(19) United States
(12) Patent Application Publication
(10) Pub. No.: US 2016/0065641 A1
(43) Pub. Date: Mar. 3, 2016

(54) Global Distribution Model

(71) Applicants: Beau Ner Chesluk, London (GB); Russell Irwin, London (GB); Anthony Rushton, West Byfleet (GB)

(72) Inventors: Beau Ner Chesluk, London (GB); Russell Irwin, London (GB); Anthony Rushton, West Byfleet (GB)

(21) Appl. No.: 14/472,165

(22) Filed: Aug. 28, 2014

(51) Int. Cl. H04L 29/06; H04L 29/08

(52) U.S. Cl. CPC H04L 65/608; H04L 67/1095; H04L 67/306

(57) ABSTRACT

According to aspects of the technology there are provided a method for distributing content from one or more content sources over a communications network to a plurality of users by a content distribution system, the content distribution system comprising a master node and a plurality of local nodes in communication with the master node, each local node serving a group of users from the plurality of users, the method comprising: maintaining, at the master node, a content directory associated with a plurality of content items from the one or more content sources, the content directory comprising content location data for the plurality of content items and information associated with each of the content items; generating, at each local node, user content location data for each user in the group of users based on selecting a plurality of content items from the content directory according to a user profile of each user, the user content location data for each user including locations of the selected content items; and transmitting, by the local node, the user content location data for each user to a content player associated with said each user for use in retrieving the corresponding content items from the one or more content sources for seamless playback of the selected content items.

### TECHNICAL FIELD

The present technology relates to a method and apparatus for distributing and streaming content to a plurality of users. Additionally, the technology relates to a distribution content delivery system for distributing content from the one or more content sources over a communication network to a plurality of users.

### BACKGROUND

The uptake of HTTP-based, content delivery networks to distribute content over the past ten years has grown exponentially. This is a radical change from the traditional methods and means by which consumers previously accessed media content; e.g. via their radios and TVs on limited free and/or pay-per-view stations. Instead, consumers around the world are now actively seeking out platforms for the specific content they would like to view. A further shift from the traditional viewing model has occurred over the last few years from the buy and download model in favour of online streaming platforms, such as Netflix®, LoveFilm®, Spotify®, YouTube™ and the like.

However, despite these radical changes in consumer viewing habits, the presentation of media on the content provider platforms has not changed much over the years. Indeed, for the most part, the providers display their content using the old-style library book shelve display; for example, the format of display of information on both Netflix® and Amazon's® websites. Although a user can often sort the content by genre etc and/or conduct key word searches, the user has to make an active choice as to the type of content item and/or select the particular item of content for which they would like access. In cases of indecisiveness, or perhaps because of the information overload, users feel overwhelmed and frustrated by this selection process.

One of the most popular content providers is YouTube™, which has over 6 billion hours of video or content items that can be watched each month. However, with 100 hours of video being uploaded to YouTube™ every minute, there is simply too much content for users to view. Combining this with other content providers or sources, there is a vast mountain of content available to each user on Earth. With so much content available, the typical user is limited to finding content using search engines or subscribing to user groups/blogs or other possible feeds. However, users cannot possibly hope to view all but a fraction of this content, which does not necessarily have a high relevance to the user. With so much content available, content that is relevant to each user is difficult to find.

Therefore, there is a need for an efficient and easy to use system for a user to stream and view relevant content available from the multitude of content sources and providers. Additionally, there is a need for an improved method, apparatus and system for distributing content worldwide. Furthermore, there is a need for an improved method, apparatus and system for enabling users to access content.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to an embodiment, there is provided a computer-implemented method for generating a content stream comprising a plurality of content items from one or more content sources, the method comprising: defining one or more instances in each content item of the plurality of content items based on one or more parameters; defining one or more of the instances in each content item as a start point from which to commence playback of the content item; and playing back the content item from the defined start point.

Preferably, defining one or more instances in each content item of the plurality of content items further comprises analysing the content or subject matter of the content item to determine the points of interests. Preferably, the analysis of the content of the content item is based on an analysis of the volume of the soundtrack of the content item. Preferably, the analysis of the content or subject matter of the content item is based on audio and/or voice recognition. Preferably, the analysis of the content or subject matter of the content item is based on visual and/or facial recognition. Preferably, the analysis of the content or subject matter of the content item is based on image analysis. Preferably, the analysis of the content or subject matter of the content item is based on can identify the tone and/or mood of an instance of the content item. Preferably, the instance of the content item indicates any one of: climax of the content item, the beginning of an action sequence, or a love scene. Preferably, the one or more parameters includes a particular time period from the start and/or end of the content item.

Preferably, the time period is set at defined percentage of the duration of the content item. Preferably, the percentage is set at any one of 0%, 1%, 5%, 10%, 15%, 20% and 25%. Preferably, the time period is set at defined measure in seconds. Preferably, the time period is set at any one of 0 sec, 1 sec, 5 sec, 10 sec, 15 sec, 20 sec, 25 sec and 30 sec. Preferably, the one or more instances in each content item are randomly selected. The method may further comprise receiving feedback from the user during playback of the content item. Preferably, the received feedback is indicative of the user interest in the one or more of the instances in each content item. Preferably, the received feedback is used to reduce the number of defined one or more instances by reducing the number of selected instances.

In an embodiment, there is provided a system for generating a content stream comprising a plurality of content items from one or more content sources, the system comprising: means for defining one or more instances in each content item of the plurality of content items based on one or more parameters; means for defining one or more of the instances in each content item as a start point from which to commence playback of the content item; and means for playing back the content item from the defined start point.

Preferably, the system provides an interactive user interface configured to provide a user with random access to content items. Preferably, the means for defining one or more instances in each content item of the plurality of content items further comprises means for analysing the content or subject matter of the content item to determine the points of interests. Preferably, the means for analysing the content of the content item is based on an analysis of the volume of the soundtrack of the content item. Preferably, the means for analysing the content or subject matter of the content item is based on audio and/or voice recognition, and/or optionally, the means for analysing the content or subject matter of the content item is based on visual and/or facial recognition, and/or optionally, the means for analysing the content or subject matter of the content item is based on image analysis, and/or optionally, the means for analysing of the content or subject matter of the content item is based on can identify the tone and/or mood of an instance of the content item.

Preferably, the instance of the content item indicates any one of: climax of the content item, the beginning of an action sequence, or a love scene. Preferably, the one or more parameters includes a particular time period from the start and/or end of the content item. Preferably, the time period is set at defined percentage of the duration of the content item. Preferably, the percentage is set at any one of 0%, 1%, 5%, 10%, 15%, 20% and 25%. Preferably, the time period is set at defined measure in seconds. Preferably, the time period is set at any one of 0 sec, 1 sec, 5 sec, 10 sec, 15 sec, 20 sec, 25 sec and 30 sec. Preferably, the one or more instances in each content item are randomly selected.

The system may further comprise means for receiving feedback from the user during playback of the content item. Preferably, the received feedback is indicative of the user interest in the one or more of the instances in each content item. Preferably, the received feedback is used to reduce the number of defined one or more instances by reducing the number of selected instances.

Also provided is a computer-readable medium comprising instructions which, when executed by an apparatus, cause the apparatus to perform a computer process comprising the steps of the method.

According to an embodiment there is provided a computer-implemented method for generating a content stream for playback on one or more content players from one or more content sources, the method comprising: receiving a content directory associated with a plurality of content items of the one or more content sources, the content directory comprising content location data for the plurality of content items and information associated with each content item; generating a playlist of content items based on content items in the content directory for user playback; receiving user feedback data from the content player for the user during playback, wherein the user feedback comprises data indicating a user has rejected playback of the one or more content items; and constructing a user profile of the user based on the user feedback data.

Preferably, the generating a playlist of content items from the content directory is based on a user profile of each user. The method may further comprise updating the user profile continually or intermittently using received user feedback data. Preferably, the user feedback information includes a time stamp by which the user rejected playback of the one or more content items. Preferably, the user feedback information further comprises an indication of like and/or dislike of the one or more content items provided by the user. Preferably, the user feedback information further comprises further user specified comments relating the one or more content items.

Preferably, the specified comments includes tweets or other known messages sent by social media means. The method may further comprise user selection of an incognito mode wherein the user's own feedback data is not used in constructing the user's profile. The method may further comprise user selection of a voyeur mode wherein the generated playlist of content times for user playback is generated based on a third parties' user profile. Preferably, the generated playlist is the generated playlist of content times is the generated playlist for the third party. Preferably, the user feedback to reject playback does not reject actual playback of the one or more content items. Preferably, the user profile is not updated when the user has selected voyeur mode. Preferably, based on the user feedback data, the method further comprises recommending the playlist of one or more other third parties. Preferably, generating a playlist of content items based on content items the content directory for user playback further comprises applying one or more content filters.

Preferably, the content filters includes one or more parameters to restrict one or more content items from the playlist based on information associated with each content item. Preferably, generating a playlist of content items based on content items the content directory for user playback further comprises searching for content items based on the one or more parameters.

Preferably, the one or more parameters includes the selection or deselection of: key words, age restrictions, genre, types of content, quality of the content stream and/or languages.

The method may further comprise retrieving one or more of the content items in the playlist using the content location data from the content directory for allowing seamless playback by a user on a content player. Preferably, positive feedback is provided when the user watches a specified duration of the content item. The method may further comprise the step of providing a user logging in to enable a user to verify their identity. The method may further comprise allowing a user to discern between interesting and uninteresting content in respect of the plurality of content items through the use of random access. Preferably, the user feedback data from the content player for the user is only received after a specified period of time of playback. Preferably, the period of time is 30 seconds.

In a further aspect, there is provided a system for generating a content stream for playback on one or more content players from one or more content sources, the apparatus comprising: means for receiving a content directory associated with a plurality of content items of the one or more content sources, the content directory comprising content location data for the plurality of content items and information associated with each content item; means for generating a playlist of content items based on content items in the content directory for user playback; means for receiving user feedback data from the content player for the user, wherein the user feedback comprises data indicating a user has rejected playback of the one or more content items; and means for constructing a user profile of the user based on the user feedback data.

Preferably, the generating a playlist of content items from the content directory is based on a user profile of each user. The system may further comprise means for updating the user profile continually or intermittently using received user feedback data. Preferably, the user feedback information includes a time stamp by which the user rejected playback of the one or more content items. Preferably, the user feedback information further comprises an indication of like and/or dislike of the one or more content items provided by the user. Preferably, the user feedback information further comprises further user specified comments relating the one or more content items. Preferably, the specified comments includes tweets or other known messages sent by social media means. The system may further comprise means for enabling user selection of an incognito mode wherein the user's own feedback data is not used in constructing the user's profile. The system may further comprise means for enabling user selection of a voyeur mode wherein the generated playlist of content times for user playback is generated based on a third parties' user profile.

Preferably, the generated playlist is the generated playlist of content times is the generated playlist for the third party. Preferably, the user feedback to reject playback does not reject actual playback of the one or more content items. Preferably, the user profile is not updated when the user has selected voyeur mode. Preferably, based on the user feedback data, the system further comprises means recommending the playlist of one or more other third parties. Preferably, generating a playlist of content items based on content items the content directory for user playback further comprises means for applying one or more content filters. Preferably, the content filters includes one or more parameters to restrict one or more content items from the playlist based on information associated with each content item. Preferably, generating a playlist of content items based on content items the content directory for user playback further comprises means for searching for content items based on the one or more parameters.

Preferably, the one or more parameters includes the selection or deselection of: key words, age restrictions, genre, types of content, quality of the content stream and/or languages. The system may further comprise means for retrieving one or more of the content items in the playlist using the content location data from the content directory for allowing seamless playback by a user on a content player. Preferably, positive feedback is provided when the user watches a specified duration of the content item. The system may further comprise means for providing a user logging in to enable a user to verify their identity. The system may further comprise means for allowing a user to discern between interesting and uninteresting content in respect of the plurality of content items through the use of random access. Preferably, the user feedback data from the content player for the user is only received after a specified period of time of playback. Preferably, the period of time is 30 seconds.

Also provided is a computer-readable medium comprising instructions which, when executed by an apparatus, cause the apparatus to perform a computer process comprising the steps of the method.

In an embodiment, there is provided a computer-implemented method for distributing content from one or more content sources over a communications network to a plurality of content players each associated with a user of a content distribution system, the method comprising: receiving a content directory associated with a plurality of content items of the one or more content sources, the content directory comprising content location data for the plurality of content items and information associated with each content item; retrieving the content items using the received user content location data from the one or more content sources for seamless playback of the selected content items; associating the content items with one or more related content items; and distributing the one or more related content items to each of the plurality of content players when the content item is being played back.

Preferably, the content player further comprises one or more remote controls connectable to the content player. Preferably, the one or more related content items are distributed to the one or more remote controls when the content item is being played back. Preferably, when the one or more remote controls are connected to the content player, a user is able to interact with the one or more related content items. Preferably, the related content item comprises an advertisement which is related to the content item.

The method may further comprise playing back the distributed related content on one or more of the plurality of content players when the content item is being played back. The method may further comprise displaying the distributed related content on one or more of the plurality of content players when the content item is being played back. The method may further comprise receiving user feedback data from the content player for the user, wherein the user feedback comprises data indicating a user has rejected playback of the one or more content items and/or related items. The method may further comprise transmitting user feedback data from said content player for use in updating the user profile of said user based on the corresponding user feedback data for the user. Preferably, the user feedback data is transmitted from said content player after a predetermined time period.

The method may further comprise receiving an instruction to skip playback of a content item of the user content location data; starting playback of another content item of the user feedback data; and sending a feedback message comprising user feedback data associated with the skipped content item and/or related item, the user feedback data comprising at least a portion of the user content location data associated with the content item and/or related item and an indication the content item and/or related was skipped.

The method may further comprise detecting a content item and/or related item was played back without an instruction to skip playback of the content item and/or related item; sending a feedback message comprising user feedback data associated with the played back content item and/or related item, the user feedback data comprising at least a portion of the user content location data and an indication the content item and/or related item was fully played back, wherein the user feedback data is stored by the master node for use in updating a user profile of the user. The method may further comprise transmitting a request from a remote device for controlling the content player of the user, the request including an authentication token associated with the content player; and receiving, at the device, a response authorising control of the content player by the device when the authentication token is valid.

The method may further comprise receiving user content location data, the user content location data further including an authentication token for the content player inserted by the local node; detecting from the user content location data the authentication token; and displaying the authentication token during playback of content items associated with the user content location data. Preferably, the authentication token is a QR code. The method may further comprise receiving one or more control instructions from the device; and receiving the one or more control instructions issued by a remote device authorised to control the content player, wherein the content player performs operations according to the one or more control instructions. Preferably, the related item is played back and/or displayed on the remote device.

The method may further comprise generating, for each content item in the user control location data of the user, a random starting point within a playback time slot between a start point of the content item and an end point of the content item; and starting the playback of a content item based on the random starting point of the content item. Preferably, the start point is based on a first time interval from the beginning of the content item, and the end point is based on a second time interval from the end of the content item. The method may further comprise receiving, at the content player after starting playback of a content item, an instruction to play the content item from the beginning of the content item; and playing back the content item from the beginning of the content item. The method may further comprise receiving a control instruction for preventing user feedback data from being sent or generated by the content player; and suspending the sending or generation of user feedback data from the content player. The method may further comprise transmitting a request for a user to receive user content location data associated with another user; receiving the user content location data of the other user to the content player of the requesting user when the other user has authorised viewing of their user content location data.

Preferably, the content player associated with the user viewing the user content location data of the other user is configured to continue playback of a content item when receiving control instructions to skip playback of the content item for the user content location data of the other user. The method may further comprise receiving user content location data for the user based on a user profile of the user, the user content location data comprising a plurality of previews of content items; receiving during playback of a preview of a content item, a control instruction to watch the content item associated with the preview content item; and retrieving, by the content player, the content item associated with the preview content item for playback to the user.

Preferably, the step of retrieving may further comprise: sending a content location request for the content item associated with the preview content item; receiving user content location data for the user comprising the location of the content item; and accessing the content item for playback to the user. Preferably, accessing the content item may further comprise: sending a request to retrieve the content item from the location of the content item, the request including user permissions data associated with accessing the content item; and retrieving the content item when the user permissions data includes permission for the user to access the content item.

In an embodiment, there is provided a system for distributing content from one or more content sources over a communications network to a plurality of content players each associated with a user of a content distribution system, the system comprising multiple content players comprising: means for receiving a content directory associated with a plurality of content items of the one or more content sources, the content directory comprising content location data for the plurality of content items and information associated with each content item; means for retrieving the content items using the received user content location data from the one or more content sources for seamless playback of the selected content items; means for associating the content items with one or more related content items; and means for distributing the one or more related content items to each of the plurality of content players when the content item is being played back.

Preferably, the content player further comprises one or more remote controls connectable to the content player. Preferably, the one or more related content items are distributed to the one or more remote controls when the content item is being played back. Preferably, when the one or more remote controls are connected to the content player, a user is able to interact with the one or more related content items. Preferably, the related content item comprises an advertisement which is related to the content item. Preferably, the system further comprises means for playing back the distributed related content on one or more of the plurality of content players when the content item is being played back. Preferably, the system further comprises means for displaying the distributed related content on one or more of the plurality of content players when the content item is being played back. Preferably, the system further comprises means for receiving user feedback data from the content player for the user, wherein the user feedback comprises data indicating a user has rejected playback of the one or more content items and/or related items.

The system may further comprise means for transmitting user feedback data from said content player for use in updating the user profile of said user based on the corresponding user feedback data for the user. Preferably, the user feedback data is transmitted from said content player after a predetermined time period. Preferably, the system further comprises means for receiving an instruction to skip playback of a content item of the user content location data; means for starting playback of another content item of the user feedback data; and means for sending a feedback message comprising user feedback data associated with the skipped content item and/or related item, the user feedback data comprising at least a portion of the user content location data associated with the content item and/or related item and an indication the content item and/or related was skipped.

The system may further comprise means for detecting a content item and/or related item was played back without an instruction to skip playback of the content item and/or related item; means for sending a feedback message comprising user feedback data associated with the played back content item and/or related item, the user feedback data comprising at least a portion of the user content location data and an indication the content item and/or related item was fully played back, wherein the user feedback data is stored by the master node for use in updating a user profile of the user. The system may further comprise means for transmitting a request from a remote device for controlling the content player of the user, the request including an authentication token associated with the content player; and means for receiving, at the device, a response authorising control of the content player by the device when the authentication token is valid.

The system may further comprise means receiving user content location data, the user content location data further including an authentication token for the content player inserted by the local node; means for detecting from the user content location data the authentication token; and means for displaying the authentication token during playback of content items associated with the user content location data. Preferably, the authentication token is a QR code. The system may further comprise means for receiving one or more control instructions from the device; and means for receiving the one or more control instructions issued by a remote device authorised to control the content player, wherein the content player performs operations according to the one or more control instructions.

Preferably, the related item is played back and/or displayed on the remote device. Preferably, the system may comprise means for generating, for each content item in the user control location data of the user, a random starting point within a playback time slot between a start point of the content item and an end point of the content item; and means for starting the playback of a content item based on the random starting point of the content item. Preferably, the start point is based on a first time interval from the beginning of the content item, and the end point is based on a second time interval from the end of the content item. Preferably, the system may comprise means for receiving, at the content player after starting playback of a content item, an instruction to play the content item from the beginning of the content item; and means playing back the content item from the beginning of the content item.

Preferably, the system may comprise means for receiving a control instruction for preventing user feedback data from being sent or generated by the content player; and means for suspending the sending or generation of user feedback data from the content player. Preferably, the system may comprise means for transmitting a request for a user to receive user content location data associated with another user; means for receiving the user content location data of the other user to the content player of the requesting user when the other user has authorised viewing of their user content location data.

Preferably, the content player associated with the user viewing the user content location data of the other user is configured to continue playback of a content item when receiving control instructions to skip playback of the content item for the user content location data of the other user. The system may comprise means for receiving user content location data for the user based on a user profile of the user, the user content location data comprising a plurality of previews of content items; means for receiving during playback of a preview of a content item, a control instruction to watch the content item associated with the preview content item; and means for retrieving, by the content player, the content item associated with the preview content item for playback to the user.

Preferably, the means for retrieving further comprises: means for sending a content location request for the content item associated with the preview content item; means for receiving user content location data for the user comprising the location of the content item; and means for accessing the content item for playback to the user. The means for accessing the content item may further comprise: means for sending a request to retrieve the content item from the location of the content item, the request including user permissions data associated with accessing the content item; and means for retrieving the content item when the user permissions data includes permission for the user to access the content item.

Also provided is a computer-readable medium comprising instructions which, when executed by an apparatus, cause the apparatus to perform a computer process comprising the steps of the method.

According to an embodiment there is provided a computer-implemented method for modifying a content stream distributed to one or more users, the method comprising: generating a content stream comprising a plurality of content items from one or more content providers; constructing one or more filters for modifying the content steam, wherein the one or more filters is constructed by defining one or more parameters relating the content items; applying the one or more filters to the content stream; selecting one or more content items from the content stream based on defined parameters; and modifying the content stream by applying the one or more constructed filters to the plurality of content items in the content stream.

Preferably, the content items are randomly selected from the one or more content sources. The method may further comprise receiving user feedback data from the content player for the user, wherein the user feedback comprises data indicating a user has rejected playback of the one or more content items. Preferably, the filters are constructed based on the profile of a user.

The method may further comprise transmitting user feedback data from said content player for use in updating the user profile of said user based on the corresponding user feedback data for the user. Additionally or alternatively, the method may further comprise receiving an instruction to skip playback of a content item of the user content location data; starting playback of another content item of the user feedback data; and sending a feedback message comprising user feedback data associated with the skipped content item, the user feedback data comprising at least a portion of the user content location data associated with the content item and an indication the content item was skipped.

Preferably, the feedback message comprises user feedback data is sent to a user profile generator. The feedback message may be sent when the instruction to skip playback exceeds a predefined playback timing threshold or falls within a predefined playback timing threshold. The method may further comprise detecting a content item was played back without an instruction to skip playback of the content item; sending a feedback message comprising user feedback data associated with the played back content item, the user feedback data comprising at least a portion of the user content location data and an indication the content item was fully played back, wherein the user feedback data is stored by the master node for use in updating a user profile of the user.

The method may further comprise transmitting a request from a remote device for controlling the content player of the user, the request including an authentication token associated with the content player; and receiving, at the device, a response authorising control of the content player by the device when the authentication token is valid. Additionally or alternatively, the method may further comprise receiving user content location data, the user content location data further including an authentication token for the content player inserted by the local node; detecting from the user content location data the authentication token; and displaying the authentication token during playback of content items associated with the user content location data. Preferably, the authentication token is a QR code.

The method may further comprise receiving one or more control instructions from the device; and receiving the one or more control instructions issued by a remote device authorised to control the content player, wherein the content player performs operations according to the one or more control instructions. Preferably, the related item is played back and/or displayed on the remote device. Additionally or alternatively, the method may comprise generating, for each content item in the user control location data of the user, a random starting point within a playback time slot between a start point of the content item and an end point of the content item; and starting the playback of a content item based on the random starting point of the content item.

Preferably, the start point is based on a first time interval from the beginning of the content item, and the end point based on a second time interval from the end of the content item. The method may further comprise receiving, at the content player after starting playback of a content item, an instruction to play the content item from the beginning of the content item; and playing back the content item from the beginning of the content item. Additionally or alternatively, the method may further comprise receiving a control instruction for preventing user feedback data from being sent or generated by the content player; and suspending the sending or generation of user feedback data from the content player.

The method may further comprise transmitting a request for a user to receive user content location data associated with another user; receiving the user content location data of the other user to the content player of the requesting user when the other user has authorised viewing of their user content location data. Preferably, the content player associated with the user viewing the user content location data of the other user is configured to continue playback of a content item when receiving control instructions to skip playback of the content item for the user content location data of the other user.

The method may further comprise receiving user content location data for the user based on a user profile of the user, the user content location data comprising a plurality of previews of content items; receiving during playback of a preview of a content item, a control instruction to watch the content item associated with the preview content item; and retrieving, by the content player, the content item associated with the preview content item for playback to the user. Preferably, the step of retrieving further comprises: sending a content location request for the content item associated with the preview content item; receiving user content location data for the user comprising the location of the content item; and accessing the content item for playback to the user. Preferably, accessing the content item further comprises: sending a request to retrieve the content item from the location of the content item, the request including user permissions data associated with accessing the content item; and retrieving the content item when the user permissions data includes permission for the user to access the content item.

Preferably, positive feedback is provided by a user watching or playing back the content item for a predetermined period of time. The method may further comprise assigning weights to each type of feedback; wherein the user profile is updated by the assigned weights. Preferably, the weights indicate the probability or likelihood of a user liking a particular content item. Preferably, the weights indicate the probability or likelihood of a user liking a theme or genre of content items.

In a further embodiment, there is provided a system for modifying a content stream distributed to one or more users, the apparatus comprising: means for generating a content stream comprising a plurality of content items from one or more content providers; means for constructing one or more filters for modifying the content steam, wherein the one or more filters constructed by defining one or more parameters relating the content items; means for applying the one or more filters to the content stream; means for selecting one or more content items from the content stream based on defined parameters; and means for modifying the content stream by applying the constructed filter the content items.

Preferably, the content items are randomly selected from the one or more content sources. The system may further comprise means receiving user feedback data from the content player for the user, wherein the user feedback comprises data indicating a user has rejected playback of the one or more content items. Preferably, the filters are constructed based on the profile of a user.

The system may further comprise means for transmitting user feedback data from said content player for use in updating the user profile of said user based on the corresponding user feedback data for the user. Additionally or alternatively, the system may further comprise means for receiving an instruction to skip playback of a content item of the user content location data; means for starting playback of another content item of the user feedback data; and means for sending a feedback message comprising user feedback data associated with the skipped content item, the user feedback data comprising at least a portion of the user content location data associated with the content item and an indication the content item was skipped.

Preferably, the feedback message comprises user feedback data is sent to a user profile generator. Preferably, the feedback message is sent when the instruction to skip playback exceeds a predefined playback timing threshold. Preferably, the feedback message is sent when the instruction to skip playback falls within a predefined playback timing threshold. The system may further comprise means for detecting a content item was played back without an instruction to skip playback of the content item; means for sending a feedback message comprising user feedback data associated with the played back content item, the user feedback data comprising at least a portion of the user content location data and an indication the content item was fully played back, wherein the user feedback data is stored by the master node for use in updating a user profile of the user.

The system may further comprise means for transmitting a request from a remote device for controlling the content player of the user, the request including an authentication token associated with the content player; and means for receiving, at the device, a response authorising control of the content player by the device when the authentication token is valid. Additionally or alternatively, the system may further comprise means for receiving user content location data, the user content location data further including an authentication token for the content player inserted by the local node; means for detecting from the user content location data the authentication token; and means for displaying the authentication token during playback of content items associated with the user content location data. Preferably, the authentication token is a QR code.

The system may further comprise means for receiving one or more control instructions from the device; and means for receiving the one or more control instructions issued by a remote device authorised to control the content player, wherein the content player performs operations according to the one or more control instructions. Preferably, the related item is played back and/or displayed on the remote device. The system may further comprise means for generating, for each content item in the user control location data of the user, a random starting point within a playback time slot between a start point of the content item and an end point of the content item; and means for starting the playback of a content item based on the random starting point of the content item. Preferably, the start point is based on a first time interval from the beginning of the content item, and the end point is based on a second time interval from the end of the content item.

The system may further comprise means for receiving, at the content player after starting playback of a content item, an instruction to play the content item from the beginning of the content item; and means for playing back the content item from the beginning of the content item. Additionally or alternatively, the system may further comprise means for receiving a control instruction for preventing user feedback data from being sent or generated by the content player; and means for suspending the sending or generation of user feedback data from the content player.

The system may further comprise means for transmitting a request for a user to receive user content location data associated with another user; means for receiving the user content location data of the other user to the content player of the requesting user when the other user has authorised viewing of their user content location data. Preferably, the content player associated with the user viewing the user content location data of the other user is configured to continue playback of a content item when receiving control instructions to skip playback of the content item for the user content location data of the other user.

The system may further comprise means for receiving user content location data for the user based on a user profile of the user, the user content location data comprising a plurality of previews of content items; means for receiving during playback of a preview of a content item, a control instruction to watch the content item associated with the preview content item; and means for retrieving, by the content player, the content item associated with the preview content item for playback to the user. The step of retrieving may further comprise: means for sending a content location request for the content item associated with the preview content item; means for receiving user content location data for the user comprising the location of the content item; and means for accessing the content item for playback to the user. The step of accessing the content item may further comprise: means for sending a request to retrieve the content item from the location of the content item, the request including user permissions data associated with accessing the content item; and means for retrieving the content item when the user permissions data includes permission for the user to access the content item.

Preferably, positive feedback is provided by a user watching or playing back the content item for a predetermined period of time. The system may further comprise means for assigning weights to each type of feedback; wherein the user profile is updated by the assigned weights.

Preferably, the weights indicate the probability or likelihood of a user liking a particular content item. Preferably, the weights indicate the probability or likelihood of a user liking a theme or genre of content items.

Also provided is a computer-readable medium comprising instructions which, when executed by an apparatus, cause the apparatus to perform a computer process comprising the steps of the method.

In an embodiment, there is provided a method for distributing content from one or more content sources over a communications network to a plurality of users by a content distribution system, the content distribution system comprising a master node and a plurality of local nodes in communication with the master node, each local node serving a group of users from the plurality of users, the method comprising: maintaining, at the master node, a content directory associated with a plurality of content items from the one or more content sources, the content directory comprising content location data for the plurality of content items and information associated with each of the content items; generating, at each local node, user content location data for each user in the group of users based on selecting a plurality of content items from the content directory according to a user profile of each user, the user content location data for each user including locations of the selected content items; and transmitting, by the local node, the user content location data for each user to a content player associated with said each user for use in retrieving the corresponding content items from the one or more content sources for seamless playback of the selected content items.

The method may further comprise: receiving, at the master node, user feedback data from the content player for each user in response to seamless playback of the selected content items; storing, at the master node, the user feedback data associated with the user; and updating, at the master node, a user profile of the user based on the corresponding user feedback data for the user. The method may further comprise: receiving, by the content player, an instruction to skip playback of a content item of the user content location data; starting playback of another content item of the user feedback data; and sending, to the master node, a feedback message comprising user feedback data associated with the skipped content item, the user feedback data comprising at least a portion of the user content location data associated with the content item and an indication the content item was skipped; storing, at the master node, the user feedback data associated with the user for use in updating a user profile of the user.

The method may further comprise: detecting a content item was played back without an instruction to skip playback of the content item; sending, to the master node, a feedback message comprising user feedback data associated with the played back content item, the user feedback data comprising at least a portion of the user content location data and an indication the content item was fully played back; storing, at the master node, the user feedback data associated with the user for use in updating a user profile of the user.

The method may further comprise receiving, at the local node, a request for controlling the content player of the user from a device, the request including an authentication token associated with the content player; and sending, to the device, a response authorising control of the content player by the device when the authentication token is valid. The method may further comprise: generating, at the local node, an authentication token for the content player and associated user; inserting the authentication token into the user content location data of the associated user; sending, to the content player, the user content location data; detecting, by the content player, from the user content location data the authentication token; and displaying, by the content player, the authentication token during playback of content items associated with the user content location data.

When the authentication token is a QR code, the method may further comprise: capturing, by the device, an image of the authentication token when it is displayed by the content player; and decoding the captured authentication token to generate a decoded authentication token for use with the local node in authenticating the device to control the content player.

The method may further comprise: receiving, at the local node, one or more control instructions from the device; and sending, from the local node, the one or more control instructions to the content player, wherein the content player performs the one or more control instructions. The method may further comprise: generating, for each content item in the user control location data of the user, a random starting point within a playback time slot between a start point of the content item and an end point of the content item; and starting the playback of a content item based on the random starting point of the content item.

Preferably, the start point is based on a first time interval from the beginning of the content item, and the end point is based on a second time interval from the end of the content item The method may further comprise: receiving, at the content player after starting playback of a content item, an instruction to play the content item from the beginning of the content item; and playing back the content item from the beginning of the content item. The method may further comprise: receiving, at the content player, a control instruction for preventing user feedback data from being sent or generated by the content player; and suspending the sending or generation of user feedback data from the content player.

The method may further comprise: receiving, at the local node, a request for a user to receive user content location data associated with another user; sending, at the local node, the user content location data of the other user to the content player of the requesting user when the other user has authorised viewing of their user content location data. The method may further comprise: receiving, at the local node, a request for a user to receive user content location data associated with another user currently using the system; sending, at the local node, the user content location data of the other user to the content player of the requesting user when the other user has authorised viewing of their user content location data. Preferably, the content player associated with the user viewing the user content location data of the other user is configured to continue playback of a content item when receiving control instructions to skip playback of the content item for the user content location data of the other user.

The method may further comprise: generating, at the local node, user content location data for a user based on a user profile of the user, the user content location data comprising a plurality of previews of content items; receiving, by the content player during playback of a preview of a content item, a control instruction to watch the content item associated with the preview content item; and retrieving, by the content player, the content item associated with the preview content item for playback to the user. Preferably, the step of retrieving further comprises: sending, to the local node, a content location request for the content item associated with the preview content item; receiving, from the local node, user content location data for the user comprising the location of the content item; and accessing the content item for playback to the user. Preferably, accessing the content item further comprises: sending a request to retrieve the content item from the location of the content item, the request including user permissions data associated with accessing the content item; and retrieving the content item when the user permissions data includes permission for the user to access the content item.

The method may further comprise: generating a random selection of content items from the content directory; selecting content items from a random selection of content items according to a user profile of the user; and generating user content location data based on the selected content items. The method may further comprise: selecting a plurality of content items from the content directory according to a user profile of the user; and prior to generating the user content location data, randomly shuffling the selected content items.

Preferably, when each user is associated with a user profile bank comprising one or more user profiles of the user, the method may comprise: building a user profile for the user profile bank by: analysing stored user content location data and user feedback data associated with content items played back to the user to identify one or more preference(s) associated with the user; and generating user profile rules or an instruction set associated with the identified preference(s), the user profile rules for use in generating user content location data for the user according to the user profile.

The method may further comprise: generating, by a content player, a queue of a plurality of content item player instantiations, each content item player instantiation for retrieving a content item associated with the user content location data from one or more content sources; and retrieving, by the content player, a content item player instantiation from the queue for playback of the corresponding retrieved content item. Preferably, the step of generating a queue of a plurality of content item player instantiations further comprises: retrieving, for each content item in the user content location data, the content item location; instantiating a content item player for retrieval of the content item from the content item location; and inserting the content item player instantiation in the queue of content item player instantiations when the content item has been retrieved by the content item player instantiation.

The method may further comprise the step of retrieving a content item player instantiation from the queue when a minimum number of content item player instantiations are in the queue for substantially seamless playback of content items. The method may further comprise the step of retrieving a content item player instantiation from the queue comprises selecting a content item player instantiation from the queue that is ready to perform playback of a corresponding content item.

In an embodiment there is provided a method for distributing content from one or more content sources over a communications network to a plurality of users by a content delivery client, the communications network including a plurality of content delivery clients in communication with each other, each content delivery client serving a user from the plurality of users, the method comprising: maintaining a content directory associated with a plurality of content items from the one or more content sources or one or more other content delivery clients, the content directory comprising content location data for the plurality of content items and information associated with each of the content items; generating user content location data for the user based on selecting a plurality of content items from the content directory according to a user profile of the user, the user content location data including locations of the selected content items; and retrieving by a content player of the user the corresponding content items from the one or more content sources and/or other client delivery clients for seamless playback of the selected content items.

The method may further comprise: receiving user feedback data from the content player in response to seamless playback of the selected content items; storing the user feedback data associated with the user; and updating a user profile of the user based on the corresponding user feedback data for the user. The method may further comprise: generating a random selection of content items from the content directory; selecting content items from a random selection of content items according to a a user profile of the user; and generating user content location data based on the selected content items.

The method may further comprise: receiving, at the master node, user feedback data from the content player for each user in response to seamless playback of the selected content items; storing, at the master node, the user feedback data associated with the user; and updating, at the master node, a user profile of the user based on the corresponding user feedback data for the user. The method may further comprise: receiving, by the content player, an instruction to skip playback of a content item of the user content location data; starting playback of another content item of the user feedback data; and sending, to the master node, a feedback message comprising user feedback data associated with the skipped content item, the user feedback data comprising at least a portion of the user content location data associated with the content item and an indication the content item was skipped; storing, at the master node, the user feedback data associated with the user for use in updating a user profile of the user.

The method may further comprise: detecting a content item was played back without an instruction to skip playback of the content item; sending, to the master node, a feedback message comprising user feedback data associated with the played back content item, the user feedback data comprising at least a portion of the user content location data and an indication the content item was fully played back; storing, at the master node, the user feedback data associated with the user for use in updating a user profile of the user.

The method may further comprise receiving, at the local node, a request for controlling the content player of the user from a device, the request including an authentication token associated with the content player; and sending, to the device, a response authorising control of the content player by the device when the authentication token is valid. The method may further comprise: generating, at the local node, an authentication token for the content player and associated user; inserting the authentication token into the user content location data of the associated user; sending, to the content player, the user content location data; detecting, by the content player, from the user content location data the authentication token; and displaying, by the content player, the authentication token during playback of content items associated with the user content location data.

When the authentication token is a QR code, the method may further comprise: capturing, by the device, an image of the authentication token when it is displayed by the content player; and decoding the captured authentication token to generate a decoded authentication token for use with the local node in authenticating the device to control the content player.

The method may further comprise: receiving, at the local node, one or more control instructions from the device; and sending, from the local node, the one or more control instructions to the content player, wherein the content player performs the one or more control instructions. The method may further comprise: generating, for each content item in the user control location data of the user, a random starting point within a playback time slot between a start point of the content item and an end point of the content item; and starting the playback of a content item based on the random starting point of the content item.

Preferably, the start point is based on a first time interval from the beginning of the content item, and the end point is based on a second time interval from the end of the content item The method may further comprise: receiving, at the content player after starting playback of a content item, an instruction to play the content item from the beginning of the content item; and playing back the content item from the beginning of the content item. The method may further comprise: receiving, at the content player, a control instruction for preventing user feedback data from being sent or generated by the content player; and suspending the sending or generation of user feedback data from the content player.

The method may further comprise: receiving, at the local node, a request for a user to receive user content location data associated with another user; sending, at the local node, the user content location data of the other user to the content player of the requesting user when the other user has authorised viewing of their user content location data. The method may further comprise: receiving, at the local node, a request for a user to receive user content location data associated with another user currently using the system; sending, at the local node, the user content location data of the other user to the content player of the requesting user when the other user has authorised viewing of their user content location data. Preferably, the content player associated with the user viewing the user content location data of the other user is configured to continue playback of a content item when receiving control instructions to skip playback of the content item for the user content location data of the other user.

The method may further comprise: generating, at the local node, user content location data for a user based on a user profile of the user, the user content location data comprising a plurality of previews of content items; receiving, by the content player during playback of a preview of a content item, a control instruction to watch the content item associated with the preview content item; and retrieving, by the content player, the content item associated with the preview content item for playback to the user. Preferably, the step of retrieving further comprises: sending, to the local node, a content location request for the content item associated with the preview content item; receiving, from the local node, user content location data for the user comprising the location of the content item; and accessing the content item for playback to the user. Preferably, accessing the content item further comprises: sending a request to retrieve the content item from the location of the content item, the request including user permissions data associated with accessing the content item; and retrieving the content item when the user permissions data includes permission for the user to access the content item.

The method may further comprise: generating a random selection of content items from the content directory; selecting content items from a random selection of content items according to a user profile of the user; and generating user content location data based on the selected content items. The method may further comprise: selecting a plurality of content items from the content directory according to a user profile of the user; and prior to generating the user content location data, randomly shuffling the selected content items.

Preferably, when each user is associated with a user profile bank comprising one or more user profiles of the user, the method may comprise: building a user profile for the user profile bank by: analysing stored user content location data and user feedback data associated with content items played back to the user to identify one or more preference(s) associated with the user; and generating user profile rules or an instruction set associated with the identified preference(s), the user profile rules for use in generating user content location data for the user according to the user profile.

The method may further comprise: generating, by a content player, a queue of a plurality of content item player instantiations, each content item player instantiation for retrieving a content item associated with the user content location data from one or more content sources; and retrieving, by the content player, a content item player instantiation from the queue for playback of the corresponding retrieved content item. Preferably, the step of generating a queue of a plurality of content item player instantiations further comprises: retrieving, for each content item in the user content location data, the content item location; instantiating a content item player for retrieval of the content item from the content item location; and inserting the content item player instantiation in the queue of content item player instantiations when the content item has been retrieved by the content item player instantiation.

The method may further comprise the step of retrieving a content item player instantiation from the queue when a minimum number of content item player instantiations are in the queue for substantially seamless playback of content items. The method may further comprise the step of retrieving a content item player instantiation from the queue comprises selecting a content item player instantiation from the queue that is ready to perform playback of a corresponding content item.

It will be appreciated that although specific examples and the described embodiments refer to master nodes, local nodes and content players as separate apparatuses and/or systems, these features and components are interchangeable and combinable such that any method step may be performed by any and/or all of the separate components.

Also provided is a system comprising means operable to perform the steps of the method. Further provided is a computer-readable medium comprising instructions which, when executed by an apparatus, cause the apparatus to perform a computer process comprising the steps of the method.

In an embodiment there is provided a method for distributing content from one or more content sources over a communications network to a plurality of users by a master node of a content distribution system, the content distribution system further comprising a plurality of local nodes in communication with the master node, each local node serving a group of users from the plurality of users, the method comprising: maintaining a content directory associated with a plurality of content items of the one or more content sources, the content directory comprising content location data for the plurality of content items and information associated with each of the content item; transmitting the content directory to one or more of the local nodes; maintaining a user profile bank comprising one or more user profiles for each of the plurality of users; and transmitting the user profile bank to one or more of the local nodes for use in generating, at each local node, user content location data for each user in the group of users based on selecting a plurality of content items from the content directory according to a user profile of said user, the user content location data including locations of the selected content items, wherein the user content location data for each user is transmitted to a content player associated with said each user for use in retrieving the corresponding content items from the one or more content sources for seamless playback of the selected content items.

The method may further comprise: receiving user feedback data from the content player for each user during playback of the selected content items of the user content location data; storing the user feedback data for the user; updating one or more of the user profile(s) of the user based on the corresponding stored user feedback data for the user. The method may further comprise: receiving a user feedback message comprising user feedback data associated with a skipped content item in response to an instruction sent to a content player from a user for skipping playback of the content item, the user feedback data comprising at least a portion of the user content location data associated with the content item and and an indication the content item was skipped; storing the user feedback data for use in updating the user profile(s) of the user.

The method may further comprise: receiving a user feedback message associated with a user, the feedback message comprising user feedback data associated with one or more played back content items, the user feedback data comprising at least a portion of the user content location data associated with the content item and an indication the content item was fully played back; and storing the user feedback data for use in updating the user profile(s) of the user.

The method may further comprise: suspending storage of user feedback data in response to receiving, a control instruction for preventing user feedback data from being stored or used by the master node in updating a user profile of the user. The method may further comprise: receiving a request from a local node for a user to receive user content location data associated with another user; sending user profile associated with the other user to the local node for generating user content location data of the other user for playback on the content player of the requesting user when the other user has authorised viewing of user content location data according to the user profile of the other user.

The method may further comprise: receiving a request from a local node for a user to receive user content location data associated with another user currently using the system; sending a user profile of the other user to the local node for generating user content location data of the other user for playback on the content player of the requesting user when the other user has authorised viewing of their user content location data according to the user profile of the other user.

The method may further comprise: sending a user profile of a user generated for previewing a plurality of content items to a local node for use in generating user content location data for a user based on the user profile for previewing a plurality of content items, the user content location data comprising a plurality of previews of content items; receiving, by the content player during playback of a preview of a content item, user feedback data of the user associated with the playback of one or more preview content items; and updating the user profile for previewing the plurality of content items based on the user feedback data.

When each user is associated with a user profile bank comprising one or more user profiles of the user, the method may further comprise: building a user profile for the user profile bank of a user by: analysing stored user content location data and user feedback data associated with content items previously played back to the user to identify one or more preference(s) associated with the user; and generating user profile rules or an instruction set associated with the identified preference(s), the user profile rules for use in generating user content location data for the user according to the user profile.

It will be appreciated that although specific examples and the described embodiments refer to master nodes, local nodes and content players as separate apparatuses and/or systems, these features and components are interchangeable and combinable such that any method step may be performed by any and/or all of the separate components.

Also provided is a system comprising means operable to perform the steps of the method. Further provided is a computer-readable medium comprising instructions which, when executed by an apparatus, cause the apparatus to perform a computer process comprising the steps of the method.

In an embodiment, there is provided a method for distributing content from one or more content sources over a communications network to a plurality of users by a local node in a content distribution system, the content distribution system comprising a master node in communication with the local node, the method comprising: receiving a content directory associated with a plurality of content items of the one or more content sources, the content directory comprising content location data for the plurality of content items and information associated with the content items; receiving a user profile directory comprising a user profile for each of the plurality of users; generating user content location data for each user based on selecting a plurality of content items from the content directory according to the user profile of said each user, the user content location data including locations of the selected content items; and transmitting the user content location data for each user to a content player associated with said each user for use in retrieving the corresponding content items from the one or more content sources for seamless playback of the selected content items.

The method may further comprise: receiving updated user profiles from the master node, wherein the user profile of each user has been updated based on user feedback data transmitted from the content player for said each user during playback of said content items. The method may further comprise: receiving a request for controlling the content player of the user from a device, the request including an authentication token associated with the content player; and sending, to the device, a response authorising control of the content player by the device when the authentication token is valid.

The method may further comprise: generating an authentication token for the content player and associated user; inserting the authentication token into the user content location data of the associated user; sending, to the content player, the user content location data for detection, by the content player, of the authentication token display of the authentication token during playback of content items associated with the user content location data. Preferably, when the authentication token is a QR code, the method may further comprise: receiving a representation of the authentication token based on an image of the QR code captured by the device when the authentication token is displayed by the content player using the representation of the authentication token in authenticating the device to control the content player.

The method may further comprise: receiving one or more control instructions from the device; and sending the one or more control instructions to the content player, wherein the content player performs the one or more control instructions. The method may further comprise: receiving a control instruction from the content player for preventing user feedback data from being sent or generated by the content player; and suspending the update of historical content data and user feedback data in the master node. The method may further comprise: receiving a request for a user to receive user content location data associated with another user; sending the user content location data of the other user to the content player of the requesting user when the other user has authorised viewing of their user content location data.

The method may further comprise: receiving a request for a user to receive user content location data associated with another user currently using the system; sending the user content location data of the other user to the content player of the requesting user when the other user has authorised viewing of their user content location data. The method may further comprise: generating user content location data for a user based on a user profile of the user, the user content location data comprising a plurality of previews of content items; receiving a control instruction from the content player to watch the content item associated with the preview content item; and sending the content item associated with the preview content item for playback to the user.

The step of retrieving may further comprise: receiving a content location request for the content item associated with the preview content item; transmitting user content location data for the user comprising the location of the content item for allowing the content player to access the content item for playback to the user. The accessing the content item may further comprise: receiving a request to retrieve the content item from the location of the content item, the request including user permissions data associated with accessing the content item; and sending the content item when the user permissions data includes permission for the user to access the content item. The method may further comprise: generating a random selection of content items from the content directory; selecting content items from a random selection of content items according to a user profile of the user; and generating user content location data based on the selected content items.

The method may further comprise: selecting a plurality of content items from the content directory according to a user profile of the user; and prior to generating the user content location data, randomly shuffling the selected content items.

It will be appreciated that although specific examples and the described embodiments refer to master nodes, local nodes and content players as separate apparatuses and/or systems, these features and components are interchangeable and combinable such that any method step may be performed by any and/or all of the separate components.

Also provided is a system comprising means operable to perform the steps of the method. Further provided is a computer-readable medium comprising instructions which, when executed by an apparatus, cause the apparatus to perform a computer process comprising the steps of the method.

There is provided a computer-implemented method for streaming content from one or more content sources over a communications network to a content player associated a user of a content distribution system, the method comprising: receiving user content location data for said user, the user content location data generated by selecting a plurality of content items of said one or more content sources from a content directory, the content directory including locations of said content items and information associated with said content items, and a user profile of said user, wherein the user content location data includes locations of the selected content items; retrieving the corresponding content items using the received user content location data from the one or more content sources for seamless playback of the selected content items.

The method may further comprise: sending user feedback data from said content player for use in updating the user profile of said user based on the corresponding user feedback data for the user. The method may further comprise: sending user feedback data from the content player for each user in response to seamless playback of the selected content items, wherein the user feedback data is stored for updating a user profile of the user. The method may further comprise: receiving an instruction to skip playback of a content item of the user content location data; starting playback of another content item of the user feedback data; and sending a feedback message comprising user feedback data associated with the skipped content item, the user feedback data comprising at least a portion of the user content location data associated with the content item and an indication the content item was skipped, wherein the user feedback data is stored for use in updating a user profile of the user.

The method may further comprise: detecting a content item was played back without an instruction to skip playback of the content item; sending a feedback message comprising user feedback data associated with the played back content item, the user feedback data comprising at least a portion of the user content location data and an indication the content item was fully played back, wherein the user feedback data is stored for use in updating a user profile of the user. The method may further comprise: transmitting a request from a remote device for controlling the content player of the user, the request including an authentication token associated with the content player; and receiving a response authorising control of the content player by the device when the authentication token is valid.

The method may further comprise: receiving user content location data, the user content location data further including an authentication token for the content player; detecting from the user content location data the authentication token; and displaying the authentication token during playback of content items associated with the user content location data. Preferably, the authentication token is a QR code. The method may further comprise: receiving one or more control instructions from the device; performing operations according to the one or more control instructions. The method may further comprise: generating, for each content item in the user control location data of the user, a random starting point within a playback time slot between a start point of the content item and an end point of the content item; and starting the playback of a content item based on the random starting point of the content item. Preferably, the start point is based on a first time interval from the beginning of the content item, and the end point is based on a second time interval from the end of the content item.

The method may further comprise: receiving, at the content player after starting playback of a content item, an instruction to play the content item from the beginning of the content item; and playing back the content item from the beginning of the content item. The method may further comprise: receiving, at the content player, a control instruction for preventing user feedback data from being sent or generated by the content player; and suspending the sending or generation of user feedback data from the content player. The method may further comprise: transmitting a request for a user to receive user content location data associated with another user; receiving the user content location data of the other user to the content player of the requesting user when the other user has authorised viewing of their user content location data. Preferably, the content player associated with the user viewing the user content location data of the other user is configured to continue playback of a content item when receiving control instructions to skip playback of the content item for the user content location data of the other user.

The method may further comprise: receiving user content location data for the user based on a user profile of the user, the user content location data comprising a plurality of previews of content items; receiving, by the content player during playback of a preview of a content item, a control instruction to watch the content item associated with the preview content item; and retrieving, by the content player, the content item associated with the preview content item for playback to the user. Preferably, the step of retrieving further comprises: sending a content location request for the content item associated with the preview content item; receiving user content location data for the user comprising the location of the content item; and accessing the content item for playback to the user. Accessing the content item may further comprise sending a request to retrieve the content item from the location of the content item, the request including user permissions data associated with accessing the content item; and retrieving the content item when the user permissions data includes permission for the user to access the content item.

The method may further comprise: generating a queue of a plurality of content item player instantiations, each content item player instantiation for retrieving a content item associated with the user content location data from one or more content sources; and retrieving a content item player instantiation from the queue for playback of the corresponding retrieved content item. The step of generating a queue of a plurality of content item player instantiations may further comprise: retrieving, for each content item in the user content location data, the content item location; instantiating a content item player for retrieval of the content item from the content item location; and inserting the content item player instantiation in the queue of content item player instantiations when the content item has been retrieved by the content item player instantiation. The step of retrieving a content item player instantiation from the queue when a minimum number of content item player instantiations are in the queue for substantially seamless playback of content items. Preferably, the step of retrieving a content item player instantiation from the queue comprises selecting a content item player instantiation from the queue that is ready to perform playback of a corresponding content item.

It will be appreciated that although specific examples and the described embodiments refer to master nodes, local nodes and content players as separate apparatuses and/or systems, these features and components are interchangeable and combinable such that any method step may be performed by any and/or all of the separate components.

Also provided is a system comprising means operable to perform the steps of the method. Further provided is a computer-readable medium comprising instructions which, when executed by an apparatus, cause the apparatus to perform a computer process comprising the steps of the method.

The features of each of the above aspects and/or embodiments may be combined as appropriate, as would be apparent to the skilled person, and may be combined with any of the aspects of the technology. Indeed, the order of the embodiments and the ordering and location of the preferable features is indicative only and has no bearing on the features themselves. It is intended for each of the preferable and/or optional features to be interchangeable and/or combinable with not only all of the aspect and embodiments, but also each of preferable features.

### BRIEF DESCRIPTION OF THE DRAWINGS

For better understanding of the aspects and/or embodiments described herein and to show how the same may be carried into effect, reference will now be made, by way of example only, to the accompanying figures, in which:

FIG. 1a is a schematic diagram illustrating an example distributed content delivery system according to an embodiment;

FIG. 1b is a flow diagram illustrating an example process for maintaining and distributing a content directory according to an embodiment;

FIG. 1c is a flow diagram illustrating an example process for maintaining and distributing a session directory according to an embodiment;

FIG. 1d is a flow diagram illustrating an example process for maintaining a local content and session directory and distributing content locally according to an embodiment;

FIG. 1e is a flow diagram illustrating an example process for receiving and playing distributed content according to an embodiment;

FIG. 1f is a schematic diagram illustrating another example distributed content delivery system according to an embodiment;

FIG. 2a is a schematic diagram illustrating an example distributed content delivery system according to an embodiment;

FIG. 2b is a schematic diagram further illustrating the distributed content delivery system of FIG. 2a;

FIG. 2c is a schematic diagram illustrating an example master node of the distributed content delivery system of FIG. 2a and/or 2b;

FIG. 2d is a schematic diagram illustrating an example local node of the distributed content delivery system of FIG. 2a and/or 2b;

FIG. 2e is a flow diagram illustrating an example process for preparing playback of content items in a content player system of the distributed content delivery system of FIG. 2a and/or 2b;

FIG. 2f is a flow diagram illustrating an example process for playback of prepared content items in the content player system of FIG. 2e;

FIG. 2g is a flow diagram illustrating an example process for preparing playback of content items in a content player system of the distributed content delivery system of FIG. 2a and/or 2b;

FIG. 2h is a flow diagram illustrating an example process for playback of prepared content items in the content player system of FIG. 2g;

FIG. 3 is a screenshot illustrating an example graphic user interface for a remote control for the distributed content delivery system according to an embodiment;

FIG. 4a is a screenshot illustrating an example of the user content location data (e.g. playlist) for the content player of a user;

FIG. 4b is a screenshot illustrating an example of the content player retrieving, playing and cueing content items based on the user content location data received from the local node;

FIG. 4c is a screenshot illustrating an example of feedback data to be transmitted from the content player towards the master node for updating the user profiles;

FIG. 5 is a screenshot of an example QR code for use with a remote control, for example, the remote control depicted in FIG. 3;

FIG. 6 is a screenshot of the recipe or mixer for use in generating the user content location data (e.g. playlist) according to the user profile; and

FIG. 7 is a graph showing the profile of a particular content item with a time measure on the x-axis and points of interest measure on the y-axis.

It will also be appreciated that although features from each of the embodiments may be identified by different reference numerals in the figures and throughout the description, similar features including the properties and functionality attributed thereto, from one embodiment may be interchangeable with those of another embodiment.

### DETAILED DESCRIPTION

References will now be made in detail to the various aspects and/or embodiments, examples of which are illustrated in the accompanying figures. In the following detailed description, numerous specific details are set forth in order to provide a thorough understanding of the technology. However, it will be apparent to one of ordinary skill in the art that the technology may be practiced without these specific details.

Overview of a Distributed Content Delivery System (e.g. DOZO TV)

A distributed content delivery system for streaming content to a plurality of users is briefly described herein. The system selects, for each user of the system, from a content directory (e.g. a content pool or content database) of content items such as clips, videos, audio and/or other digital content or multimedia content from a plurality of content sources or providers (e.g. web servers such as YouTube™, Netflix®, Lovefilm®, IMDB, Vimeo, Daily Motion, Spotify®, and other streaming content servers or sites etc.) and sends or transmits the selected content by way of one or more playlist(s) comprising content location data over a communications network (e.g. the Internet) to a content player associated with the user. The playlist for each user or group of users may include a list of locations or addresses for use by the content player in accessing and playing the selected content listed in the playlist, which may be specifically tailored or pre-selected for that user.

Although the content delivery system need not modify the particular content distributed to a user or group of users, in a preferred embodiment, the system may be configured to select specific content items (or deselect specific content items) to be distributed to the user or user group. It should be noted that when the term “user” is used herein, it is intended to encompass the situation where there is “one or more users” wherein the one or more user may be part of a user group based on the users' locations, relationships, interests, preferences or any other such suitable parameters. More detail regarding the selection (and/or deselection) of content items to be distributed to a user or user group will be provided below.

In this preferred embodiment, the system selects content for each user based on a user profile bank for that user. The user profile bank, in one example, may be compiled and built up over time in part from user feedback data transmitted by the content player of the user. The user profile bank for a user may include one or more user profiles (e.g. recipes or sets of instructions for generating user appropriate content) for that user; each of which may be defined and based on the user's viewing preferences derived, at least in part, from user feedback data associated with playback of content from previous and current playlists viewed by the user, the user's detected mood, genre of content, the time of day the user is viewing content, content trending, user location(s), and/or whether the user is watching with family or friends, or whether the user is watching by themselves etc. A user profile from the user profile bank for a user may be automatically selected by the system and/or the user may manually select a particular user profile for the system to use when selecting content items from the content directory. The system may select content items from a randomly generated set of content items and filter these results according to a selected user profile, in this way the user only knows that the content items will be based one of his user profiles.

The system may also maintain two or more playlists with weightings, which may be adjusted depending on negative and/or positive feedback. The two or more playlists are preferably associated with a user (or group of users). For example, the one list could be generated as a user's profile whereas the second list could be generated as a user's ‘party mix’ or generated when a user has company (which may or may not be determined when multiple remote controls are identified in the vicinity of the content player). The system may be operable to mix the two or more playlists associated with the user (or group of users) for playback. It will be appreciated that the two or more playlists may be generated by two or more separate list generation queries going to the server and/or they may be generated by the content player. Indeed, it will be appreciated that any of these steps can occur on any of the modules of the system.

A content player receives playlist(s) for a user from the system, downloads and buffers the content and plays the content to the user via one or more content item players. More than one content item player may be required due to different types or formats of the content items from the one or more content sources. Content from the playlist is downloaded and buffered such that the user experiences real-time seamless playback of the content items listed in the playlist.

In some instances, the content items in the playlist are played to the user from a random starting point within the content item. The random starting point for an entry may be selected from a time interval set to be between a start point and an end point within the content for that playlist entry. For example, the start point may be set to be 10 seconds from the start of the content, and the end point may be set to be 30 seconds from the end of the content. The start and/or end point can be selected based on feedback received from other users that have seen the particular content item. For example, if users starting the clip at 2:00 generally skip and users starting at 6:00 generally watch, then the random function may be weighted towards the latter. The content for each entry in the playlist may be played for a period of time after which the content for the next entry in the playlist is played. Additionally or alternatively, the content for each entry in the playlist may play for a set period of time or a random period of time, after which the content for the next entry in the playlist starts playing. It will be appreciated that the random starting point and indeed end point may be selected by other parameters; for example, based on points of interest derived from the content itself in the content item. It will also be appreciated that the random start point may be the beginning of the clip and/or the random end point may be the end of the clip itself (i.e. may be set as 0 seconds before the end of the clip).

The user can interact with the content player and provide user feedback to the system for use in generating user profiles and/or updating one or more user profiles in the user profile bank. The user may use an input device such as a keyboard, remote control device or smart phone configured to control the content player, or touch screen input, voice or speech recognition input or any other device or method of providing a device with input from a user. The user may provide negative feedback to the system by skipping to the next content item entry in the playlist before the content item of the current entry finishes playing. The content player may send the system one or more feedback messages indicating the content items that were skipped and also those content items that were fully played. Positive feedback may be provided by a user watching the entirety of a content item and/or watching the content item for a certain duration or time period (for example 30 seconds). The content player may allow a user to provide additional types of feedback messages such as indicators of likes and dislikes, tweets, etc.

Additionally or alternatively, the content player may provide a “DO” button configurable to be selected and to enable a user to invite related marketing solicitations or similar when the user is interested in a certain activity and which may be available whilst a user is watching a particular content item. For example, if a user was watching a rock climbing clip they may click “DO” and receive in their inbox (or via other suitable means) offers from local rock climbing clubs for discounted lessons, and the like. Additionally or alternatively, the content player can allow a user to provide additional types of feedback messages such as “BUY”, “BOOK”, “INFO”, etc.; wherein the “BUY” option may provide a user with a link to a webpage or equivalent, or provide contact details for a seller (personal and/or company) of a product and/or service provided in the content item; wherein the “BOOK” option may provide a user with a link to a webpage or equivalent, or provide contact details for a person or company offering the service which is desired from in the content item; and wherein the “INFO” option may provide a user with further detail and/or specification relating the particular product(s) and/or service(s) depicted in the content item.

The content player's playlist may have further content items injected into it in response to positive user interaction on the content player. The content locations of the further content items are sent to the content player for inclusion into the playlist of the content player. The content locations of the further content items are placed into the playlist of the content player at such a point that the further content items will be played back to the user in the near future, e.g. they may be played back to the user when the content player is ready to playback the further content items without disrupting the user experience of substantially seamless playback of the current content items in the playlist. For example if a user watches a content item about football the content player may ask the system for relevant content items (e.g. clips) associated with football, and then inject one or more further content items (e.g. clips) into the playlist of the content player so that these will be shown (e.g. played back) in the very near future. Should the user be interested in these further content items further relevant content items may be injected into the playlist again, which produces a further feedback loop between content player and the system.

This feedback may be used by the system to build the user profile bank. It is preferable that the content player for the user sends user feedback data to the system for updating one or more user profiles of the profile bank. It will be appreciated that although the feedback can update the user profile back directly, it is possible that feedback will only translate to the probability or likelihood of a user being interested in a particular content item or group of items. Different weights may also be specified for the one or more types of user feedback.

The user feedback data may include a user identity for the user, content address and/or content identity and playback information for the content of each entry in the playlist. The playback information may include the length of time the content for each entry was played, and/or may include an indication of whether the content for an entry was fully played or skipped by the user, and/or a timestamp and/or date and time the content item was played back to the user. The user feedback data may be sent by the content player to the system for analysis to determine the type of content the user prefers to allow for updating one or more of the user profiles, and/or for storage of the user feedback data as historical user data for the user.

The system may store, for each user, the user feedback data for that user as historical user data representative of the viewing sessions for that user. The historical user data may include data representative of the user feedback data such as content item identity, content item location, and whether the user liked, skipped or disliked the content item. The historical user data may be used for creating new user profiles or updating user profiles for the user etc. In addition, the system may use the historical user data for displaying to the user via the content player, a website, or a remote control device or in any other suitable manner, a list or selection of content items the user has previously watched based on the historical user data. The historical user data may be filtered to produce a list of content items based on the content items the user has liked or did not skip during playback of the content item. The content item list may also be generated based on filtering the historical user data for that user in any other way, e.g. via genre of the content item, keywords, content item identity, language, date or time one or more content items were played back to the user. The list of content items may be displayed to the user for use in the user selecting a content item from the list that they wish to watch again.

When the user selects a content item from the list, the system is configured to send a playlist including the content location or address associated with the selected content item. The playlist may be user content location data including data representative of the location or address of the selected content item from the corresponding content source. On receiving the playlist, the content player retrieves the content item for playback of the selected content item to the user. This allows the user to re-watch content items again that have been played back seamlessly. In a similar manner, the system may be configured to allow a user to request content items based on title, keywords, genre, content item identities, type of content item, and/or topics, subject-matter within the content items and/or any other characteristic or feature associated with the content item that may be used to find suitable content items from the historical data. This may allow a user to find and watch a content item that they may have heard about from their friends or a content item that is trending or in a content item global or local chart hit list.

In one example, the local charts may be based on the geographic location of a user. For example, a user in Germany may be connected to a node in the UK, and a second German user may connect to a US based node. In this example, both users would receive the same German chart should they desire local charts.

Alternatively or additionally, instead of allowing a user select a content item from the content item list, the content item list may be used by a system to generate playlist for the user, which may be sent to the content player of the user for seamless playback of the content items on the content item list. The content list can be generated on the fly and/or alternatively, they can be pre-generated. In addition to using historical data to generate a content item list for a user to select a content item to watch, the system may also generate the content item list based on content items that are trending or are on a content item chart hit list. This content item list may also be displayed to the user for selection of a content item, or additionally and/or alternatively, the trending or chart hit list may be used to generate a playlist for the user allowing the content player of the user to seamlessly playback content of the content item list.

The updated user profile(s) may be used by the system to select further content items from the content directory and/or the plurality of content sources and send the further selected content items according to a user profile for that user by way of one or more further playlist(s) to the content player of that user. As the user profile(s) develop(s) based on the user feedback data, the selected content becomes more personalised to the “tastes” of the user, which ensures the user continues to watch the selected content provided by the system. For example, the system can provide generic lists of content items and user accounts which indicate the probabilities that the user would be interested in particular content items in these generic lists; wherein the probabilities can be modified by user feedback operations.

The user profile(s) for a user may be updated based on user feedback data generated by the user's negative or positive interactions with the content player. In order to provide a user with user profiles that are “attuned” or personalised to that user, the system should receive reliable user feedback data from the content player. Should the user leave the room and/or forget that the content player is still operating or playing back content, the content player may still send user feedback data to the system. However, as the user is not in the room or not watching the content player, each content item will fully playback and may provide a series of “false” positive user feedback data because the user is not interacting with the content player. This may skew the user feedback data received by the system and the user profile(s) of the user will or could be updated based on this user feedback data, which may also skew the user profile. Instead, the system and/or content player may be configured to detect when a user is watching the content player and when they have walked away or are not watching the content player. This detection may be based on user feedback data received by the system or based on the expiry of a timer.

For example, the system may analyse the user feedback data for user usage pattern(s) based on the frequency and number of skips, likes, tweets and other user inputs to determine whether the user is watching the content player or not. Based on the user usage patterns, which may be stored as historical data for the user, the system can determine whether the user is watching the content player or not. On detecting that the user is not watching the content player based on the user input behaviour not corresponding to the user usage pattern(s), the system may suspend storing user feedback data from the content player to avoid skewing the historical user data for the user and also the user profile(s) that are updated based on the user feedback data. The system may further analyse any recently stored user feedback data of the user to determine when the user most likely left the room or stopped watching and the user feedback data that the system has stored after the user left the room or stopped watching. The user feedback data that is determined to have been stored after the user left the room or stopped watching may be removed or ignored by the system.

Alternatively or additionally, the content player may be configured to analyse the user feedback data for user usage pattern(s) and the content player may detect whether the user is watching the content player or not based on whether the input user behaviour corresponds to the user usage pattern(s). When the content player detects the user is not watching the content player, the content player may suspend sending feedback data to the system, and/or the content player may go into a standby or pause mode, or simply prompt the user to determine whether they wish to continue watching the content player. The prompt may have a timer, which once count down suspends the content player sending user feedback data or puts the content player into a standby mode. In another example, the content player may be configured to start a reminder timer based on user inactivity, which once expired reminds or prompts the user to provide some negative user feedback or at least remove the prompt. If no negative user feedback is detected or the prompt is not removed, the content player may suspend sending user feedback data to the system and/or enter a standby or pause mode until the user returns to instruct the content player to proceed with playback of the content items. Over this time, the content player may receive further playlists from the system, which is may store for future playback of content items to the user.

Alternatively or additionally, if the system detects or suspects that the user has left the room or is not watching, the system may attempt to prompt a reaction from the user by inserting one or more content items into the playlist that the user may not like. If it is determined that the user provides a negative user input, e.g. skips the content item, then the system can assume the user is still watching the playback of the content items. If the user does not skip at least one of the one or more content items, then the system can determine that the user is not watching the content items and suspend storing user feedback data as previously described.

The user profile(s) updated by the system can be used for not only personalizing the content transmitted to the user, but the profile itself provides useful information for content providers by establishing the preferences of viewers and it does this in an instantaneous way. The compilation of profile information for groups of users and/or all users will be commercially valuable to inter alia the marketing and advertising industry.

### Distributed Content Delivery System

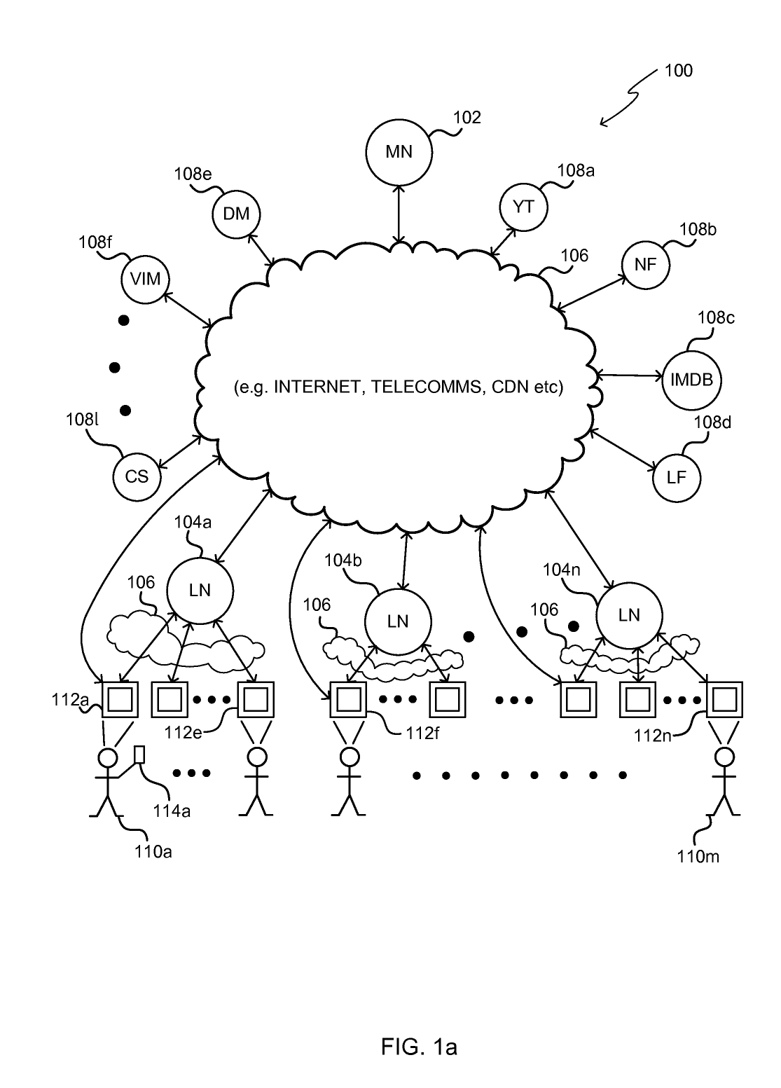

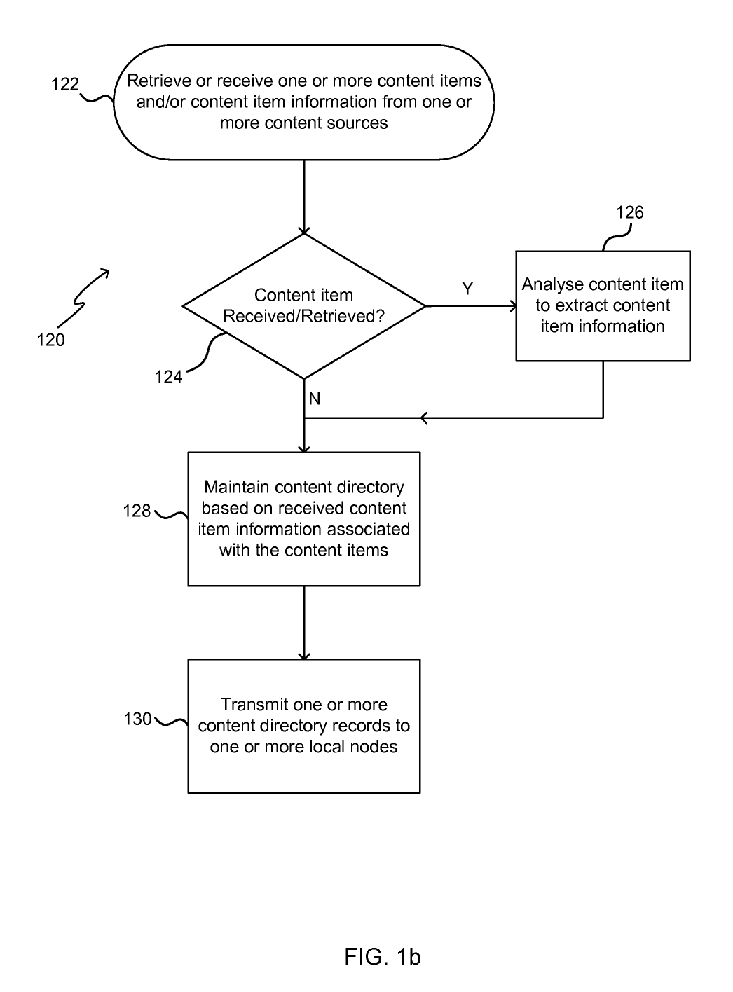

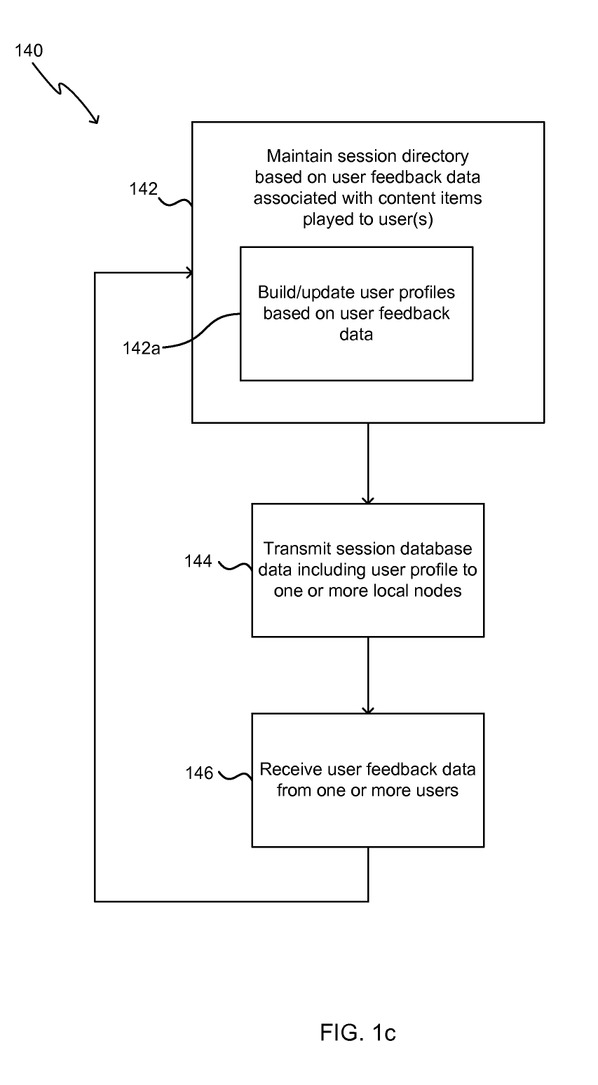

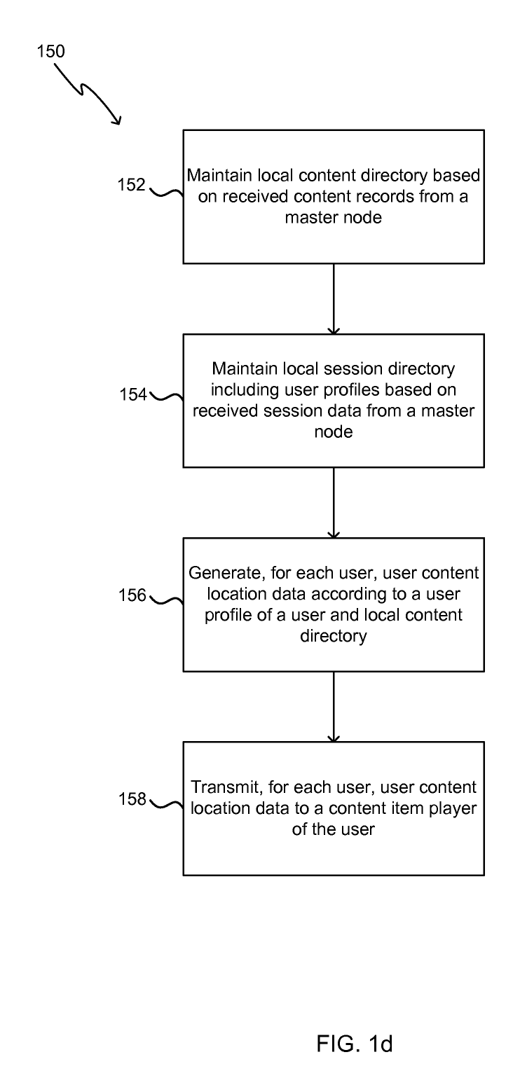

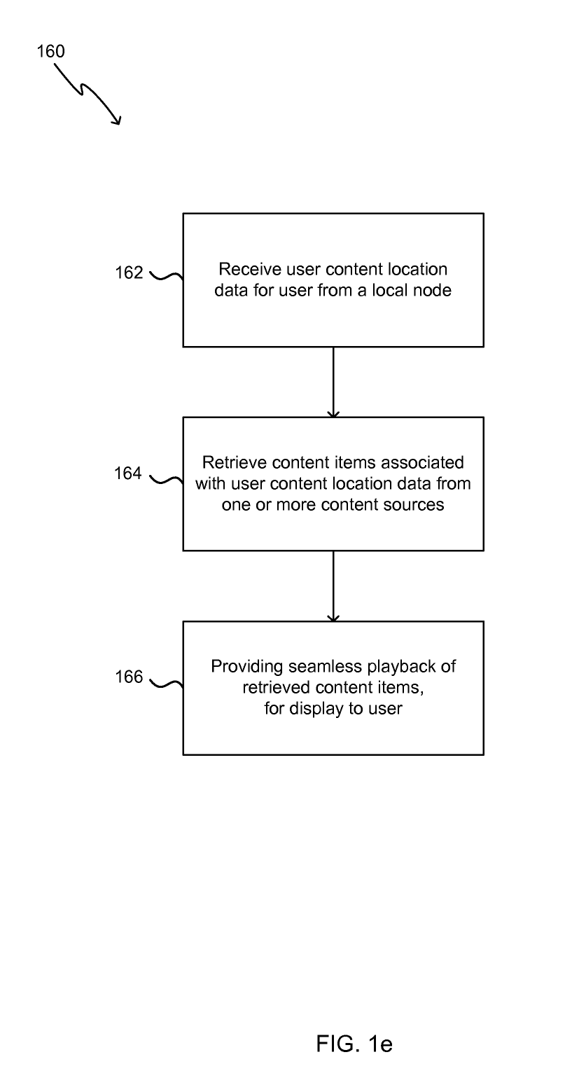

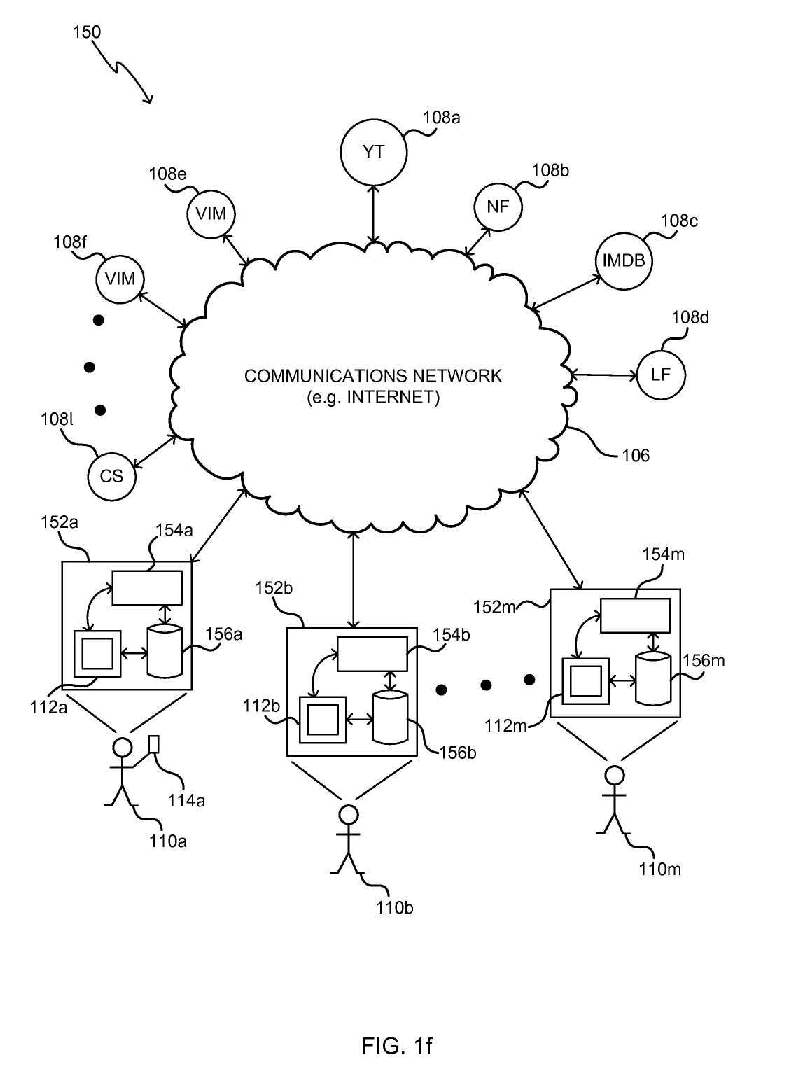

FIG. 1a is a schematic diagram illustrating an example of the distributed content delivery system 100 according to an embodiment. The distributed content delivery system 100 includes a master node 102 and a plurality of local nodes 104a-104n in communication over a communication network 106 (e.g. the Internet, telecommunications, content delivery network (CDN) and/or other networks) with the master node 102. The distributed content delivery system 100 distributes content from one or more content sources 108a-108l (e.g. web servers such as YouTube, Netflix, Love film, IMDB, Vimeo, Daily Motion, Spotify, and other streaming content servers or sites etc.) over the communications network 106, such as the Internet, to a plurality of users 110a-110m that are using the system 100 to view content. The content sources 108a-108l provide users with access to content including a plurality of content items (e.g. clips, videos, multimedia content, music or audio content, etc.) Each local node 104a of the plurality of local nodes 104a-104n serves a group of users 110a-110e of the plurality of users 110a-110m. The users 110a-110m use content players 112a-112m to access the system 100 for viewing content. Each user 110a of the plurality of users 110a-110m is associated with a content player 112a for use in receiving user content location data (e.g. playlists or clip lists) from a local node 104a serving that user 110a, where the user content location data is used by the content player 112a to playback content items selected by the local node 104a to the user 110a. Instead of each local node 104a retrieving the content items for each of the plurality of users 110a-110m, each of the plurality of content players 112a-112m uses the corresponding user content location data of each user to retrieve the selected content items from the one or more content sources 108a-108e to provide substantially seamless playback of the content items to the user whilst ensuring a scalable model.

It will be appreciated that the distributed content delivery system 100 can comprise one or more master nodes 102 connectable to the one or more local nodes 104. The one or more master nodes 102 may be operable to communicate with each other by any suitable means and/or may be intra connectable. It will also be appreciated that where multiple master nodes 102 are provided, each master node 102 may comprise each of the components as described herein or alternatively, the various components of this node may be provided on separate master nodes 102. Despite the fact that systems and methods described herein may involve one or more master nodes 102, for simplicity, reference will only be made the master node 102 in the singular. This is not intended to be limiting and therefore, any reference to “master node” should be interpreted as “one or more master nodes”.

In operation, the master node 102 maintains and stores a content directory associated with a plurality of the content items from the one or more content sources 108a-108e. The content directory may comprise a database of content records, each content record including content location data for each of the plurality of content items and information associated with each content item. In maintaining the content directory, the master node 102 communicates with the one or more content sources 108a-108e to retrieve updated content location data and information associated with the new or updated content items. The master node 102 may then process and collate all the received content location data and associated content information of the plurality of content items into the content directory.

The master node 102 may also maintain and store a session directory associated with the plurality of users 110a-110m. The session directory includes a plurality of user profile banks in which each user profile bank is associated with a user of the plurality of users 110a-110m. A user profile bank comprises one or more user profiles (e.g. content “recipes” such as sets of instructions for generating user appropriate content) for that user based on, at least in part, previous viewing habits of the user. A user profile comprises a set of instructions and/or rules for use by the master node 102 and/or local nodes 104a-104n in determining/selecting content items from the content directory and sending user content location data (e.g. one or more playlists generated/determined for a user based on a user profile) associated with the selected content items to the content player 112a associated with the user 110a. The user content location data for a user preferably simply details the location(s) of the selected content items. It will be appreciated that the user content location data may be modified depending on the geographic location of the user.

The session directory may also include, for each user of the plurality of users 110a-110m, data representative of user feedback data and/or content information collected for that user during each viewing or playback session of content items on the content player 112a associated with a user 110a. User profiles may be based on the user's viewing preferences derived, at least in part, from user feedback data associated with playback of content items from previous and current content information such as user content location data (e.g. current playlists) received by the content player 112a of the user 110a. Although the user profile bank for each user may contain only one user profile, but one or more different user profiles for a user may be generated for specific preferences of the user by analysing the user feedback data and user content location data collected and stored in the session directory for each of the users 110a-110m during viewing sessions on content players 112a-112m. The master node 102 updates the user profiles for a user based on the user feedback data from the content player 112a of the user 110a and over time, each user profile may reflect the preferences of the type of content items the user may enjoy watching.

Depending on the user feedback data from a user, the master node 102 may analyse the user feedback data and determine which user profile of the bank of user profiles may be more relevant to what the user may prefer to watch at that point in time. In effect, the user feedback data provided amounts to a form of indirect communication from the user of which user profile they may wish the master 102 or local node 104a to use when generating content to view. Additionally or alternatively, the user may communicate a preference for which user profile from their user profile bank should be used to generate content. This preference may be communicated via the content player to the master node 102 or local node 104a. The user feedback data from such sessions may be used to update the selected user profile of the user or one or more other user profiles of the user.

The master node 102 communicates the content directory records and/or updates to previous content directory records to each of the local nodes 104a-104n such that each local node 104a includes copies or substantially mirrors the content directory of the master node 102. Similarly, the master node 102 also communicates the session directory including the user profile banks or updated user profile banks to each of the local nodes 104a-104n such that each local node 104a also includes a copy or substantially mirrors the session directory of the master node 102. The master node 102 may forward to a local node 104a a portion of the session directory associated with the group of users 110a-110f serviced by that local node 104a. The master node 102 may also store a copy of the session directory via a third party service provider content delivery network such that local nodes 104a-104n may further update their session directories to substantially mirror the session directory of the master node 102.

Each local node 104a uses the received content directory records and the received session directory including the user profile banks from the master node 102 to generate user content location data (e.g. a playlist) for each user 110a in the group of users 110a-110f served by that local node 104a. The user content location data for each user 110a is based on selecting a plurality of content items from the content directory according to the user profile of each user 110a. The user content location data includes locations of the selected content items. The content list can be generated on the fly and/or alternatively, the can be pre-generated.

Alternatively or additionally, the local node 104a may use the user profile bank of a user 112a in addition with local parameters such as local content charts, local trends, and other local aspects, and the content directory to generate user content location data for the user according to one or more user profiles of the user. For each user 110a, the local node 104a transmits the user content location data for that user to the content player 112a associated with that user 110a, where the content player 112a uses the received user content location data to retrieve, from one or more of the content sources 108a-108I, the content items associated with the user content location data for seamless playback of the selected content items.

The content player 112a for a user 110a may perform seamless playback of the selected content items for the user 110a by retrieving a first portion of the corresponding content items from one or more of the content sources 108a-108e, buffering said first portion of one or more of the content items for seamless playback of the first portion of selected content items. While the buffered first portion of one or more content items are being played back, the content player 112a retrieves a second portion of the corresponding content items from the one or more content sources 108a-108e, buffers said second portion for seamless playback of the second portion after the first portion and so on. As the user content location data is consumed by the content player 112a, the content player 112a may signal the local node 104a to generate and transmit further user content location data according to the user profile of the user 110a for further seamless playback of further content items.

The content player 112a may be configured to perform a random seamless playback mode in which the content items associated with the user content location data for the user 110a (e.g. the playlist) are spooled up and played from a random playback starting point within each content item. The random starting point for a content item may be selected by the content player 112a to be any point within a time interval between a predetermined start point and a predetermined end point within the content item. For example, for content items greater than 40 seconds long, the start point may be set to be 10 seconds from the start of the content item, and the end point may be set to be 30 seconds from the end of the content item. Thus, the random starting point is selected to be a random time within the interval between 10 seconds from the start of the content item to before 30 seconds from the end of the content item. It will also be appreciated that the random start point may be the beginning of the clip and/or the random end point may be the end of the clip itself (i.e. may be set as 0 seconds before the end of the clip). The content item may be played for a set period of time, a random period of time, or until the content item is fully played after which the next content item that is buffered is spooled up and played with another random starting point within the next content item. The start and/or end point can also be selected based on feedback received from other users that have seen the particular content item. For example, if users starting the clip at 2:00 generally skip and users starting at 6:00 generally watch, then the random function may be weighted towards the latter. In addition, when viewing the playback of a content item the user 110a may wish to view the whole content item from the beginning of the content item, therefore the content player 112a may be configured to receive a user command or instruction to playback the entire content item, after which the content player 112a resumes seamless playback (e.g. random seamless playback) of the content items associated with the user content location data of the user 110a.

The master node 102 or local nodes 104a-104n may also maintain user accounts in relation to the one or more of the plurality of users 110a-110m. This allows a user 110a to login into the distribution system 100 to receive content items for seamless playback on their corresponding content players 112a. A user 110a may login to the distribution system 100 via the content player 112a by using a typical username and login password pair. Once logged in, the local node 104a associated with the user 110a generates a user content location data for user 110a and transmits this data to the content player 112a associated with the user for seamless playback of the content items associated with the user content location data. It will be appreciated that a user does not necessarily have to be affixed to a single node nor do they have to log off.

It will be appreciated that although a login into the distribution system 100 may be provided as means to identify users, the distribution system 100 may allow for anonymous access. For example, a user can use the distribution system 100 without logging in and provided the user accesses the distribution system 100 using the same computer, and preferably without clearing cookies, the distribution system 100 may provide an anonymous user profile which will tailor itself towards them. It will be appreciated that although in this example cookies are used to describe by the distribution system 100 to tailor the anonymous user profile, other alternative means can be used.

User feedback data of a user's 110a interaction with the associated content player 112a may be sent to the master node 102 for each content item that is played back to the user 110a. The user feedback data associated with each user interaction may be sent in one or more data packets to the master node via communications network 106 or via a third party network service. Once received at the master node 102, the user feedback data is processed by the master node 102 to analyse or classify the types of content items the user 110a would prefer to watch and update the user profile bank of the user accordingly. The user feedback data may be based on a user's positive feedback through a passive interaction or a user's negative feedback though an active interaction occurring during playback of each content item played back by the content player 112a. For example, when a user watches the playback of a content item for the total time set aside for playback of that content item, this is a passive interaction, then this passive interaction is interpreted as a positive feedback.

Positive feedback may also be provided by a user watching the entirety of a content item and/or watching the content item for a certain duration or time period (for example 30 seconds) and/or review of other user interactivity in respect of an item of content. However, a user 110a can provide negative feedback by actively instructing or commanding the content player 112a to skip the content item when it starts playing. The negative feedback may be weighted depending on how long the user 110a watches the content item. For example, if user 110a skips the content item very quickly from when it starts playing, then this negative feedback may be weighted more than if the user 110a skips the content item mid-way through or near the end of the total time set aside for playback of the content item. The content player 112a for the user 110a sends the user feedback data to the master node 102 for updating the user profile associated with the user 110a.

The user content location data of the user (e.g. the playlist) for the content player 112a may have further content items injected into it in response to positive user interaction or positive feedback on the content player 112a. In relation to content items that have received positive user feedback, the content player 112a may indicate to the local node 104a or the master node 102a for further content items that are relevant to the content items the user 110a apparently likes. The local node 104a may receive this indication and generate further user content location data for the user 110a that includes the content locations of the further content items. The further user location data of the user 110a is sent to the content player 112a for inclusion into the user content location data currently on the content player 112a. The content locations of the further content items may be placed into the user content location data of the content player 112a at such a point that the further content items will be played back to the user in the near future. For example, these further content items may be played back to the user when the content player 112a is ready to playback the further content items without disrupting the user experience of substantially seamless playback of current content items in the user content location data of the content player 112a. This produces a further feedback loop between the content player 112a and the master node 102 and/or the local node 104a for fine tuning the selection of the content items that will enhance the user experience.

The user feedback data for each content item may include a user identity for the user 110a, at least a portion of the user content location data such as the content item location or address and/or content identity, and playback information for the content item. The playback information may include the length of time the content item was played, and/or may include an indication of whether the content item was fully played or skipped by the user. The user feedback data is sent by the content player 112a to the master node 102 for analysis to determine the type of content the user prefers and for updating and/or generating one or more user profiles for the user profile bank of the user 110a. The updated or generated user profile(s) can be used by the master node 102 and local nodes 104a-104n to select further content items from the plurality of content sources 108a-108f and send the further selected content items by way of one or more further user content location data (e.g. playlist(s)) to the content player 112a of the user 110a. As the user profile(s) develop based on the user feedback data, the content items selected from the content directory according to the user profile(s) becomes more personalised and reflect the “tastes” of the user 110a, which ensures the user 110a continues to watch the selected content items provided by the local nodes 104a-104n.

A user 110a may select a voyeuristic mode to follow or to connect to and watch another user's seamless playback of content items. The other user 110f may be a celebrity that the user 110a may wish to follow and watch what the celebrity watches. Alternatively, the other user 110f may be a friend, where they both may wish to watch the same content items together. In order to do this, the local node 104a first checks the user 110a is allowed to follow/connect to and watch the other user's seamless playback of content items. This may be based on filters and/or permissions the other user 110f has set-up on their user account and/or associated with one or more of their user profiles. If the other user 110f sets a permission to allow voyeuristic mode for one or more of their user profiles, they may also set a skipping permission that allows additional users to instruct the content player 112f of the other user 110f to skip playback of content items while the other user 110f is watching. Typically, the skipping permission may not be set to allow additional users to skip playback of the content the other user 110f is watching, because this would then not be a true depiction of what the celebrity or friend wishes to watch.

If the user is allowed to connect and watch the other user's seamless playback of content items according to one of the user profiles of the other user, the local node 104a retrieves and transmits the user content location data based on the user profile of the other user 110f to the content player 112a of the user 110a. The content player 112a then retrieves and seamlessly performs playback of the content items associated with the user content location data associated with the other user. Depending on the permissions set by the other user 110f, the user 110a may passively watch the playback substantially in real-time, taking into account data transmission and processing delays by master node 102, local nodes 104a-104n and the networks 106, of the same content that is being controlled and watched by the other user 110f (e.g. the celebrity they are following or friend they are watching with).

When in the voyeuristic mode, the content player 112a of the user 110a may send user feedback data to the master node 102 based on the content items being retrieved and played back based on the user content location data of the other user 110f. This user feedback data may be used to update the user profile(s) of user 110a. Although the user 110a may not be able to instruct the content player 112f of the other user 110f to skip content items, the user 110a may instruct the content player 112a to send user feedback data to the master node 102 based on playback of the content to the other user 110f. For example, the user 110a may send a skip command or instruction to the content player 112a of the user 110a, although the content player 112a may ignore the skip command and continue playback of the current content item, the content player 112a may send the master node 102 user feedback data associated with a negative feedback interaction as the user wishes to skip the content item, but cannot as the content player 112a is operating in a voyeuristic mode that does not allow skipping of playback of the content. Should the user 110a watch a content item all the way through or a substantial and/or predefined period of time of the content item without issuing a skip command or instruction when the content player 112a is in voyeuristic mode, then the content player 112a may send user feedback data based on a positive feedback interaction. This mode may be used in conjunction with any other function or mode associated with the user 110a and/or the content player 112a of the user 110a.

In addition to providing a “watch alongside, live” aspect, the voyeur mode also enables a user to watch a content stream of one or more other users, even where the content streams are past content streams. For example, a user may be enabled to access the content stream, e.g. the content playlist of celebrity and/or friend and/or other user who they follow on a form of social media such as on twitter. Where a user is watching a content stream of a user they are following on twitter, for example, the entire stream of content items, or a portion thereof, will be injected to the users stream, i.e. the content item location data will be inserted into into the users content playlist, and the content items will be cued up to the same point that the original user watched it from. Access to the content stream may be provided on via the distribution system itself or via another means, for example, via the social media site.

It will be appreciated that although it is detailed above that the entire stream of content items is injected to the user's stream, this need not be the case. Indeed, the system and method can be configured such that only content items for which positive feedback has been provided is injected into the user stream (e.g. the viewer has watched over a predetermined duration of the content item (e.g. over 30 seconds) and/or has provided some other form of positive interaction (e.g. selected the ‘like’ button)).

Additionally and/or alternatively, the stream of content items which can be injected into the user's stream need not be the entirety of the stream and in fact could simply be one or more specific content items. Indeed, in one example, the stream of content items can be an amalgamation of one or more content items from one or more other users and/or one or more content items. In this example, the system is enable to compile an amalgamated stream of content items which are compiled from the content streams of, for example, your friends; wherein the amalgamated stream may be compiled with one content item from one user and then one content item from a second user and so forth (i.e. shuffled or mixed), or in any other suitable manner.

The session database master unit (e.g. D.U.D.E. (master)) 234 in one example may build up a historical store of what feedback is given and preferably store it in a way that it can be loaded into memory and queried in a timely manner on receipt of an incoming feed of user feedback. Preferably, the feedback is cached and sharded based on the potential query parameters which can be configured depending on the expected workload. Queries may be made to the session database master unit which are preferably based on filters; for example “give me all the data from this user/this country/this clip id”. In this example, once all the events are filtered, the columns of interest (e.g. playback time, time of day, location, or otherwise) are preferably combined in a requested way (e.g. averaged, summed, or otherwise) and as part of this combination process may be attributed a score value (e.g. 10 points for >30 s watched, 20 points for >2 m watched or otherwise). In this example, the session database master unit may present scores as another column and produce an output in the form of a column list (e.g. csv or excel or displayed in a table as depicted). It will be appreciated that these parameter values and/or the columns of interest are configurable based on user and/or system preferences.

Preferably, the session database master unit is operable deal with combined queries; for example: “For user A, who has friends X Y and Z, give me everything that X Y and Z have watched more than 30 seconds of and score them according to [scoring function, e.g. longer is better, liked clips score higher]”. In this example, the session database master unit may produce as output the user who watched it as well as their cue-in time and optionally details regarding when they watched it—this is the feed list. Furthermore, other queries may be “give me a list of every clip user A has watched and/or if any of these entries occur in the feed list delete them” and/or “remove duplicate clips”. This last query is particularly useful when an amalgamated content stream is being produced, for example when a content stream comprises one or more content items from more than one user as it will prevent the same content item from being shown more than one time. It will be appreciated that the above list of queries are for exemplary purposes only and should not be considered as limiting or exclusive.

Additionally and/or alternatively, an enhanced session database master unit may be provided which is less processor intensive than the session database master unit. This enhanced session database master unit preferably pre-computes the lists and makes them available to the nodes in a distributed fashion. Preferably, the enhanced session database master unit is able to download these pre-computed lists either in whole or in part. As the order is preferably known (e.g. scoring can be equated to grading content items with grades A to E, or similar, after which they should be in time order), this means that each user has multiple lists from which to take results (in the A to E example, five lists).

In this example, the enhanced session database master unit works on one friend at a time, trying to find a content item that the querying user has not seen, basically by starting at the end of the grade A list and working backwards, eliminating any entries in the “already seen” list. If nothing is found in the grade A list the system moves to grade B, and so on. Once the friend produces a viable content item that is taken, the system moves to the next friend, moving through the friends in a cycle until the required number of content items is produced to form a playlist.

By simplifying an operation that can be performed in the session database master unit in this way, the data can be made available in a distributed fashion (using, for example Amazon S3, or similar, for storage which may be accessed by http requests for partial chunks of the file) and processed efficiently as there are limited modes of configuration. The end output is the same as what is described for the session database master unit example above.

There may be times when user 110a may wish not to send user feedback data from content player 110a to the master node 102. For example, the user 110a may wish to remain “incognito” and simply watch a seamless playback of content items without their interactions with the content player 112a affecting their one or more user profile(s). The content player 112a may be set up in an incognito mode that suppresses transmission of user feedback data to the master node 102 for a period of time. When incognito mode is selected by user 110a, the content player 112a of user 110a stops sending feedback data based on the content items that are being played back to the user 110a. This mode may be used in conjunction with any other function or mode associated with the user 110a and/or the content player 112a of the user 110a.

In addition, the user may select a preview or menu mode of operation of the content player 112a or a movie mode associated with a user profile of the user profile bank of the user. The content directory may include a plurality of preview content items that are associated with one or more content items. For example, the preview content items may be movie trailers associated with movies (e.g. IMDB, Amazon, Google, Netflix or Love Film), which may be freely available or available from a subscription service. In the menu mode, the plurality of preview content items in conjunction with a user profile of the user 112a (e.g. the user profile may be based on a movie genre e.g. drama, Sci-Fi, Action, children, family, horror, boring etc.) are used to generate user content location data associated with a selection of the preview content items As the preview content items are selected according to the user profile of the user (e.g. a movie user profile of the user), the content player 112a is configured to use the user content location data associated with the selected preview content items to retrieve the content items for seamless playback to the user 110a. The seamless playback of the preview content items is effectively a menu of possible content items that the user may wish to watch. As such, the content player 112a and the distribution system 100 are configured to allow the user 110a to select a preview content item that the user 110a wishes to watch. The content player 112a communicates the selection to the local node 104a and/or the master node 102, which are configured, in response, to send user content location data of the content item associated with the selected preview content item. The content player 112a receives the user content location data associated with the content item and retrieves the content item from one of the content sources 108a-108l for playback on the content player 112a of the user 110a. Should the content item be associated with a subscription based content source or provider and should the user 110a be a subscriber of such a content source or provider, the content player 112a may be configured by the user to include user credentials or user permissions, which are used when the content player 112a retrieves and access the content item from the content source for playback to the user 110a. Should the user not be a subscriber of the content source or service provider, the content player 112a could be configured to notify the user 110a that this content item cannot be played unless they subscribe to the content source or service provider. In this way, a user 110a may be presented with a montage of possible trailers/preview content items in line with one of their user profile(s) that they will most likely wish to watch. This relieves the user 110a of the burden of knowing in advance what content item they would like to watch and may also provide the user 110a with content items in the genre that they would enjoy but did not know about.

Although a user 110a may control their content player 112a using a keyboard or other direct input for skipping content items, and/or for selecting a content item to play in full, etc., the user may wish to control the content player 112a using a remote control device 114a. Instead of using a dedicated remote control device, the user 110a may use a mobile device 114a (e.g. a mobile or smart phone, iPad, tablet, lap-top, or any other portable device that may communicate over a network) that may connect to a communications network 106. The mobile device may be configured to execute an application that performs the function of a remote control for skipping content items, and/or selecting a content item to play in full, or to like or dislike a content item, selecting modes of play such as random mode (default setting of playing random content items where no user profile filter is applied), guided stream mode (mode where the content stream is restricted in some manner, perhaps by filtering the selected content items to particular genre or some other categorization), voyeuristic mode (watching another person's stream), incognito mode (having any and all feedback options turned off), etc. Such an application may be downloaded from a repository and installed on the mobile device. In order to use the mobile device 114a as a remote control, the user may first acquire data representative of a permission and identity of the content player 112a that they wish to control. The data representative of the permission and identity is sent to the local node 104a, which registers the mobile device 114a of the user 110a with the content player 112a. The user 110a then uses the mobile device 114a to send control commands to the content player 112a via the local node 104a for controlling the playback of the content items. The local node 104a relays the commands via the communication network 106 back to the content player 112a, which may then operate according to the commands. The data representative of the permission and identity of the content player 112a may be obtained using coded data such as a Quick Response (QR) code presented or displayed by the content player 112a to the user 110a during the playback of content items. For example, a QR code may be configured with the identity of the content player 112a and also permissions, the QR code may be captured by the camera of the mobile device 114a, decoded, and the data representative of the permission and identity of the content player 112a is sent to the local node 104a for processing and registering the mobile device 114a as a remote control device for the content player 112a. In this way, a user 110a may remotely control the content player 112a.

Additionally or alternatively, the remote control may be a separate device hardwired to carry out the remote control functionality. It will also be appreciated that the remote control functionality can be provided and/or accessible to a user via a webpage and or other suitable delivery means.

### Master Node

The master node 102 may include one or more processors, one or more transmitter(s) and receiver(s), and one or more storage unit(s), the one or more processor(s) coupled to the transmitter(s), receiver(s), and storage unit(s), where at least one of the storage unit(s) include computer instructions, which when executed on at least one of the processor(s), configures the processor(s) performs, by way of example, an example process for distributing content from the one or more content sources 108a-108e over the communications network 106 to a plurality of users by the master node 102 based on the following:
A1. Maintaining a content directory associated with a plurality of content items of the one or more content sources 108a-108e, the content directory including content location data for the plurality of content items and information associated with each of the content item.
A2. Transmitting records of the content directory to one or more local nodes 104a-104n.
A3. Maintaining a user profile directory including a user profile for each of the plurality of users 110a-110m.
A4. Transmitting records of the user profile directory to one or more of the local nodes 104a-104n for use in generating, at each local node 104a, user content location data for each user 110a in the group of users 110a-110h based on selecting a plurality of content items from the content directory according to a user profile of each user 110a. The user content location data includes locations of the selected content items, where the user content location data for each user 110a is transmitted to a content player 112a associated with said each user 110a for use in retrieving the corresponding content items from the one or more content sources 108a-108e for seamless playback of the selected content items.
A5. Receiving user feedback data from the content player 112a for each user 110a during playback of the selected content items.
A6. Updating the user profile of the user 110a based on the corresponding user feedback data for the user 110a. Proceed to A1.

### Local Node

Each local node 104a may include one or more processors, one or more transmitter(s) and receiver(s), and one or more storage unit(s), the one or more processor(s) coupled to the transmitter(s), receiver(s), and storage unit(s), where at least one of the storage unit(s) include computer instructions, which when executed on at least one of the processor(s), configures the processor(s) performs, by way of example, an example process for distributing content from the one or more content sources 108a-108e over the communications network 106 to a group of users 110a-110h served by a local node 104a based on the following:
B1. Receiving one or more records of a content directory associated with a plurality of content items of the one or more content sources 108a-108e. The content directory including records of content location data for the plurality of content items and information associated with the content items.
B2. Maintaining a local content directory based on the one or more records of the content directory.
B3. Receiving one or more user profiles associated with a user profile directory, the user profile directory including a user profile for each of the group of users 110a-110h served by the local node 104a.
B4. Maintaining a local user profile directory based on the one or more user profiles of the user profile directory.
B5. Generating user content location data for each user 110a in the group of users 110a-110h based on selecting a plurality of content items from the content directory according to the user profile of said each user 110a. The user content location data including locations of the selected content items.
B6. Transmitting the user content location data for each user 110a to a content player 112a associated with said each user 110a for use in retrieving the corresponding content items from the one or more content sources 108a-108e for seamless playback of the selected content items.
B7. Receiving a request for further user content location data from one or more content players 112a-112h of one or more of the users 110a-110h. Proceed to B1.

### Content Player

Each content player 112a may comprise computer instructions stored in a storage unit or memory, which when executed on at least one processor, configures the processor to perform, by way of example, an example process for streaming content from one or more content sources 108a-108e over the communications network 106 to a user 110a of the plurality of users 110a-110m for playback of content on a display by the content player 112a associated with the user 110a as follows:
C1. Receiving user content location data for said user 110a, the user content location data generated at a local node 104a serving the user 110a. The local node 104a selects a plurality of content items of said one or more content sources 108a-108e from a content directory according to a user profile of said user 110a. The content directory includes locations of said content items and information associated with said content items, and the user content location data includes locations of the selected content items. The content list can be generated on the fly and/or alternatively, the can be pre-generated.
C2. Retrieving the corresponding content items using the received user content location data of the user 110a from the one or more content sources 108a-108e for seamless playback of the selected content items.
C3. Transmitting user feedback data from said content player 112a for use in updating the user profile of said user 110a based on the corresponding user feedback data for the user 110a.

The master node 102, the plurality of local nodes 104a-104n and the plurality of content players 112a-112m cooperate to provide seamless playback of content items to users 110a-110m according to corresponding user profiles, and using user feedback data from each of the users 110a-110m to update the corresponding user profiles of the users 110a-110m, in which updated user profiles are fed back to the local nodes 104a-104n for selecting further content items for further seamless play back for each of the users according to their user profile(s).

In addition, the content player 112a may be further configured to, in response to positive user interaction or positive feedback on the content player 112a, indicate to the master node 102 and/or local node 104a that further content items relevant to the content items associated with the positive feedback be injected into the user content location data on the content player 112a. The content player 112a may then be further configured to receive from the local node 104a further user content location data for the user 110a in response to the indication that includes the content locations of the further content items that may be relevant. On receiving the further user content location data, the content player 112a is configured to place the content locations of the further content items into the user content location data of the content player 112a at such a point that the further content items will be played back to the user in the near future. For example, these further content items may be played back to the user when the content player 112a is ready to playback the further content items without disrupting the user experience of substantially seamless playback of current content items in the user content location data of the content player 112a.

FIG. 1b is a flow diagram illustrating another example process 120 for maintaining and distributing content items by a master node 102 according to an embodiment. In order to build up a “pool” of content to draw upon, the master node 102 or the operators of the master node 102 may need to build and maintain a content directory comprising content item information associated with one or more content items of one or more content sources 108a-108l. The content item information associated with a content item may include location or address data for retrieving the content item, data representative of the characteristics, description, and/or features etc. of one or more content items, for example, metadata etc. In step 122 the master node 102 or operator of the master node 102 may retrieve and/or receive one or more content items and/or content item information associated with corresponding content items from one or more of the content sources 108a-108l. The master node 102 may be configured to schedule retrieval or receive content item information from one or more content sources to ensure the content directory is kept up-to-date such that the users of the system 100 have access to the latest content.

A content source 108a may not necessarily have ready access to the content item information associated with a content item, such that the only way to get the content item information would be to retrieve the content item, analyse the content item and extract useful content item information associated with the content item. The content items may include any digital content such as video, audio, and multimedia, which typically requires significant storage requirements. To significantly reduce these storage requirements, the received content items may be analysed to extract content item information for each content item for storage in the content directory.

In step 124, a check may be performed to determine if any content items were retrieved or received (e.g. content item retrieved/received?). If it is determined that one or more content items were actually retrieved or received (e.g. Y) by the master node 102 or operator thereof, then the process proceeds to step 126, in which case the one or more content items are analysed to extract content item information for each content item that is analysed. Otherwise, if content item information associated with one or more content items is received, then the process proceed to step 128 for updating and/or storing any new content item information associated with content items within the content directory. This may include digital processing of the content item to extract information associated with the content item such as metadata. For example, audio processing may be performed to determine the audio characteristics or description of the content item (e.g. content item title, content length, type of audio, format of audio, genre, etc.). In an additional or alternative example, video processing may be performed on the content item to determine the video characteristics or description of the content item. For example, the digital processing may extract metadata associated with a video and/or audio content item. The content item information that is extracted from the received or retrieved content items is then stored in the content directory. This reduces storage space by instead storing the content item information of the retrieved or received content items in the content directory and not the content items themselves. It will be appreciated that audio processing can be conducted to ascertain volume levels (for example, so that content items that are too loud can be filtered out or adjusted) and/or video processing can be conducted to analyse the content item for amount of motion or amount of colour (for example, to eliminate or delete content items that simply constitute still images).

Although steps 122, 124 and 126 include retrieving and analysing content items, it is to be appreciated by the skilled person that the master node 102 may not necessarily perform the portions of steps 124, 126 and 128 related to retrieving and analysing content items from one or more content sources. Instead, the content source or a third party may perform the retrieval and analysis of the content items to generate content item information associated with the content items for storage in the content directory. In this instance, the master node 102 may instead only retrieve and/or receive content item information associated with one or more content sources 108a-108l.

In step 128, the content directory is maintained by the master node 102 for storing the content item information received or retrieved from the one or more content sources 108a-108l, as well as, any content item information extracted from one or more content items retrieved and/or received from one or more content sources. Further content items and/or content item information may be retrieved and/or received from the content sources, and input to and maintained in the content directory. In step 130, the master node 102 distributes the content directory to one or more local nodes 104a-104n for further distribution of content to one or more users.

FIG. 1c is a flow diagram illustrating another example process 140 for maintaining and distributing content items by a master node 102 according to an embodiment. In step 142 the master node 102 maintains a session directory that includes records for each user includes user information collected from said each user of the plurality of users that use the distributed content delivery system 100. The user information may include historical information associated with past content items distributed to the user, user feedback data associated with user interaction during playback of one or more content items to the user. The master node maintains the session directory data for each user based on user feedback data associated with content items played back to each of the user. In step 142a, the master node 102 may further include a processor for processing the user information stored in the session database for each user to create, build or update a user profile bank for each user, the user profile bank including one more user profiles. The user profiles may be based on, but not limited to, user feedback data received at the master node 102 from each user as described herein. The user profile bank for each user is also stored in the session directory for each user. In step 142, the session directory data including user profiles is transmitted or distributed to one or more local nodes 104a-104n. The session directory may include one or more user records for storing the user data. After distributing the content directory and session directory to the one or more local nodes 104a-104n, each local node 104a stores the one or more user records. The local node 104a may generate or produce user content location data for playback to the user of the content player. The content list can be generated on the fly and/or alternatively, the can be pre-generated. The user may provide feedback associated with the content items being played back to the user. The user may interact with the content player system and provide user feedback data. In step 146, the master node 102 receives user feedback data from each user and provides the user feedback data for each user to maintaining the session database including the user profile bank, where the process returns to step 142 for processing the newly acquired user feedback data.

FIG. 1d is a flow diagram illustrating an example process 150 for a local node to maintain content and session directories and transmit content location data to each user. In step 152 the local node 104a maintains a local content directory based on received content records or data representative of the content directory of the master node 102. In step 154, the local node 104a also maintains a local session directory including user profiles and user information. In step 156, the local node 104a generates or creates user content location data according to one or the user profiles for the user and also the local content directory. In step 158, the local node 104a transmits the generated user content location data to a corresponding user for use by a content item player 112a in playing back one or more of the content items.

FIG. 1e is another flow diagram illustrating an example process 160 for a content player system 112a according to an embodiment. The content player system 112a is one of a plurality of content player systems 112a-112m. In step 162, the content player system 112a receives user content location data associated with each user. In step 164, the content items associated with the user content location data are retrieved from the one or more content sources 108a-108l. In step 166, the content item player for each content item is executed to retrieve the content items from the one or more content sources 108a-108l. The content item player assists in providing seamless playback of retrieved content items for display to the user.

Although the distributed content delivery system 100 has been described with reference to one or more master nodes 102, a plurality of local nodes 104a-104n, and a group of users 110a-110e with content players in communication with each other, it is to be appreciated by the skilled person that one or more of the functions performed by one or more master node 102, one or more local nodes 104a-104m and/or content players etc., may be centralised or distributed and implemented or executed in various entities, computing systems, or clients that result in the same or similar functionality. For example, the functions of master node 102 and one or more local nodes 104a-105m may be combined to form a content delivery system that serves one or more content players of one or more users. In another example, the distributed content delivery system may be implemented as a content delivery clients in which each content delivery client is configured to include the functionality of a master node 102a and/or local nodes 104a-104m and content players 112a-112m as described with reference to FIGS. 1a-1e.

The content delivery system or clients may also use peer-to-peer technologies other other content delivery systems and/or clients to support generation of user profiles, storage of content directories and/or session directories, user feedback loops, and selection of user content location data being performed by a content delivery system or client for each user. For example, a random access video system may include a content delivery client (e.g. a web client) for each user using a communications network (e.g. peer-to-peer technologies) where randomness and feedback loops are entirely performed within the content delivery client which discovers and communicates with other clients. For example, each client could communicate with other clients for developing content directories for use in selecting user content location data, the other clients may also act as content sources for a content delivery client.

FIG. 1f is a schematic illustration of another example of a distributed content delivery system 150 for distributing content from one or more content sources 108a-108l (e.g. web servers such as YouTube, Netflix, Love film, IMDB, Vimeo, Daily Motion, Spotify, and other streaming content servers or sites etc.) and/or content delivery clients 152a-152m over the communications network 106 (e.g. the Internet, wireless network such as a Wi-Fi network or telecommunications network) to a plurality of users 110a-110m that each have a content delivery client 152a-152m for distributing and viewing content. The content sources 108a-108l for a particular content delivery client 152a may include one or more other content delivery clients 152b-152m such that a content delivery client 152a may retrieve content items from content sources 108a-108l and/or other content delivery clients 152b-152m. As previously described, the content sources 108a-108l may provide users with access to content including a plurality of content items (e.g. clips, videos, multimedia content, music or audio content, etc.) via the content delivery clients 152a-152m. The users 110a-110m use content delivery clients 152a-152m that each include a content engine 154a-154m and content players 112a-112m for viewing content. Each user 110a of the plurality of users 110a-110m is associated with a content delivery client 152a in which the content engine 154a generates user content location data (e.g. playlists or clip lists) for use by the content player 112a in retrieving and receiving the corresponding content or content items to provide substantially seamless playback of the content items to the user 110a.

In operation, each content delivery client 152a has a content engine 154a that maintains and stores a content directory associated with a plurality of the content items, which may be based on content from the one or more content sources 108a-108e. In this example, the content directory may be stored in a local storage unit 156b such as memory or a hard disk drive, but may also be stored in external storage units e.g. a cloud based storage provider (not shown) via communication network 106. The content directory may comprise a database of content records, each content record including content location data for each of the plurality of content items and information associated with each content item. In maintaining the content directory, the content engine 154a may communicate with the one or more content sources 108a-108e to retrieve updated content location data and information associated with the new or updated content items. In addition or alternatively, the content delivery clients 152a-152m may communicate with each other via a peer-to-peer network in which each content engine 154a may communicate with one or more corresponding content engines 154b-154m to retrieve content location data and information associated with content items stored in content directories of the other content delivery clients 152b-152m that are not within content directory of content delivery client 152a.

Furthermore, as the content players 112a-112m of each content delivery client 152a-152m may retrieve one or more content items based on user content location data generated for each of the users 110a-110m, the retrieved content items may be cached or stored within each corresponding content delivery client 152a-152m, for example, in storage units 156a-156m. This means the content delivery clients 152a-152m may be able to share content items with other content delivery clients 152b-152m. For example, each content delivery client 152a-152m may be configured to send content information comprising the address or location of said each content delivery client 152a-152m and one or more content items stored on said each content delivery client 152a-152m to other content delivery clients 152a-152m. The content delivery clients 152a-152m on receiving content item information from other content delivery clients 152a-152m may update their content directories such that content items may be shared in a peer-to-peer fashion over communication network 106.

The content delivery clients 152a-152m may form an ad hoc peer-to-peer network with content delivery clients 152a-152m joining and/or leaving the adhoc peer-to-peer network. In such cases, updated messages may be required to be sent between content delivery clients 152a-152m to allow clients to maintain their content directories for when a content delivery client 152a leaves the network, and/or for when a content delivery client joins the network.

Each content engine 156a may also maintain a session directory associated with each user of a content delivery client 152a. In this example, the session directory may be stored in a local storage unit 156b such as memory or a hard disk drive, but may also be stored in external storage unit(s) e.g. external server in network or a cloud based storage provider (not shown) via communication network 106. The session directory may include one or more user profile banks in which each user profile bank is associated with a user of the content delivery client 152a. As previously described, a user profile bank may include one or more user profiles (e.g. content “recipes” such as sets of instructions for generating user appropriate content) for that user based on, at least in part, previous viewing habits of the user. A user profile comprises a set of instructions and/or rules for use by the content delivery client 152a in determining/selecting content items from the content directory to generate user content location data (e.g. one or more playlists generated/determined for a user based on a user profile) associated with the selected content items for playback on a content player 112a.

The session directory may also include, for each user of the content delivery client 152a, data representative of user feedback data and/or content information collected for that user during each viewing or playback session of content items on the content player 112a. User profiles may be based on the user's viewing preferences derived, at least in part, from user feedback data associated with playback of content items from previous and current content information such as user content location data (e.g. current playlists). Although the user profile bank for each user may contain only one user profile, one or more different user profiles for a user may be generated for specific preferences of the user by analysing the user feedback data and user content location data collected and stored in the session directory for each of the users 110a-110m during viewing sessions on content players 112a-112m. The content engine 154a may update the user profiles for a user based on the user feedback data from the content player 112a of the user 110a and over time, each user profile may reflect the preferences of the type of content items the user may enjoy watching.

Depending on the user feedback data from a user, the content engine 154a may analyse the user feedback data and determine which user profile of the bank of user profiles may be more relevant to what the user may prefer to watch at that point in time. Additionally or alternatively, the user may communicate to the content engine 154a a preference for which user profile from their user profile bank should be used to generate content. The user feedback data from such sessions may be used to update the selected user profile of the user or one or more other user profiles of the user.

Each content engine 154a uses the content directory and session directory of the content delivery client 152a to generate user content location data (e.g. a playlist) for each user 110a. The user content location data for each user 110a is based on selecting a plurality of content items from the content directory according to the user profile of each user 110a. The user content location data includes locations of the selected content items. The user content location data is provided to the content player 112a, where the content player 112a uses the received user content location data to retrieve, from one or more of the content sources 108a-108l and/or from one or more content delivery clients 152a-152m, the content items associated with the user content location data for seamless playback of the selected content items.

The content player 112a for a user 110a may perform seamless playback of the selected content items for the user 110a by beginning to retrieve one or more of the content items based on the user content location data, and performing playback of any sufficiently buffered content item that has been retrieved, as more and more of the subsequent content items become sufficiently buffered these items may also be played back once the previous content item has been dealt with according to user interaction with the player 112a, e.g. fully played back or skipped. As the user content location data is consumed by the content player 112a, the content engine 154a generates further user content location data for consumption by the content player 112a for further seamless playback of further content items.

As described with reference to FIGS. 1a-1e, the user feedback data of a user's 110a interaction with the associated content player 112a may be feedback to the content engine 154a for each content item that is played back to the user 110a. The user feedback data is processed by the content engine 154a to analyse or classify the types of content items the user 110a would prefer to watch and update the user profile bank of the user accordingly. The user feedback data may be based on a user's positive feedback through a passive interaction or a user's negative feedback though an active interaction occurring during playback of each content item played back by the content player 112a. The user feedback data for each content item may include a user identity for the user 110a, at least a portion of the user content location data such as the content item location or address and/or content identity, and playback information for the content item. The playback information may include the length of time the content item was played, and/or may include an indication of whether the content item was fully played or skipped by the user. The user feedback data is analysed by the content engine 156a to determine the type of content the user prefers and for updating and/or generating one or more user profiles for the user profile bank of the user 110a. As the user profile(s) develop, update or change based on the user feedback data, the content engine 154a uses the up-to-date user profile(s) to generate user content location data for selecting content items from the content directory that are more personalised and reflect the “tastes” of the user 110a. This ensures the user 110a continues to watch the selected content items provided by the content engine 156a. Each content delivery client 152a-152m may be configured to include one or more further functions as of the one or more master node(s) 102, one or more local nodes 104a-104n, and content players 112a-112m as described with reference to FIGS. 1a-1e.

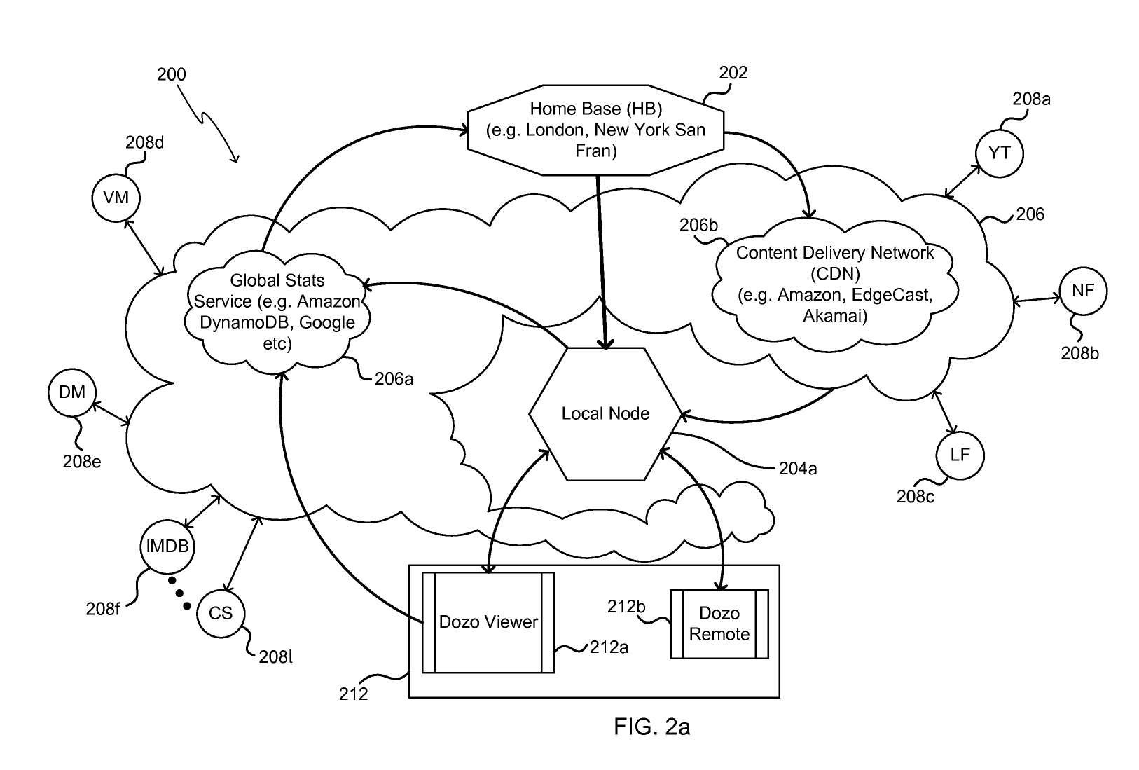

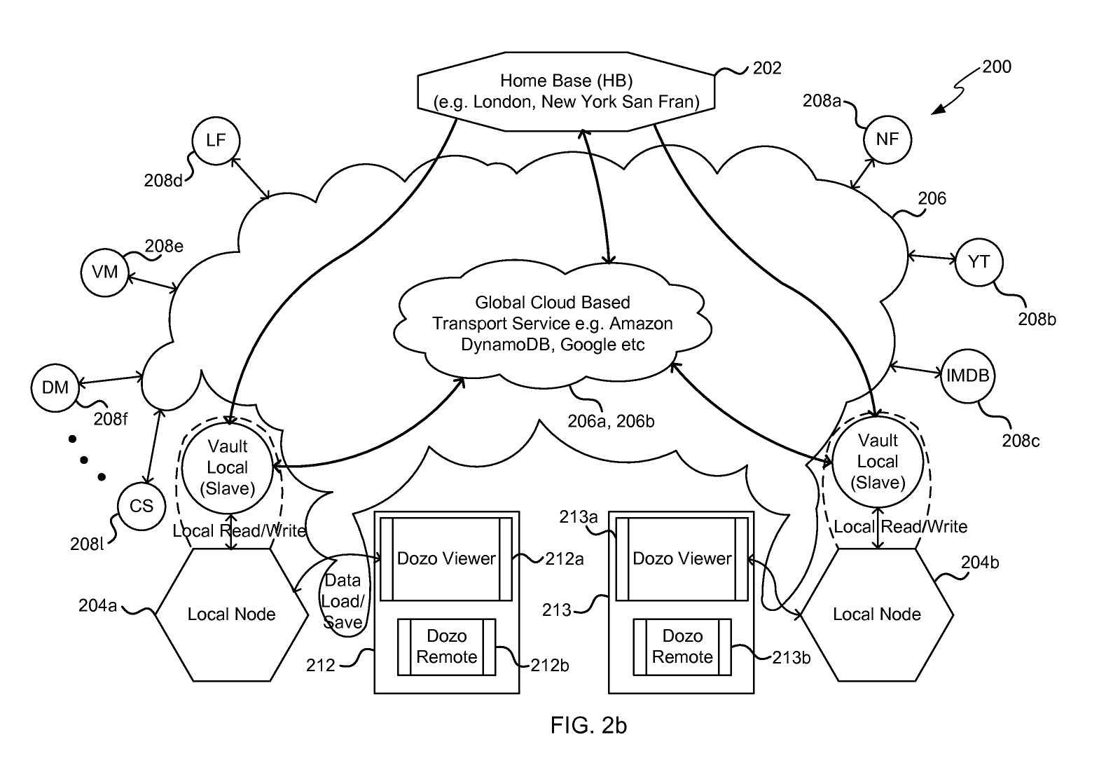

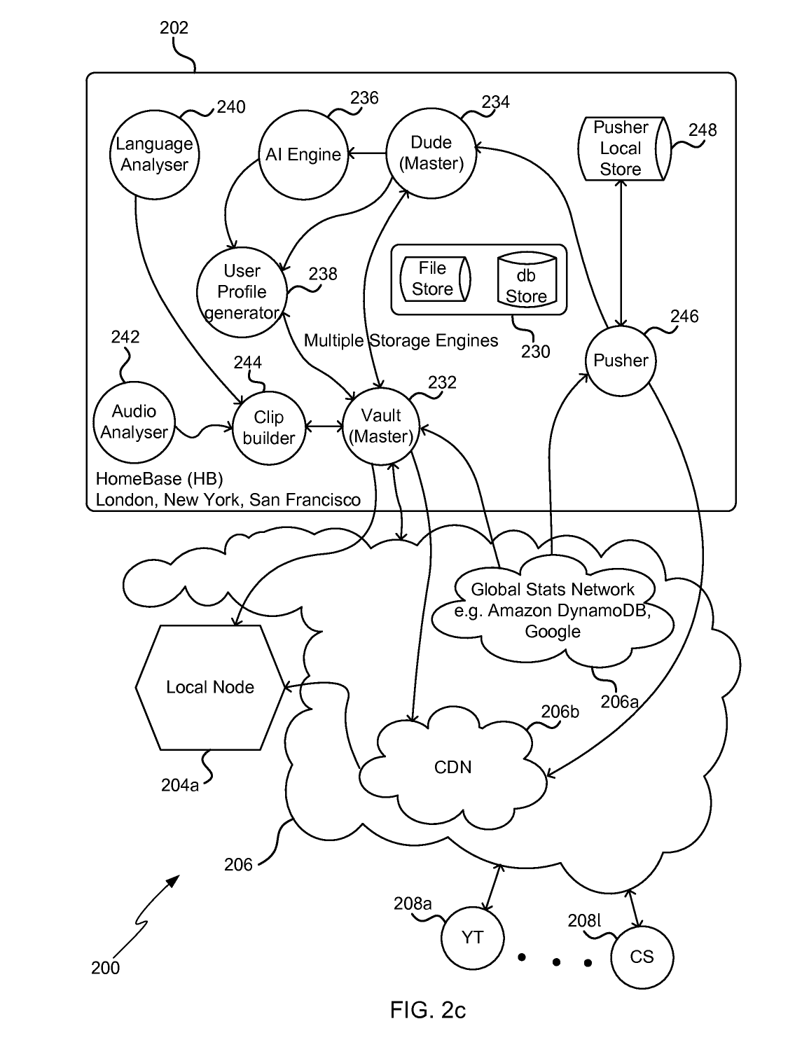

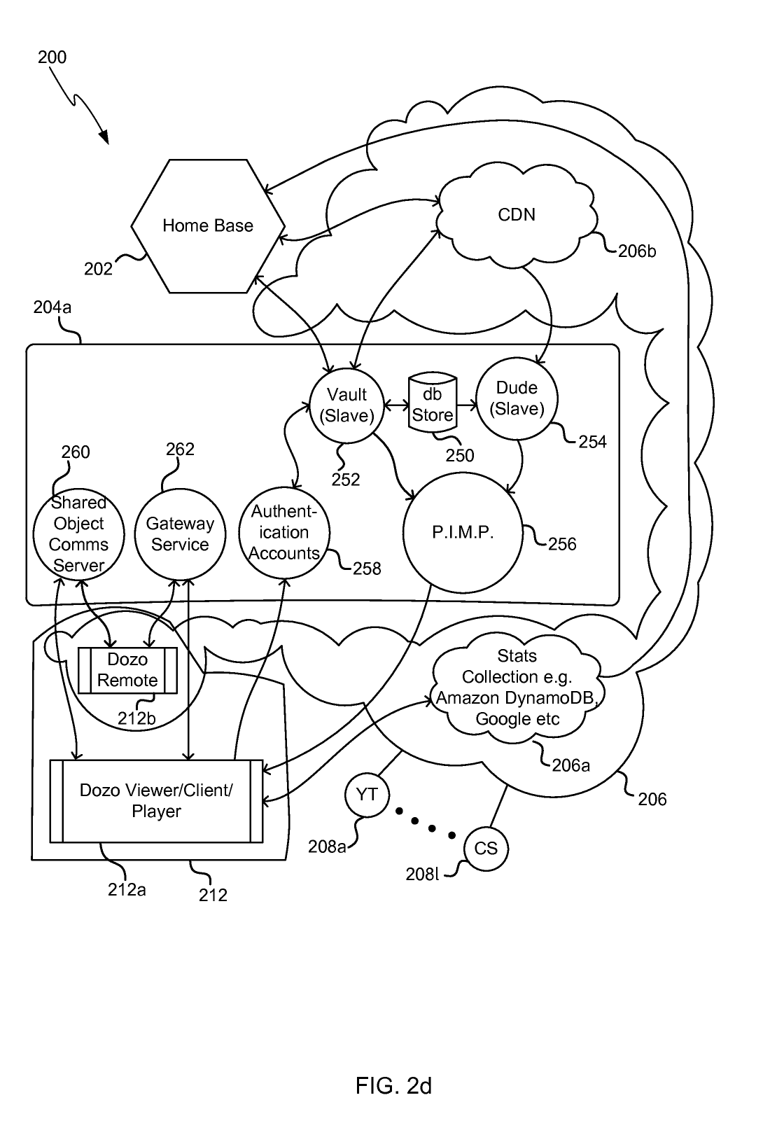

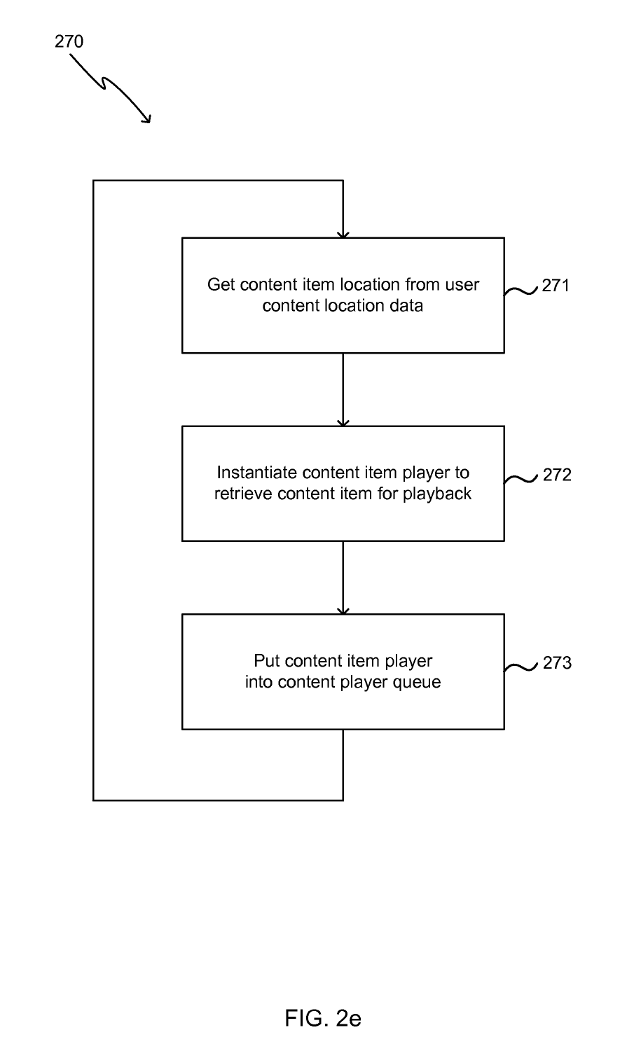

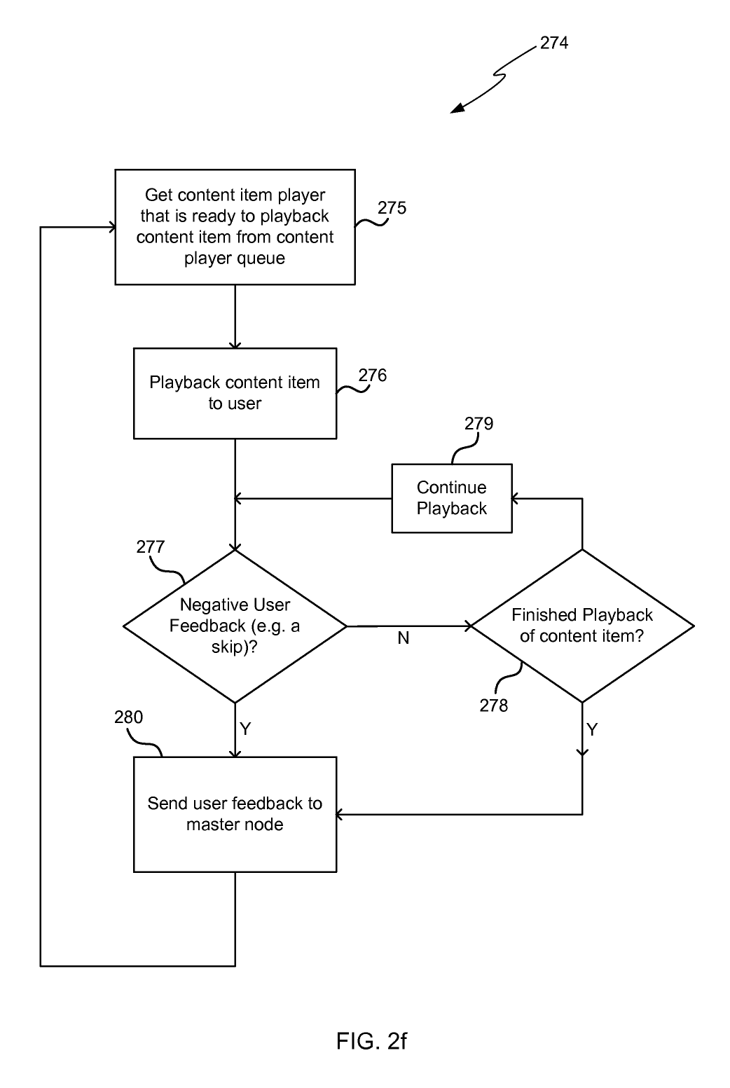

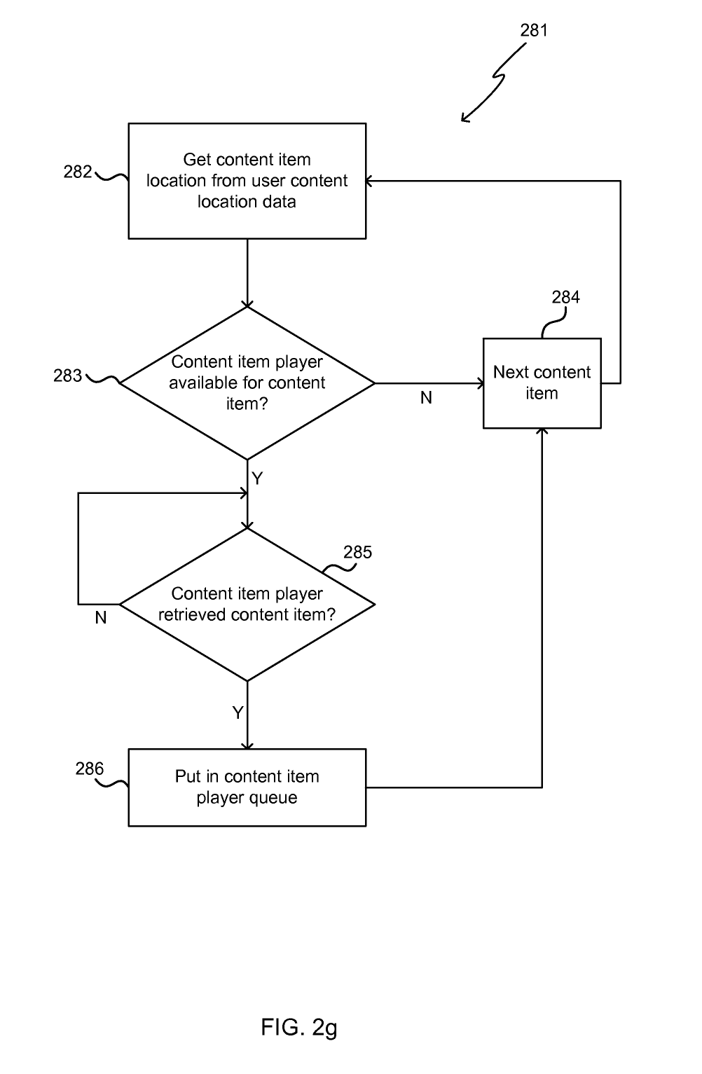

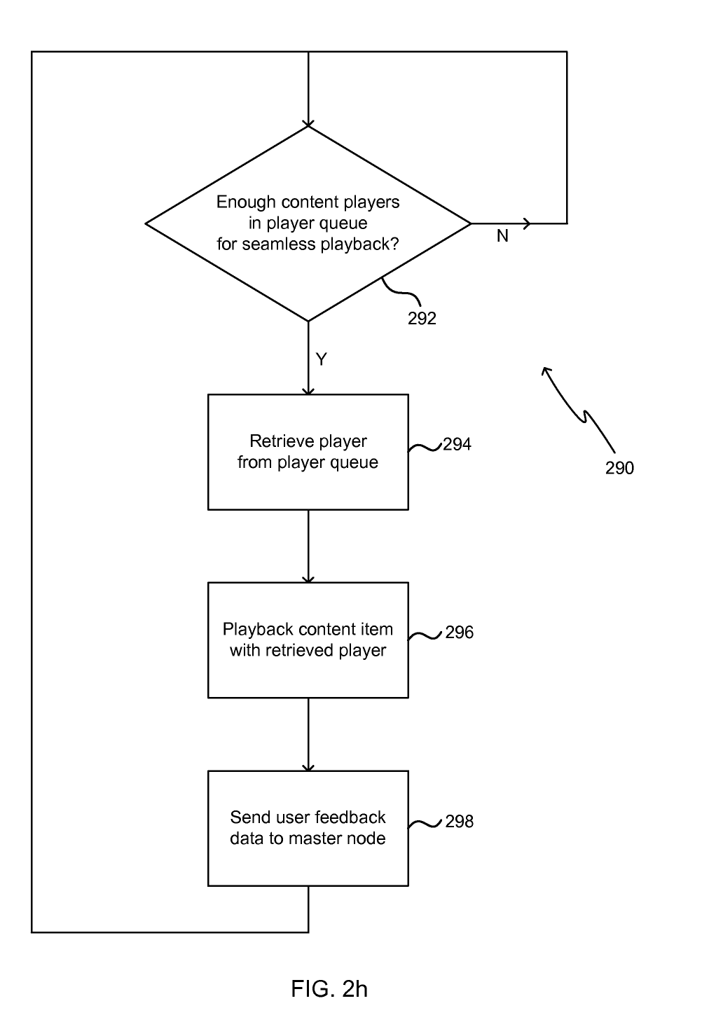

FIGS. 2a and 2b are schematic diagrams illustrating other examples of a distributed content delivery system 200 for delivering content to a plurality of users according to an embodiment. The distributed content delivery system 200 includes a master node 202 (e.g. Home Base (HB)) in communication with a plurality of local nodes, for example, local nodes 204a and 204b over a communication network 206 (e.g. the Internet and/or other data or telecommunication networks etc.). Communication network 206 may further include a one or more communications networks or overlay networks of various data service providers (e.g. global statistics services, content delivery networks and/or other dedicated data networks) for storing and communicating data between the master node 202 and local nodes 204a-204b for use in enabling the delivery of content from one or more content sources 208a-208l (e.g. web servers such as YouTube, Netflix, Lovefilm, IMDB, Vimeo, Daily Motion, Spotify, and other streaming content servers or sites etc.) to the users via content player systems 212-213 of the distributed content delivery system 200. Each of the local nodes 204a-204b serves a group of one or more users of the plurality of users within the distributed content delivery system 200. The content player systems 212-213 associated with the users are in communication with the master node 202 and a corresponding local node 204a-204b. Each local node 204a enables the delivery of personalised content or content items to each user by configuring each content player system 212 or 213 of a user to access a selection of the plurality of content items (e.g. clips, videos, multimedia content, audio content, etc.) personalised for the user from content sources 208a-208l for playback to the user via the content player system 121 or 213.

In the example of FIG. 2a, the master node 202 is in communication with the local nodes 204a-204b via communication network 206, which also includes a content delivery network (e.g. Amazon, EdgeCast, Akamai) 206a and a global statistics service network 206b providing a global statistics service (e.g. statistics via a cloud based collecting service, e.g. Amazon DynamoDB, Google, etc.) for providing the local nodes 204a and 204b with the necessary user profile and content data. This provides the local nodes 204a and 204b with enough user and content information to generate, for each user in the group of users served by the local node 204a or 204b, user content location data including locations of selected content items according to a user profile (e.g. playlists) for configuring the content player systems 212 or 213 for accessing the selected content items from one or more content sources 208a-208l to provide a personalised playback of content or content items for that user.

In the example of FIG. 2b, the master node 202 is in communication with the local nodes 204a-204b via communication network 206, which also includes global statistics service network 206b providing a global statistics service (e.g. statistics via a cloud based collecting service, e.g. Amazon DynamoDB, Google, etc.). The master node 202 may use the communications network 206b to provide the local nodes 204a and 204b with the necessary user profiles (e.g. recipes) and content data (e.g. a content directory or pool of content) such as updates to the user profiles and content data. Alternatively, the master node 202 may use the communications network 206b to provide the local nodes 204a and 204b with all the user profile data (e.g. recipes) and content data (e.g. a content directory or pool of content) and also further updates of such data. The master node 202 may also store copies of the user profiles and content data in network 206b, from which the local nodes 204a-204b may retrieve further user profiles and content data. This provides the local nodes 204a and 204b with enough user and content information to generate, for each user in the group of users served by the local node 204a or 204b, user content location data including locations of selected content items according to a user profile of a user (e.g. playlists) for configuring a content player system 212 or 213 of the user to access the selected content items from one or more content sources 208a-208l to provide a personalised seamless playback of content or content items to that user.

Referring to FIGS. 2a and 2b, the distributed content delivery system 200 is a scalable delivery system that uses the master node 202 and local nodes 204a and 204b to facilitate distribution of content or content items from one or more content sources 208a-208e over the communications network 206 (e.g. the Internet) to the plurality of content player systems 212, 213 associated with one or more users. In this example, the master node 202 may be located or distributed in one or more geographic regions (e.g. London, New York, San Francisco etc.) and represents a processing hub of the system 200 that receives and processes the necessary user and content data for distributing user profile and content location data to the local nodes 204a-204b. For example, the functionalities of the master node 202 can be centralised in one geographic region (e.g. London) or can be distributed over one or more geographic regions (e.g. London, New York, China, San Francisco, etc.) to distribute the processing load and functions of the master node 202. Depending on the geographic distribution of the plurality of users in the system 200, the local nodes 204a-204b are deployed to serve a group of the plurality of users in one or more geographic regions. Each local node 204a-204b processes, for users in the group of users served by that local node 204a-204b, the received user profile and content data sent from the master node 202 and generates, for each user in the group, user content location data (e.g. playlists) for sending to each user to configure the content player system 212 and 213 to provide a personalised playback of content or content items for that user.

In these examples, a content player system 212 of a user is in communication with local node 204a and another content player system 213 of another user is in communication with local node 204b. Each content player system 212 and 213 further includes a content player 212a and 213a that provides playback of content items to the associated user and a content player remote 212b and 213b that allows the user to control playback of content items on the content player 212a or 213b. The content player systems 212 or 213 are also configured to communicate user feedback data associated with content items played back to the user on content players 212a and 213a to the master node 202. The users may provide this user feedback data via the content player remotes 212b and 213b via local nodes 204a and 204b or via direct input to the content player systems 212 and 213 (e.g. via keyboard, mouse, remote control devices, or other input devices). Each user of the plurality of users is associated with a content player system 212 or 213 for use in receiving user content location data (e.g. playlists or clip lists) from a local node 204a or 204b serving that user that configures the content player 212a or 213a to playback selected content items associated with the user content location data (e.g. playlists) to the user. The content player 212a uses the user content location data to retrieve or download and buffer the selected content items from the one or more content sources 208a-208l for seamless playback of the content items to the user.

In operation, the master node 202 maintains and stores a content directory associated with a plurality of the content items from the one or more content sources 208a-208l. The master node 202 may maintain and store the content directory using the content delivery network 206b and/or maintain and store a master copy of the content directory on storage associated with the master node 202 (e.g. a master file store or database etc.). The content directory may comprise a database of records, each record including content location data for each of the plurality of content items and content information associated with each content item. The content location data may include the identity of the content items and location or address for accessing the content item. The content information associated with each content item may include data representative of a description of the content item.

In maintaining the content directory, the master node 202 communicates with the one or more content sources 208a-208f to retrieve updated content location data and content information associated with new or updated content items. The content location data for each content item may include the location or address of the content item (e.g. the uniform resource identifier and/or location) associated with one of the content sources 208a-208l. The master node 202 processes and collates all the received content location data and associated content information into the content directory.

The content information can include metadata associated with the content item. Metadata is typically used to describe each content item to enable efficient searches of and for the content item without requiring download and manual analysis/viewing of the content item's content. Metadata of a content item can include a variety of information such as the content title, name, keywords, description of the content, if the content is a video then description of scenes in the content, transcripts or text describing the content, content format, content size, content type, catalogue or genre of content, indications of ownership or copyright, age restrictions, etc. The metadata can be accessed by a search engine that uses the metadata to efficiently perform a search or filtering operations for appropriate content on a plurality of content items based on various search criteria/ion.

However, when content information such as metadata is not readily available from the one or more content sources 208a-208l for one or more content items, in retrieving content information for a content item from such sources 208a-208e, the master node 202 or a function thereof may access and download the content of the content item for processing and analysis to determine appropriate metadata describing the characteristics of the content item (e.g. type of content, genre of content, age restrictions, language, keywords etc.). The metadata is then stored along with the content location data for those content items in the content directory.

The master node 202 also maintains a session database that includes data representative of the historical and current content and user data associated with each user in the distributed content delivery system 200. The session database may store historical data of each of the plurality of users derived from the viewing sessions of each user in the system 200, and also store user data for each user, for example, a user profile bank for each of the plurality of users, the user profile bank for each user including one or more user profile(s) that may be updated during each viewing session of the user.

The historical content and user data may include data representative of everything or all the content items that each of the users has already watched or had played back on the content player systems 212 or 213 associated with each user. The current content and user data may include data representative of all the content items that the system 200 has arranged for each of the users to receive and play back on their content player systems 212 or 213. In addition, the historical and user data also includes data representative of user feedback data associated with everything or all the content items the user has watched, has only just watched, or has had played back on their content player system 212 or 213. The historical content and user data for each user of the plurality of users is stored in the session database the master copy of which is stored by the master node 202 in the distributed content delivery system 200.

The session database is used for storing the user profile bank for each user, for storing generated user profiles, updates to user profiles. The user profile bank for each user may include one or more or a plurality of user profiles for each user in the distributed content delivery system 200. A user profile includes a set of instructions and/or rules for use by the master node 202 and/or local nodes 204a-204b in determining/selecting content items from the content directory and sending user content location data (e.g. one or more playlists generated/determined for a user based on a user profile) associated with the selected content items to the content player 212a associated with the user. Each user may have one user profile (e.g. a general user profile) or multiple user profiles (e.g. multiple user profiles each generated based on the historical and user data stored in the session database) stored in the user profile bank for that user.

The user profile(s) for a user may be generated based on the historical content and user data collected and associated with each user and stored in the session database. This user data includes user feedback data associated with playback of the content items on the content player system 212 or 213 of a user. The user feedback data is used to update one or more of the user profile(s) of the user. Each user profile is thus based on the user's viewing preferences, which is derived, at least in part, from user feedback data associated with playback of content items from previous, historical content data that has been received by the content player system 212 or 213 of the user, as well as, current user content control data (e.g. current playlists) received by the content player system 212 or 213. The master node 202 updates the user profiles based on the user feedback data and over time, each user profile reflects the preferences of the type of content items the user may enjoy watching.

The master node 202 communicates the session database (e.g. historical data and user profile bank) and content directory records and/or updates to the session database and previous content directory records to each of the local nodes 204a or 204b. This may be achieved via a direct feed communication over communication network 206 (e.g. via Internet 206a) and a global update feed communication sent via a third party service provider network 206b or 206c.

For example, updates to the session database and content directory may be sent directly to the local nodes 204a and 204b via communication network 206 (e.g. via Internet 206a) as illustrated in FIGS. 2a and 2b. Each local node 204a receives updates of the session database associated with the group of users for that local node 204a or 204b and updates to the content directory. The local nodes 204a and 204b maintain local session databases, which over time, substantially mirrors the session database and content directory of the master node 202 for that group of users.

In addition, the master node 202 can store a copy of the session database and content directory with a third party distribution and storage service 206a and/or 206b in communication network 206. The master node 202 may send global updates for all users of the session database and/or content directory to the third party communication network 206a or 206b, used to update a copy of session database stored by the third party or cloud based data storage service 206a and/or 206b e.g. Content Delivery Network (CDN) (e.g. Amazon, EdgeCast, Akamai) 206b as illustrated in FIG. 2a or a Global Cloud Based Transport Service 206b (e.g. statistics via a cloud based collecting service, e.g. Amazon DynamoDB, Google, etc.) as illustrated in FIG. 2b. The global update of the session database stored in the third party service 206a or 206b may be periodically sent or “pushed” to each of the local nodes 204a and 204b, or each of the local nodes 204a and 204b may “pull” update of the session database and/or content directory from the third party service 206a and/or 206b.

Alternatively, the updates to the session database and content directory for all users may be sent directly to each of the local nodes 204a and 204b via communication network 206 (e.g. via Internet 206a) as illustrated in FIGS. 2a and 2b. Each local node 204a and 204b receives updates of the session database associated with all users in the system 200 and updates to the content directory. The local nodes 204a and 204b maintain local session databases and local content directories, which over time substantially mirror the session database and content directory of the master node 202 for all users of system 200. The master node 202 may then only store a back-up of the session database and content directory with the third party distribution and storage service 206a and/or 206b in communication network 206. The master node 202 may send global updates for all users of the session database and/or content directory to the third party communication network 206a and/or 206b, which is used to update a the back-up copy of the session database. Local nodes 204a and 204b may then, when necessary, consult the back-up copy of the session database stored by the third party communication network 206a and/or 206b.

In any event, the local nodes 204a and 204b are supplied by the master node 202 over the communications network 206 a copy of the session database and content directory. Thus, each local node 204a or 204b has a local node session database and content directory (e.g. Vault local (slave)) that substantially mirrors the session database and content directory of the master node 202. Each local node 204a or 204b reads from and writes to the local node session database and content directory for that local node 204a or 204b.

Each local node 204a or 204b reads from the local node session database and content directory the user profile banks and content directory records associated at least with the group of users served by the local node 204a and 204b and generates user content location data (e.g. a playlist) for each user of the group of users. The user content location data for each user is based on selecting a plurality of content items from the content directory according to a user profile of each user. The user content location data includes locations of the selected content items. For each user, the local node 204a or 204b transmits the user content location data for that user to the content player system 212 or 213 of that user. The content player 212a or 213 is configured to cause the content items in the received user content location data (e.g. playlists) to download from one or more of the content sources 208a-208l, buffer (or cue) the downloaded content items, and play back the content items associated with the user content location data to produce a seamless playback of the selected content items on the content player 212a or 213a. During the viewing session of the user (i.e. while the content player system 212 or 213 of the user is still logged with the system 200), the local nodes 204a and 204b may generate one or more further user content location data according to a user profile of the user, which is sent to the content player system 212 or 213 for each user to ensure that user experiences a seamless playback of content items.

For example, the content player 212a or 213a for a user may perform seamless playback of the selected content items for the user by retrieving a first portion of the corresponding content items from one or more of the content sources 208a-208l, buffering said first portion of one or more of the content items for seamless playback of the first portion of selected content items. While the buffered first portion of one or more content items are being played back, the content player 212a or 213a may retrieve a second portion of the corresponding content items from the one or more content sources 208a-208e, buffers said second portion for seamless playback of the second portion after the first portion and so on. As the user content location data is consumed by the content player 212a or 213a, the content player 212a or 213a may signal the local node 204a or 204b to generate and transmit further user content location data (e.g. playlists) according to the user profile of the user for further seamless playback of further content items. The master node 202 or local nodes 204a or 204b are configured to maintain user accounts for the plurality of users or for the group of users associated with each local node 204a or 204b. A user may login into the distribution system 200 to begin a viewing session and so begin to receive content items for seamless playback on their corresponding content player systems 212 or 213. A user may login to the distribution system 200 via the content player system 212 or 213 using a typical username and login password pair. This information may be sent via a user data (Vault) communication connection with the local node 204a or 204b, which may be coupled to master node 202. Because each local node 204a and 204b has a local node session database and content directory that substantially mirrors the session database and content directory at the master node 202, this means that once a user has logged in to the system 200, the local node 204a associated with the user can immediately generate user content location data for user and transmit this data to the content player system 212 or 213 of the user for seamless playback of the content items associated with the user content location data. When viewing session for the user ends (e.g. the user logs off of the content player system 200 or the user is no longer considered to be registered or viewing the playback of the content items) the local nodes 202a and 204b may cease to generate further user content location data, the master node 202 can register the user as being logged off. It will be appreciated that it is not essential for the operation of the system that a user logs off.

It will also be appreciated that although a login into the distribution system 100 may be provided as means to identify users, the distribution system 100 may allow for anonymous access. For example, a user can use the distribution system 100 without logging in and provided the user accesses the distribution system 100 using the same computer, and preferably without clearing cookies, the distribution system 100 may provide an anonymous user profile which will tailor itself towards them. It will be appreciated that although in this example cookies are used to describe by the distribution system 100 to tailor the anonymous user profile, other alternative means can be used.

User feedback data representative of a user's interaction with the associated content player system 212 or 213 is transmitted back to the master node 202 for each content item that is played back to the user. The user feedback data associated with each user interaction may be sent in one or more data packets to the master node via communications network 206. For example, in FIG. 2a the user feedback data may be sent via the third party service and/or storage system 206a (e.g. Global Stats Service), the user feedback data may include, by way of example only, the content items skipped by the user, time watched etc. The master node 202 may receive or retrieve the user feedback data from the third party service 206a for updating the session database of the master node and further processing, e.g. updating the user profile bank etc. In order to reduce bandwidth and overload of information, the master node 202 may periodically schedule user feedback data updates to be transmitted/retrieved from the third party service 206a.

In the example of FIG. 2b, the user feedback data may be sent from the content player system 212 or 213 via the local node 204a or 204b, where the local node 204a or 204b uses to update the local node session database and also sends the user feedback data to the master node 202 via the third party service 206a. Again the master node 202 may retrieve the user feedback data from the third party service 206a for updating the session database of the master node 202 and further processing, e.g. updating the user profile bank etc. Updates to the local node session database of a local node 204a may be periodically transmitted to the third party network service 206a (e.g. Global Cloud Based Transport Service (e.g. statistics via a cloud based collecting service, e.g. Amazon DynamoDB, Google, etc.)) for storage and subsequent retransmission via communicating network 206 to the master node 202 for updating the session database. These communications may be sent periodically from the plurality of local nodes 204a and 204b to the master node 202 for updating the session database at the master node 202.

The user feedback data is historical data for the user that is used to update the session database of the master node 202. The user feedback data is processed by the master node 202 to generate and/or update the user profile bank of the user stored in the session database. The user feedback data may be used to analyse and classify the types of content items the user would prefer to watch based on their historical data stored in the session database. The feedback data is based on a user's negative feedback through an active interaction occurring during playback of each content item played back by the content player 212a or 213b. The feedback data may also be based on a user's positive feedback through a passive interaction occurring during playback of each content item and/or watching a predetermined amount of the content item played back by the content player 212a or 213b.

In one example, the user feedback data has a predetermined selection time limit or duration attributed thereto such that only feedback provided within or outside a particular time limit or duration updates the content stream. This enables a user to be selective about what goes into their content stream. For example, the system may be set to only include feedback into the content stream after a predetermined amount of time (i.e. only provide positive feedback when a user has viewed 30 seconds of the content time). By providing for the act of content curation by saying no within a fixed time limit, a user can provide a ‘richer’ or better content stream. Therefore, it is only content items which are watched for period of time which exceeds a specified time period that are curated, which is preferably an automatic process wherein the system automatically adds content items on which positive feedback (even where this is inactive positive feedback) to the user's feedback stream. This is particularly advantageous if the content stream is being watched by or distributed to other ‘friends’ or users as content items that were deemed by the user to be uninteresting within the predetermined time period will not be included into the content stream.

For example, the user can provide negative feedback by actively commanding the content player to skip a content item when it starts playing should the user not want to watch the content item. The negative feedback may be weighted depending on how long the user watches the content item before the user skips to the next content item. In this example, if the user skips the content item very quickly from when it starts playing, then this negative feedback may be weighted more than if the user skips the content item mid-way through or near the end of the total time set aside for playback of the content item. When a user watches the playback of a content item for the total time set aside for playback of that content item and/or a predetermined or specified portion thereof, this is a passive interaction, which is interpreted as a positive feedback otherwise the user would have skipped the content item.

In this way, the ‘act of curation’ or allowing a user to effectively ‘create’ or ‘modify’ their historical data stream, can in itself provide a social activity; for example, by enabling users to produce an ‘interesting’ data stream to share with friends. Users will in this way endeavour to create the best and/or most entertaining content stream.

The content player 212a for the user sends the user feedback data to the master node 202 for updating the session database and subsequently the user profile bank of one or more user profiles associated with the user. The user feedback data for each content item may include a user identity for the user, content location or address and/or content identity and playback information for the content item. The playback information may include the length of time the content item was played, and/or may include an indication of whether the content item was fully played or skipped by the user. As described above, the updated session database and/or updated user profile is sent to the local nodes 204a and 204b via the above communication mechanisms. The updated session database and user profiles are used by the master node 202 and local nodes 204a and 204b to generate further user content location data (e.g. playlists) associated with further content items that the user may prefer to watch. As the session database and user profile bank for each user develops based on the user feedback data from each user, the content items selected from the content directory according to a user profile of the user becomes more personalised and reflects the “tastes” of the user, which ensures the user continues to watch the selected content items provided by the local nodes 204a and 204b. The user does not need to search for content items as the user profile(s) for the user reflects the “tastes” if the user.

In addition, the content player 212a may be further configured to, in response to positive user interaction or positive feedback on the content player 212a, indicate to the master node 202 and/or local node 204a that further content items relevant to the content items associated with the positive feedback be injected into the user content location data on the content player 212a. The content player 212a may then be further configured to receive from the local node 204a further user content location data for the user in response to the indication that includes the content locations of the further content items that may be relevant. On receiving the further user content location data, the content player 212a is configured to place the content locations of the further content items into the user content location data of the content player 212a at such a point that the further content items will be played back to the user in the near future. For example, these further content items may be played back to the user when the content player 212a is ready to playback the further content items without disrupting the user experience of substantially seamless playback of current content items in the user content location data of the content player 212a.

As already described, the user feedback data may include a user identity for the user, content address and/or content identity and playback information for the content of each entry in the user content location data for each user. The playback information may include the length of time the content for each entry was played, and/or may include an indication of whether the content for an entry was fully played or skipped by the user, and/or a timestamp and/or date and time the content item was played back to the user. The user feedback data may be sent by the content player 212a of the user to the master node 202 for analysis to determine the type of content the user prefers to allow for updating one or more of the user profiles, and/or for storage of the user feedback data as historical content and user data (or historical user data) for the user. The master node 202 may store, for each user, the user feedback data for that user as historical content and user data (or historical user data), which may be representative of the viewing sessions for that user. This may be stored in the session database for updating the session database data associated with the user.

The session database data for the user includes data representative of the user feedback data such as content item identity, content item location, and whether the user liked, skipped or disliked the content item. As described, the session database data for the user may be used for creating user profiles or updating user profiles for the user etc. In addition, the master node 202 and/or the local nodes 204 or 204b may use the session database data for the user (or local session database data for the user) for displaying to the user via the content player 212a or a website or a remote control device or in any other suitable manner, a list or selection of content items the user has previously watched. The session database data for the user may be filtered to produce a list of content items based on the content items the user has liked or did not skip during playback of the content item. The content item list may also be generated based on filtering the session database data for the user in any other way, e.g. via genre of the content item, keywords, content item identity, date or time one or more content items were played back to the user. The list of content items may be displayed to the user for use in the user selecting a content item from the list that they wish to watch again.

When the user selects a content item from the list, the local node 204a may be configured to send user content location data (e.g. a playlist) including the content location or address associated with the selected content item. It will be appreciated that the content list can be generated on the fly and/or alternatively, the can be pre-generated. The user content location data includes data representative of the location or address of the selected content item from the corresponding content source. On receiving the user content location data for the selected content item, the content player 212a of the user retrieves the content item for playback of the selected content item to the user. This allows the user to re-watch content items again that have been played back seamlessly. In a similar manner, the master node 202 and/or local node 204a may be configured to allow a user to request content items based on title, keywords, genre, content item identities, type of content item, and/or topics, subject-matter within the content items and/or any other characteristic or feature associated with the content item that may be used to find suitable content items from the session database or content directory. This may allow a user to find and watch a content item that they may have heard about from their friends, or a content item that is trending or in a content item global or local chart hit list.

Alternatively or additionally, instead of allowing a user to select a content item from the content item list, the content item list may be used by a local node 204a to generate user content location data (e.g. a playlist) for the user, which may be sent to the content player 212a of the user for seamless playback of the content items on the content item list. In addition to using session database data (e.g. historical content and user data) to generate a content item list for a user to select a content item to watch, the local node 204a may also generate the content item list based on content items that are trending or are on a content item chart hit list. This content item list may also be displayed to the user for selection of a content item, or additionally and/or alternatively, the trending or chart hit list may be used to generate user content location data for the user allowing the content player 212a of the user to seamlessly playback content of the content item list.

The content player 212a or 213a may be configured to perform a random seamless playback mode in which the content items associated with the user content location data for the user (e.g. the playlist) are spooled up and played from a random playback starting point within each content item. The random starting point for a content item may be selected by the content player 212a or 212b to be any point within a time interval between a predetermined start point and a predetermined end point within the content item. For example, for content items greater than 40 seconds long, the start point may be set to be 10 seconds from the start of the content item, and the end point may be set to be 30 seconds from the end of the content item. Thus, the random starting point is selected to be a random time within the interval between 10 seconds from the start of the content item to before 30 seconds from the end of the content item. It will also be appreciated that the random start point may be the beginning of the clip and/or the random end point may be the end of the clip itself (i.e. may be set as 0 seconds before the end of the clip). The content item may be played for a set period of time, a random period of time, or until the content item is fully played after which the next content item that is buffered is spooled up and played with another random starting point within the next content item. The start and/or end point can be selected based on feedback received from other users that have seen the particular content item. For example, if users starting the clip at 2:00 generally skip and users starting at 6:00 generally watch, then the random function may be weighted towards the latter.

In addition, when viewing the playback of a content item the user may wish to view the whole content item from the beginning of the content item, therefore the content player 212a may be configured to receive a user command to playback the entire content item, after which the content player 212a resumes seamless playback (e.g. random seamless playback) of the content items associated with the user content location data of the user.

The user profile(s) for a user may be updated by the master node 202 based on user feedback data generated by the user's negative or positive interactions with the content player 212a of the user. In order to provide a user with user profiles that are “attuned” or personalised to that user, the master node 202 should receive reliable user feedback data from the content player 212a. Should the user leave the room and/or forget that the content player 212a of the user is still operating or playing back content, the content player 212a may still send user feedback data to the master node 202. However, as the user is not in the room or not watching the content player 212a, each content item will fully playback and may provide a series of “false” positive user feedback data because the user is not interacting with the content player 212a of the user. This may skew the user feedback data received by the master node 202 in relation to the user and may have a knock on effect when the user profile(s) of the user is updated based on this user feedback data. This may skew the user profile(s) of the user. Instead, the master node 202 and/or content player 212a may be configured to detect when a user is watching the content player 212a and when they have walked away or are not watching the content player 212a. This detection may be based on, by way of example only, user feedback data received by the master node 202 or based on the expiry of a timer.

For example, the master node 202 may analyse the user feedback data for a user for user usage pattern(s) based on the frequency and number of skips, likes, tweets and other user inputs to determine whether the user is watching the content player 212a or not. Positive feedback may be provided by a user watching the entirety of a content item and/or watching the content item for a certain duration or time period (for example 30 seconds) and/or review of other user interactivity in respect of an item of content. It will be appreciated that although the feedback can update the user profile back directly, it is possible that feedback will only translate to the probability or likelihood of a user being interested in a particular content item or group of items. Different weights may also be specified for the one or more types of user feedback, wherein the weights may be pre specified. These weights may then be used to update the profile by, for example, modifying the probability of particular types or themes of content items.

Based on the user usage patterns, which may be stored in the session database data (or historical content and user data) for the user, the master node 202 can determine whether the user is watching the content player 212a or not. On detecting that the user is not watching the content player 212a based on the user input behaviour not corresponding to the usual user usage pattern(s), the master node 202 may suspend storing user feedback data received from the content player 212a of the user to avoid skewing the session database data for the user and also the user profile(s) that are updated based on the user feedback data. The master node 202 may further analyse any recently stored user feedback data of the user to determine when the user most likely left the room or stopped watching and the user feedback data that the master node 202 has stored after the user left the room or stopped watching. The user feedback data that is determined to have been stored after the user left the room or stopped watching may be removed from the session database data for the user by the master node 202.

Alternatively or additionally, the content player 212a of the user may be configured to analyse the user feedback data for user usage pattern(s) and the content player 212a of the user may detect whether the user is watching the content player 212a or not based on whether the input user behaviour corresponds to the user usage pattern(s). When the content player 212a detects the user is not watching the content player 212a, the content player 212a may suspend sending feedback data to the master node 202, and/or the content player 212a may go into a standby or pause mode, and/or prompt the user to determine whether they wish to continue watching the content player 212a. The prompt may have a timer, which once count down suspends the content player 212a sending user feedback data or puts the content player 212a into a standby mode. In another example, the content player 212a may be configured to start a reminder timer based on user inactivity, which once expired reminds or prompts the user to provide some sort of user feedback e.g. negative user feedback or at least remove the prompt. If no negative user feedback is detected or the prompt is not removed, the content player 212a may suspend sending user feedback data to the master node 202 and/or enter a standby or pause mode until the user returns to instruct the content player 212a to proceed with playback of the content items. Over this time, the content player 212a may receive further user content location data (e.g. playlists) from the local node 204a, which is may store for future playback of content items to the user.

Alternatively or additionally, if the master node 202 detects or suspects that the user has left the room or is not watching, the master node 202 may instruct the associated local node 204a serving the user to attempt to prompt a reaction from the user by inserting one or more content items into the user content location data that the user may not like. If it is determined that the user provides a negative user input, e.g. skips the content item, then the master node 202 may assume the user is still watching the playback of the content items. If the user does not skip at least one of the one or more content items, then the master node 202 can determine that the user is not watching the content items and suspend storing user feedback data as previously described.

FIGS. 2c and 2d are schematic diagrams illustrating an example master node 202 and an example local node 204a, respectively, of the distributed content delivery system 200 as described with reference to FIG. 2a or 2b. For simplicity, FIGS. 2c and 2d only include some of the features, by way of example only, of FIG. 2a and/or 2b. As previously described with reference to FIGS. 2a and 2b, the master node 202 maintains a session database for the plurality of users in the distribution system 200 and a content directory of the plurality of content items from the one or more content sources 208a-208l. The session database and content directory is shared among the plurality of local nodes 204a and 204b that each serve a group of the plurality of users.

Referring to FIG. 2c, the master node 202 includes the session database and the content directory, which may be stored in file storage or database storage units 230. The master node 202 further includes a vault master unit 232 which controls the storage and transmission of the session database and content directory via communication network 206 (e.g. via Internet 206a) to the plurality of local nodes 204a or 204b, a session database master unit (e.g. D.U.D.E. (master)) 234 maintains the session database for each current user, an artificial intelligence (A1) engine unit 236 for use in processing the session database, a user profile generator unit 238 for use in generating user profiles based on the AI engine 236 and session database master unit 234, a language analyser unit 240 and audio analyser unit 242 for determining the language of a content item and audio content data of a content item, the language analyser unit 240 and audio analyser unit 241 are coupled to a content builder (or clip builder) unit 244 for generating content records for updating or inclusion into the content directory. The user profile generator unit 238 and clip builder unit 244 are coupled to the vault master unit 232, which stored the generated user profiles and content data accordingly in the session database and content directory. The master node 202 may also include a pusher unit 246 for pushing updates such as user feedback data from third party service 206a and/or 206b to the session database master unit 234, the pusher unit 246 may also push session database and/or content directory updates to third party service providers 206a and/or 206b and subsequently onto local nodes 204a or 204b. The pusher local store unit 248 may be used to store further statistics, trends, charts etc. that may be pushed to the relevant units e.g. session database master unit 234 for updating the session database, or AI engine 236 for use in generating output based on the statistics from pusher local store unit 248, or to local nodes such as local node 204a via third party provider 204b. In operation, the master node 202 maintains and stores the content directory associated with a plurality of the content items from the one or more content sources 208a-208l as described with reference to FIGS. 2a and 2b. The content directory may be managed by vault master unit 232 and file and database storage unit 230. the vault master unit 232 may be used to receive or retrieve via communications network 206 content item data associated with one or more content items of the one or more content sources 208a-208l. The content item data may include a description of each content item (e.g. metadata) and content location data for use in retrieving each content item, examples of which have been described with reference FIGS. 2a and 2b. The content item data include updates associated with content items, which are used to update the content directory. The content item data includes content item data associated with new content items, which are used to populate the content directory. The vault master unit 232 stores the content item data in the content directory. In addition, should appropriate content item data for content items not be available or there is not enough content item data that adequately describes a content item, the master node 202 may retrieve content items from content sources 208a-208l and use language analyser 240, audio analyser unit 242, and clip builder unit 244 to generate sufficient content item data related to the content items for inclusion into the content directory, examples of which have been described with reference FIGS. 2a and 2b.

The pusher unit 246, session database master unit 234 and vault master unit 232 maintain the session database that stores historical data of each of the plurality of users in the system 200 and also the user profile bank associated with the plurality of users, in addition to user feedback data associated with negative and positive feedback based on the user interacting with the content player system 212 or 213 during seamless playback of content items.

For each user, user feedback data is pushed from pusher unit 246 to the session database master unit 234, which updates the session database associated with the user feedback data. The user profile generator 238 is used to generate and/or update one or more user profiles for each user, which are stored in the user profile bank for that user. For example, the session database data for each user can be fed to an AI engine unit 236, which may include sets of instructions or modifiable plugins for processing the data stored in the session database for a user. The set of instructions or modifiable plugins may be selected to perform a specific processing on the session database data of the user to create or update a user profile with specific user preferences, statistics and/or characteristics (e.g. stats or characteristics of a group of content items), and/or traits. The user profile generator unit 238 uses the output from the AI engine unit 236 to generate instructions and/or rules for use in selecting content items associated with the specific user preferences, characteristics, and/or traits output from the AI engine unit 236. The user profile generator unit 238 creates and/or updates a user profile of said user stored in the user profile bank. In addition, the user profile generator unit 238 may also receive, from the session database master unit 234, the session database data for the user for use in updating and/or generating one or more user profiles for the user. The session database master unit 234 may also process the session database data for each user in a similar fashion as the AI engine to generate output suitable for user profile generator unit 238 to build or update one or more user profiles in the user profile bank for a user.

As previously described, the user profile bank for each user in the system 200 includes one or more user profiles which include instructions or rules describing profile data representative of the types of content items that the master node 202 has determined the user may have a preference for. The vault master unit 232 stores the generated and/or updated user profiles of the user profile bank for the user in the session database within the file or database storage unit 230.

The vault master unit 232 of the master node 202 communicates the session database (e.g. historical data and user profile directory) and content directory records or updates thereof for each user currently using the system to each of the local nodes 204a or 204b. This may be achieved, as previously described with reference to FIGS. 2a and 2b, via a direct master data feed communication over communication network 206 (e.g. via Internet 206a) and/or via a third party service 206b (e.g. CDN) as illustrated in FIG. 2c. Each local node 204a receives at least updates of the session database associated with the group of users for that local node 204a and the content directory, which over time, substantially mirrors the session database and content directory of the master node 202 for that group of users. The local node 204a may also receive updates of the session database for all users, or retrieve further updates of the session database for the group of user or for all users from the third party service 206b.

The vault master unit 232 of the master node 202 may send an update for all users of the session database and/or the content directory via a third party network service 206a or 206b. For example, a periodic global update may be sent to update a copy of the session database and/or the content directory for all users stored by the third party network service 206b (e.g. Content Delivery Network (CDN) (e.g. Amazon, EdgeCast, Akamai)) as illustrated in FIGS. 2a and 2c. The global updates of the session database and/or the content directory stored in the third party network service 206b may be periodically sent to each of the local nodes 204a and 204b. This may be sent via the vault master unit 232 or via the pusher unit 246 to the third party network service 206b and onwards to the local node 204a as illustrated in FIG. 2c. In any event, the master node 202 communicates the session database and the content directory to the local node 204a or 204b, which stores this as a local session database and a local content directory, which substantially mirrors the session database and the content directory of the master node 202

The master node 202 may include one or more processors, one or more transmitter(s) and receiver(s), and one or more storage unit(s) (e.g. storage units 230 and 248) the one or more processor(s) coupled to the transmitter(s), receiver(s), and storage unit(s), where at least one of the storage unit(s) include computer program code or instructions, which when the computer program code or instructions are executed on at least one of the processor(s), configures the processor(s) to perform the functions of the session database master unit 234, the AI engine unit 236, the user profile generator unit 238, the master vault unit 232, the clip builder unit 244, the language analyser unit 240 and audio analyser unit 242 for maintaining and updating the session database and content directory, distributing the session database and content directory to one or more local nodes, such as local node 204a.

Referring to FIG. 2d, the local node 204a includes a database storage unit 250 for storing the local node session database and content directory, a vault slave unit 252 coupled to the database storage unit 250, a session database slave unit (e.g. D.U.D.E. (slave)) 254 coupled to the database storage unit 250, a user content location data generation unit 256 (e.g. a Programmable Intelligent Manufacturer of Playlists (P.I.M.P)) coupled to the vault slave unit 254 and session database slave unit 254, a authentication unit 258 coupled with the vault slave unit 254, and a gateway service unit 262 and shared communication unit 260 (e.g. Shared Object Comms server).

The gateway service unit 262 may be provided as an alternative to the QR code wherein the content player may register with it, and remote controls may query it to see which content players are on the same IP address. If a content player and a remote control are both on the same IP address, the system in some examples can assume that the devices are in the same building (e.g. household) and thus can assume that something that the content player is to be controlled by the remote control. It will be appreciated that any other suitable unique token may be considered for this purpose.

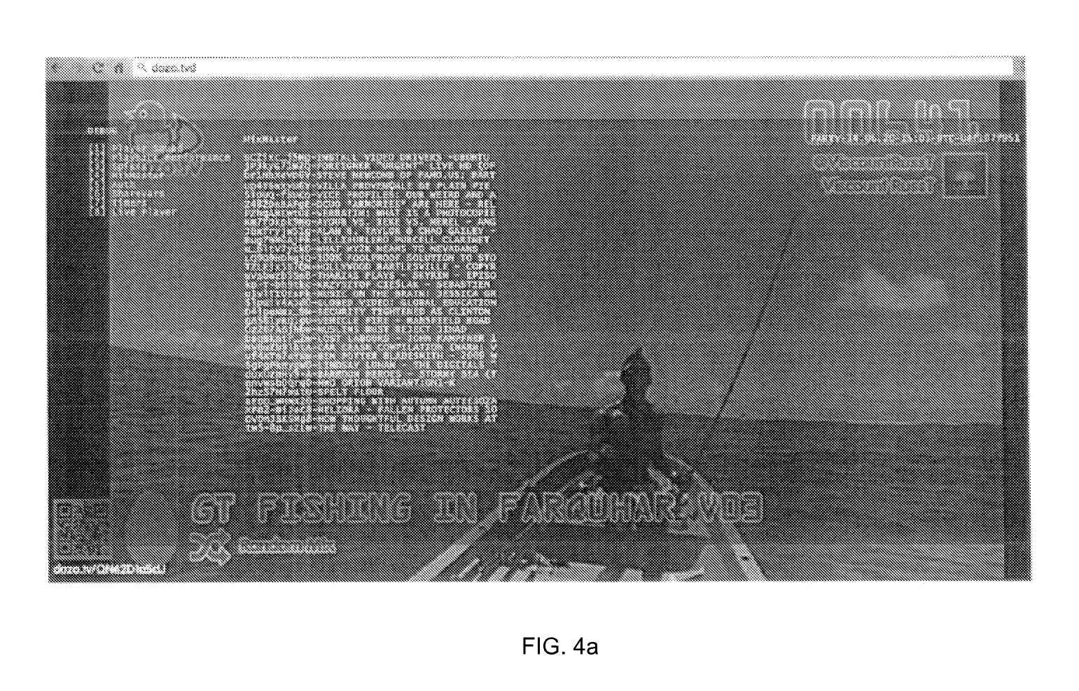

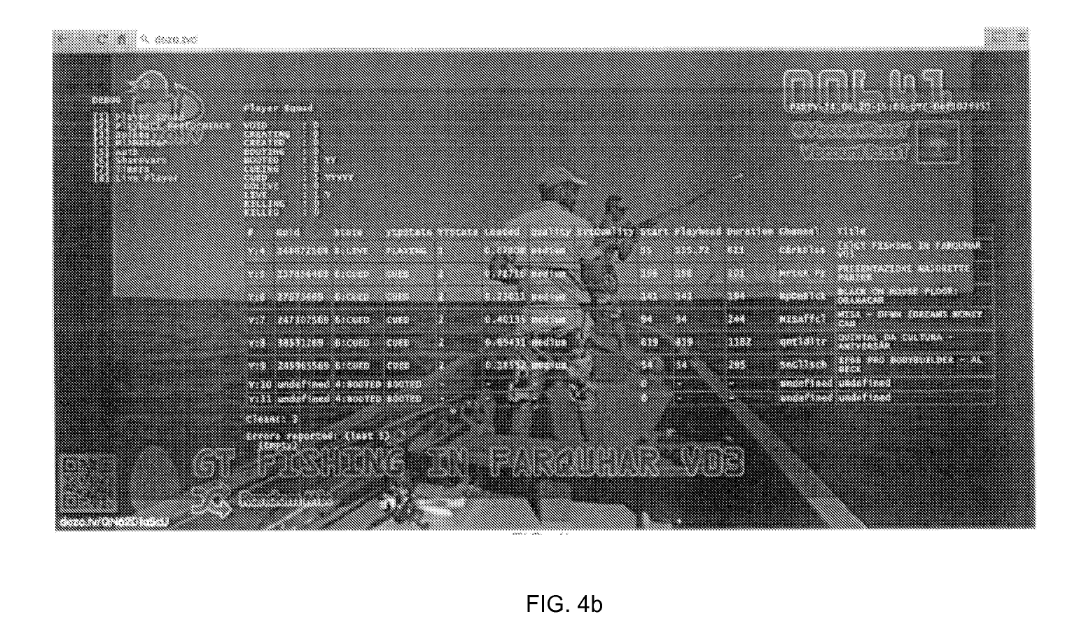

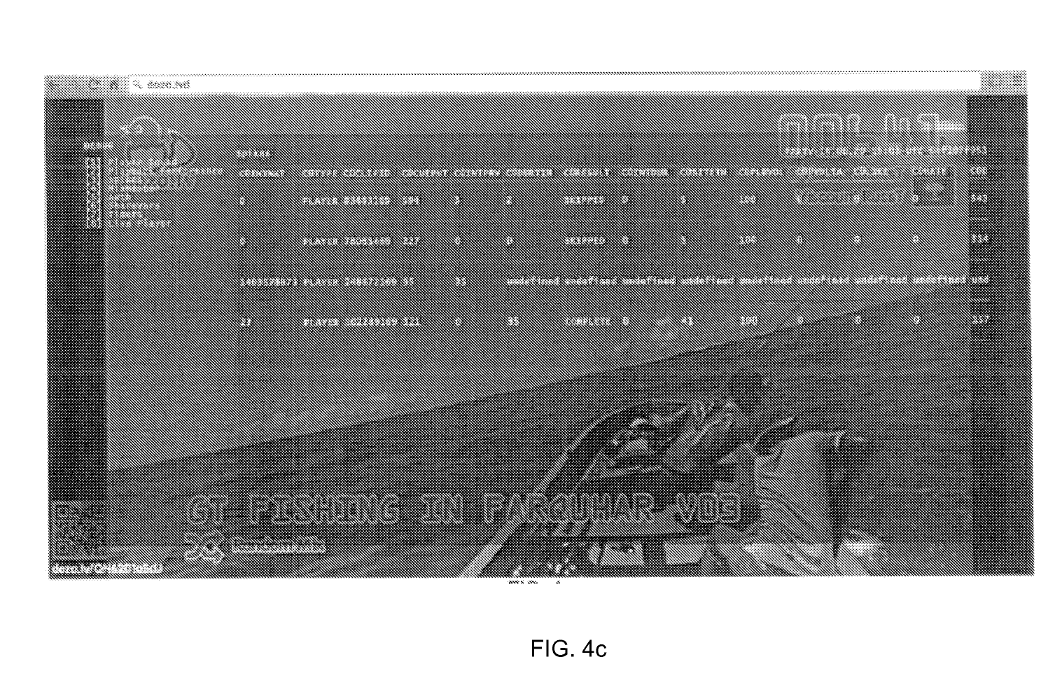

In operation, the vault slave unit 252 controls the reception and storage of the session database or updates thereof and/or content directory and updates thereof received via communication network 206 (e.g. via Internet 206a) from the master node 202. The session database slave unit (e.g. D.U.D.E. (slave)) 254 maintains and/or processes the local node session database in a similar fashion as the session database master unit 234 of the master node 202. The session database slave unit 254 can also receive updates of the session database from the third party network service 206b (e.g. CDN), examples of which have been described with reference to FIGS. 2a-2c. The user content location data generation unit 256 (e.g. a Programmable Intelligent Manufacturer of Playlists (P.I.M.P) unit) generates user content location data (e.g. playlists) for each user in the group of users served by the local node 204a. The user content location data for each user is generated based on the content directory and local node session database data for that user, which includes the user profile bank of that user (e.g. user recipes or sets of instructions or rules for generating user appropriate content) for each user. The user content location data for each user is generated by processing the user profile for a user from the local session database with the content item data of the local content directory, which outputs locations and/or identities of content items that match or are in line with the user profile for the user. The user content location data generation unit 256 also handles transmission of the user content location data for each user to the content player system 212 of each user. FIG. 4a illustrates an example text output representation of a portion of user content location data generated for a user and sent to the content player 212a of the user. The text output represents the user content location data as a table of content items listed by the content locations (which are in a machine readable format) and a content identity (e.g. a title of the content item).

Referring back to FIGS. 2a to 2d the authentication/accounts unit 258 authenticates legitimate users of system 200 and arranges for the user content location data generation unit 256 (e.g. Programmable Intelligent Manufacturer of Playlists (P.I.M.P.) unit) to begin generation and transmission of user content location data for each user of system 200 to the content player system 212 (e.g. content player 212a) for that user. The shared communications unit 260 and gateway service unit 262 provide the functionality for communicating user data and/or remotely controlling the content player system 212 via a remote device (e.g. a smart device, phone, mobile device or other device capable of communicating with local node 204a) or other remote control system.

Additionally or alternatively, the remote control may be a separate device hardwired to carry out the remote control functionality. It will also be appreciated that the remote control functionality can be provided and/or accessible to a user via a webpage and or other suitable delivery means.

The gateway service unit 262 may provide communications services between the remote unit 212b or content player 212a for use in registering content players 212a-213a and remote units 212b-213b. Shared object communications unit 260 may provide communications services between the local node 204a and the content player 212a and between the local node 204a and the remote control device 212b.

The content player system 212 includes a content player 212a and a remote unit 212b, which may be optional. Each content player 212a may include computer instructions stored in a storage unit or memory of the system 212, which when executed on at least one processor, configures the processor to perform, by way of example, an example process for streaming content from one or more content sources 208a-208l over the communications network 206 to a user of the content player system 212 for playback of content on a display. The content player 212a may include a plurality of content item players (e.g. embedded players) associated with content items from different content sources 208a-208l, which enables the content player 212a to support playback of the plurality of possible content items from each of the content sources 208a-208l. The content player system 212 is configured to receive user content location data for the user from the local node 204a.

The user content location data generation unit 256 of the local node 204a generates and sends the user content location data to the content player 212a. The user content location generation unit 256 at the local node 204a generates user content location data based on the local content directory and session database data of the user, e.g. the user profile bank for the user. The local content directory includes locations of said content items and information associated with said content items, which enables content items to be selected based on a user profile of the user. For example, the user content location generation unit 256 may select a plurality of content items of the one or more content sources 208a to 208l from the local content directory according to a user profile from the user profile bank. The user profile may also be selected from a user profile bank of the user either by the master node 202 or the local node 204a detecting which user profile the user will likely prefer (e.g. detected user mood, based on user feedback data, time of day, analysis of user mood, previous user preferences). The user profile may also be selected based on user data or user preferences communicated by the user to the local node 204a or master node 202 via the content player 212a or remote device 212b. Once generated, the user content location data for the user, which includes locations of the selected content items (e.g. a playlist of content items), is transmitted by the user content location generation unit 256 over communications network 206 to the content player 212a.

In one example, the content player system 212 is operable to insert one or more specified content items into a user's content stream or playlist. Such insertion may be provided, for example, in response to positive user interaction on the client. In one example, if a user watches a content item about football, the content player 212a may transmit a specific request over the communications network 205 for further football clips (i.e. content items classified as related to football or sports generally). Any retrieved content items identified and/or categorized to fit the desired specification may then be inserted into the playlist of content items enabling them to be played by the user in the very near future. If positive feedback is provided by the user in respect of the retrieved content items, the content player 212a may request further similar themed and/or classified content items to specifically tailor the user's content stream; thereby providing a feedback loop. This allows the content player system 212 to account for a and consider the specific mood of the user.

On receiving the user content location data, the content player 212a determines the content locations of each content item and retrieves the corresponding content items from the one or more content sources 208a to 208l via communications network 206. For example, the content player 212a may instantiate, for each type of content item in the user content location data, a content item player that supports that type of content item. Each of the content item players may stream one of the content items from the content location of the corresponding content source 208a to 208l. The content player 212a manages the plurality of content item players to provide for seamless playback of the selected content items. Multiple instantiations of a content item player that supports the same type of content item may be provided to allow seamless playback of multiple content items of the same type occurring one after the other.

For example, a content player 212a may perform a substantial seamless playback by using only those content item players that are ready to perform playback of a content item. In other words, the content player 121a plays back a content item as soon as there are any content items ready to play by the corresponding content item player. Initially, once one of the content items from the user content location data is ready playback begins, where it is assumed that at least one additional content item will be retrieved by a content item player and ready for playback by the time the user decides to skip or has watched the current content item fully etc. In the event that the at least one additional content item is not ready for playback, then the content player 212a may display a holding screen (e.g. a TV static effect, or any other suitable screen) until any additional content item is ready for playback to the user. In most cases unless the user is an aggressive skipper, meaning that they skip every content item as it starts to play, then the user will receive a substantially seamless playback of the content items.

FIG. 2e is a flow diagram illustrating an example process 270 for a content player in managing a plurality of content item players. Each of the plurality of content item players may playback content items of a different format or content items from a corresponding content source 208a to 208l. A content player queue of a plurality of content item players is formed in which each content item player in the queue has retrieved or is in the process of retrieving a content item using the content location data in the user content location data for the content item from the corresponding content source 208a-208l. In step 271, the content player gets a content item location from the user content location data. In step 272, a content item player is instantiated to retrieve and subsequently playback the content item associated with the content item location, the content item player is inserted into a content player queue. In step 273, the content player gets another content item location from the user content location data for instantiating a further content item player and retrieving said content item and placing this further content item player into the content player queue. This continues for the content locations in the user content location data, which is iteratively updated by the local node(s). The number of content item players that may be instantiated may be based on the available memory of the content player and the processing power or computational resources available to the content player.

FIG. 2f is a flow diagram illustrating another example process 274 for the content player of FIG. 2e for playback of content items using the queued content item players. In step 275, the content player retrieves a content item player from the content player queue in which the content item player is ready to begin playback of the corresponding content item. For example, the content items does not need to be fully retrieved in order for the content item player to playback the content item, instead the content item player may be considered to be ready to begin playback when it has sufficiently buffered enough of the content item to be able to begin playback of the content item. In step 276, the content player displays a playback of the content item. That is, the retrieved content item player is displayed by the content player and plays back the retrieved content item to the user. In steps 277-279, during playback of the content item, the content player checks whether there is any interaction from the user. For example, in step 277, the content player checks whether the user has provided a negative feedback information such as a skip event (e.g. the user may select to skip playback of the content item and proceed to the next content item that is ready for playback). If the user does provide negative feedback information such as the skip event, then the process proceeds to step 278. In step 278 the content player checks whether playback of the content item has finished. If playback has not finished, then the process proceeds to step 279 to continue playback of the content item, otherwise the process proceeds to step 280. It is noted that steps 277-279 may be iteratively applied either sequentially or concurrently during playback of the content item. In step 280, any user interaction or user feedback such as positive or negative feedback is determined and sent to the master node for analysis and updating the user profile bank(s) etc. The process proceeds to step 271, in which the next content item player that has a content item ready for playback is retrieved from the content player queue and steps 272-280 proceeds in relation to the next content item. In addition, the content player 212a may be further include the steps of, in response to positive user interaction or positive feedback on the content player 212a, indicating to the master node 202 and/or local node(s) 204a-204n that further content items relevant to the content items associated with the positive feedback be injected into the user content location data on the content player 212a. The content player 212a receives from the local node 204a further user content location data for the user in response to the indication that includes the content locations of the further content items that may be relevant. The further user content location data may indicate that this set of user content location data be included as soon as possible or in the near future into the user content location data on the content player 212a so that it may be played back as soon as possible or practicable. On receiving the further user content location data, the content player 212a places the content locations of the further content items into the user content location data of the content player 212a at such a point that the further content items will be played back to the user in the near future. For example, these further content items may be played back to the user when the content player 212a is ready to playback the further content items without disrupting the user experience of substantially seamless playback of current content items in the user content location data of the content player 212a. This provides a local feedback loop or a fast feedback loop for fine tuning the user content location data that is selected and/or generated by the local node 204a to what the user may be wishing to watch at that point in time.

FIG. 2g is a flow diagram illustrating an example process 281 for a content player in managing a plurality of content item players. Each of the plurality of content item players may playback content items of a different format or content items from a corresponding content source 208a to 208l. A content player queue of a plurality of content item players is formed in which each content item player in the queue has retrieved or is in the process of retrieving a content item using the content location data in the user content location data for the content item from the corresponding content source 208a-208l. In step 282, the content player gets a content item location from the user content location data. In step 283, it is determined whether a content item player may be instantiated to retrieve and playback the content item associated with the content item location. The number of content item players that may be instantiated may be based on the available memory of the content player and the processing power or computational resources available to the content player. If a content item player is available for instantiation (e.g. Y), then the content item player is instantiated and the process proceeds to step 285, where the content item player begins to retrieve the content item using the content item location. If a content item player is not available for instantiation, e.g. low computer resources available, then the process proceeds to step 284, in which the next content item is retrieved, in which the process proceeds to step 282. In step 285, if the content item player has not retrieved the content item, then the content item player continues to retrieve the content item. Once each of the content item players has retrieved its corresponding content item, the process 281 proceeds to step 286, where the content item player instantiation is inserted into a content player queue for subsequent playback of the content item after one or more previous content item player instantiations have performed playback of the content item to the user. The process 281 proceeds to step 284 to retrieve the next content item.

FIG. 2h is a flow diagram illustrating another example process 290 for the content player of FIG. 2g for playback of content items using the queued content item players. In step 292, the content player determines whether enough content item players have been instantiated and have retrieved their respective content items to ensure seamless playback of content to the user. If not, the process returns to step 292 to wait until the content item player queue has been sufficiently populated. If there are enough content item player instantiations in the content player queue, then in step 294 the content player retrieves a content item player from the content player queue. In step 296, the content player uses the retrieved content item player to playback the content item. Once the content item has finished playing, the retrieved content item player instantiation is closed or removed from the queue. In step 298, the content player may send to the master node 202 user feedback data based on user interactions in relation to the content item(s) that have been played back to the user. The content player then proceeds to step 292 for checking the status of the player queue and retrieving another content item player from the player queue for seamless playback of content item(s) to the user.

Although the distributed content delivery system 200 has been described with reference FIGS. 2a-2h as including one or more master node(s) 202, a plurality of local nodes 204a-204n, and a group of users 210a-210e with content player systems 212a-212m in communication with each other, it is to be appreciated by the skilled person that one or more of the functions performed by one or more master node(s) 202, one or more local nodes 204a-204n and/or content player systems 212a-212m etc., may be centralised or distributed and implemented or executed in various entities, computing systems, or clients that result in the same or similar functionality. For example, the functions of master node 202 and/or one or more local nodes 204a-205n may be combined to form a content delivery system that serves one or more content players of one or more users. In another example, the distributed content delivery system 200 may be implemented as one or more content delivery client(s) as described, for example, with reference to FIG. 1f.

Referring to FIG. 4b, FIG. 4b illustrates a textual output of an example status of content player 212a of the user when managing the content item players during playback of the content items in the user content location data. Each row in this example represents the status of each content item in various stages of playback. In this example, the content player 212a has instantiated six content players, with the first content item player (e.g. GUID 248672169) playing back content item entitled “(S)GT FISHING IN FARQUHAR V03”. The following five content items have a CUED status meaning the content item player instantiations associated with the content items have downloaded the content item from the corresponding content source 208a-208l and are ready to playback the content item once playback of the previous content item has terminated. The final two content items have a combined undefined and BOOTED status meaning the content item player instantiations have not yet been allocated, possibly due to limited system memory of the device the content player 212a is operating on. Alternatively, if these two were defined with the state BOOTED and the content item player is instantiated, then this means the content item player is currently downloading the content item from the corresponding content source. It will be appreciated that although in this example only three statuses are disclosed, namely, ‘playing’, ‘cued’ and ‘booted’, other status may be specified; for example, ‘downloading’, ‘processing’ etc.

Referring back to FIGS. 2a to 2d, the user can interact with the content player 212a either through a keyboard or direct input to the content player 212a or via a remote device 212b, user feedback data may be generated by the content player 212a based on these interactions. The user feedback data may be based on a user's positive feedback through a passive interaction or a user's negative feedback though an active interaction occurring during playback of each content item played back by the content player 212a. For example, when a user watches the playback of a content item for the total time set aside for playback of that content item, this is a passive interaction, then this passive interaction is interpreted as a positive feedback. However, a user can provide negative feedback by actively instructing or commanding the content player 212a to skip the content item when it starts playing. The negative feedback may be weighted depending on how long the user watches the content item. For example, if user skips the content item very quickly from when it starts playing, then this negative feedback may be weighted more than if the user skips the content item mid-way through or near the end of the total time set aside for playback of the content item. The content player for the user sends the user feedback data to the master node 202 for updating the user profile associated with the user.

The user feedback data for each content item may include a user identity for the user, at least a portion of the user content location data such as the content item location or address and/or content identity, and playback information for the content item. The playback information may include the length of time the content item was played, and/or may include an indication of whether the content item was fully played or skipped by the user.

FIG. 4c illustrates an example of user feedback data in the form of a table of text output, each row representing the user feedback data for a particular content item. The user feedback data for each content item is sent in a data packet (called a spike) towards the master node 202, e.g. via a third party network service 202a from which the service 202a periodically transmits or the master node 202 periodically retrieves the user feedback data. In this example, the user feedback data includes origin point for the feedback event (e.g. C0TYPE), content item identity (e.g. C0CLIPID), the starting location for playing the content item (e.g. C0CUEPNT), duration content item was played for (e.g. C0DURTIM), indication of skip or result of user feedback (e.g. C0RESULT), content interaction duration (C0INTDUR), volume of the content player (e.g. C0PLRVOL), an indication of whether the user indicated liked or a hated the content item (e.g. C0LIKE or C0HATE), and further user feedback data associated with the content item. It will be appreciated that the feedback data depicted in this example is illustrative only. As seen in FIG. 4c, the first two content items (e.g. the C0CLIPIDs with entries 83483169 and 78065469) were skipped by the user (e.g. the C0RESULT has an entry SKIPPED) and the last content item (e.g. the C0CLIPID with entry 102289169) was watched fully (e.g. the C0RESULT with entry COMPLETED). The content item in the third row may have been unable to be located by the content player 212a and so most of the fields are set to as ‘undefined’. In such a case, the content player system 212 switches to the next content item (e.g. the COCLIPID with entry 102289169) to provide seamless playback to the user.

Referring to FIGS. 2a to 2d, the user feedback data of a user's interaction with content player 212a is sent to the master node 202 for each content item that is played back to the user. The user feedback data associated with one or more user interactions may be sent in one or more data packets to the master node 202 via communications network 206 or via a third party network service 206b. Once received at the master node 202, the user feedback data is processed by the master node 202 to analyse or classify the types of content items the user would prefer to watch and update the user profile bank of the user accordingly. The master node 202 may be scheduled to periodically retrieve the updates.

The master node 202 analyses the updated user feedback data along with the session database data of the user to determine the type of content the user prefers and for updating and/or generating one or more user profiles for the user profile bank of the user. The user feedback data from the user is used to update a user profile of the user. These updates are then fed back from the master node 202 to the local node 204a via the vault slave unit 252 and/or the local session database slave unit 252 and communications networks 206, 206a and/or 206b.

The updated or generated user profile(s) can be used by the master node 202 and local nodes 204a or 204b to select further content items from the plurality of content sources 208a to 208l and send the further selected content items by way of one or more further user content location data (e.g. playlist(s)) to the content player 212a of the user. As the user profile(s) develop based on the user feedback data, the content items selected from the content directory according to the user profile(s) becomes more personalised and reflect the “tastes” of the user, which ensures the user continues to watch the selected content items provided by the local nodes 204a or 204b.

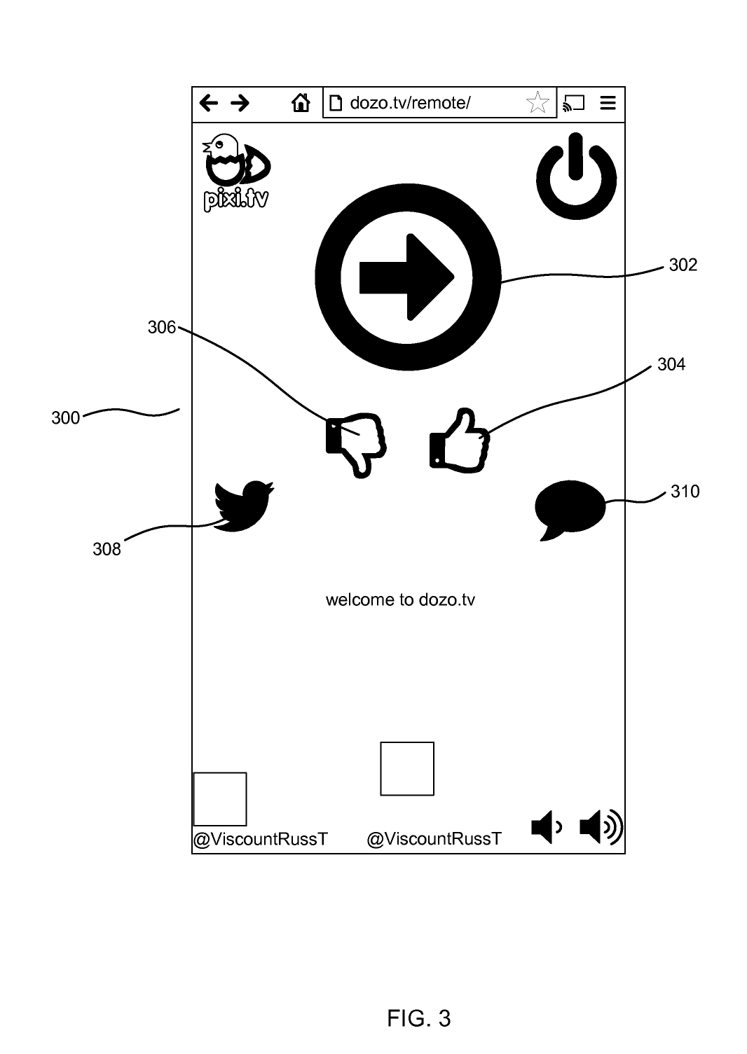

Although a user may control their content player system 212 using a keyboard or other direct input for use in skipping content items, and/or for selecting a content item to play in full, etc., the user may wish to control the content player 212a using a remote control device 212b. Instead of using a dedicated remote control, the user may use a mobile device such as a smart phone or smart device that may connect to communications network 206. The remote control device may be configured to execute an application that performs the function of a remote control for skipping content items, and/or selecting a content item to play in full, or to like or dislike a content item, etc. Such an application may be downloaded from a repository in the communication network 206 or provided by the master node 202 or a local node, e.g. local node 204a, via content player system 212 or other means. FIG. 3 illustrates a schematic diagram of an example remote control application for use on a remote device (e.g. mobile device) to remotely control a player 212a of a user in the system 200. The remote control application includes a skip icon button 302, a like icon button 304 and a dislike icon button 306, and other social media buttons 308, 310 to allow a user to communicate via social media. Referring back to FIG. 2c, in order to use the remote control device 212b as a remote control, the user first acquires data representative of a permission and identity of the content player 212a that they wish to control (e.g. using a QR code). The data representative of the permission and identity is sent from the remote device 212b to the gateway services unit 262 of the local node 204a, which registers the remote device 212b of the user with a content player 212a.

Alternatively or additionally to the QR code mechanism, a content player 212a may register with the gateway service unit 262, and a remote unit 212b may query the gateway service unit 262 to determine which content players 212a are on the same IP address as the remote unit 212b. If a content player 212a and a remote unit 212b are both on the same IP address, then it is likely that the content player 212a and remote unit 212b are in the same building or household such that the user of the remote unit 212b would like to control the content player 212a. This may provide a simple but effective mechanism for connecting a remote unit 212b to a content player 212a. Alternatively or additionally, another mechanism may be used to establish a remote unit 212b that controls a content player 212a by using a user's login details. The gateway service unit 262 may register when a user is logged into a content player 212a and also when, or if, a user logs in on the remote unit 212b. The gateway service unit 262 may then present to the remote unit 212b or the content player 212a with a notification for linking the remote unit 212b and content player 212a together such that the remote unit 212b may be used to control the content player 212a. Once the remote unit 212b is registered to remotely control the content player 212a, the local node 204a can then interpret remote control instructions sent from the remote control device 212b via either the shared communications unit 260, where the local node 204a sends corresponding control instructions via the shared communications unit to the content player system 212, which receives and interprets the control instructions accordingly. In this way, the user then uses the remote control device 212b to send control commands to the content player 212a via the local node 204a for controlling the playback (e.g. skipping) of the content items on the content player 212a. The local node 204a relays the commands via the shared communication unit 260 over the communication network 206 (e.g. via the Internet 206a) back to the content player 212a, which may then operate according to the commands.

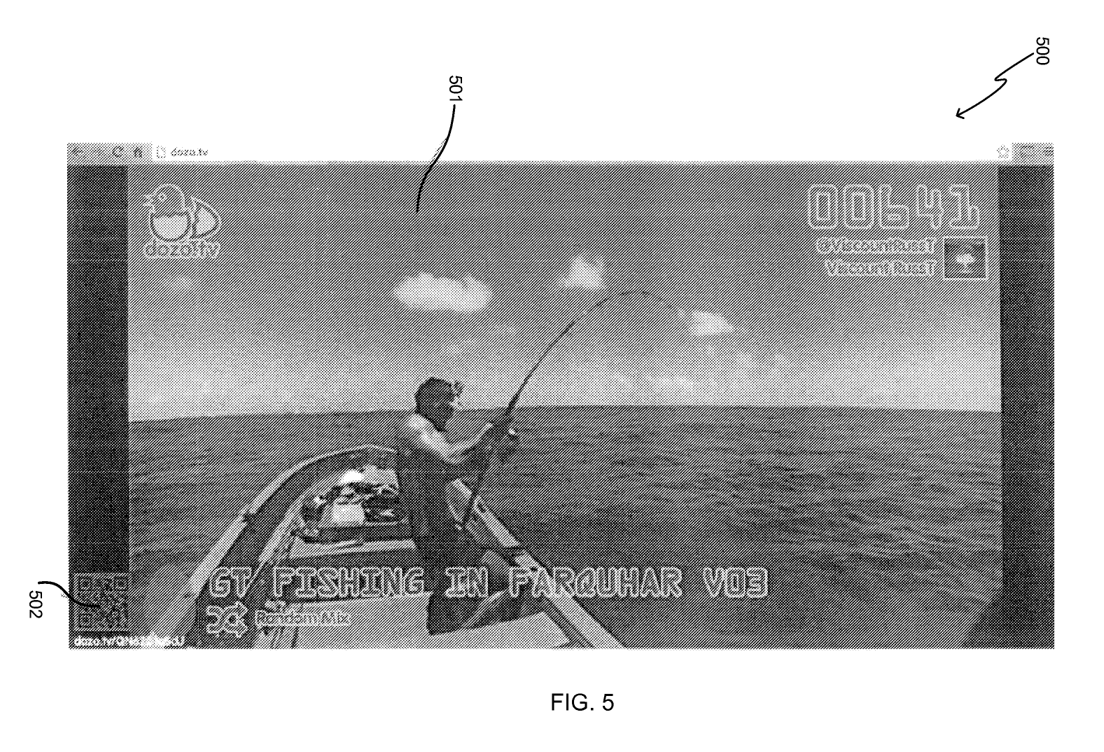

As briefly discussed above, the data representative of the permission and identity of the content player system 212 may be obtained using a QR code or other data presented by the content player 212a to the user during the playback of content items. For example, FIG. 5 illustrates a diagram of a display 501 of, for example, content player 212a during playback of a content item in which a QR code 502 is displayed in the lower left corner of the display 501. The QR code 502 may be captured by a camera of the remote control device 212b decoded, and the data representative of the permission and identity of the content player system 212 automatically sent to the local node 204a for processing and registering the remote device 212b as a remote control for the content player 212a.

A user may select a voyeuristic mode to follow or to connect to and watch another user's seamless playback of content items. The other user may be a celebrity that the user may wish to follow and watch what the celebrity watches. Alternatively, the other user may be a friend, where they both may wish to watch the same content items together. It will be appreciated that voyeuristic mode may enable a user to view the third party's playback substantially simultaneously or concurrently with the third party. Alternatively, a user may be provided with historical data from the third party's content feed such that they may view what the third party watched at a particular and/or earlier point in time. In order to do this, the authentication/accounts unit 258 of the local node 204a first checks that the user is allowed to follow/connect to and watch the other user's seamless playback of content items. This may be based on filters and/or permissions the other user has set-up on their user account associated with their user profile. For example, where a user is streaming under the ‘incognito’ mode where a system does not record feedback and/or details of the content items being streamed (as is discussed in further detail below), a third party may not have permissions to view and/or access details of the user's content stream. If the other user is situated in another local node 204b, the local node 204a may communicate with local node 204b to determine whether the user is allowed to watch what the other user is currently watching. Alternatively, the local node 204a may relay the request to the master node 202, which may determine whether the voyeur or voyeuristic mode may be engaged for the user. If permission is granted, given that each local node 204a and 204b includes a substantially mirror copy of the session database and content directory, the local node 204a should have sufficient information to proceed to allow the user access to the user content location data (e.g. playlist) for the other user. If the user is allowed to connect and watch the other user's seamless playback of content items, the local node 204a transmits the user content location data associated with the other user to the content player system 212 of the user. The content player 212a is then configured to retrieve and seamlessly perform playback of the content items associated with the user content location data of the other user. As mentioned previously, it is not required that the seamless playback is for playback of items the third party is ‘currently’ playing, but could in fact include content which they historically played. Indeed, it is envisaged that third parties can choose to post details of or a link to, or make available in another known way (such as via a direct communication means, e.g. email, sms, etc.) their playlist and/or particular content items contained therein to allow for easy access to the playlist and/or content items contained therein. This functionality would allow a third party to share the thoughts and/or suggestions to other users. When in the voyeuristic mode, the content player 212a of the user may send feedback data to the master node 202 based on the content items being retrieved and played back based on the other user's user content location data. This feedback may be used to update the user profile of user. This mode may be used in conjunction with any other function or mode associated with the user and/or the content player 212a of the user.

It will be appreciated that in the voyeur or voyeuristic mode, it is preferable that a user cannot provide feedback data to control the stream of the original third party's stream. For example, is Shakira is watching a particular clip and a user is also watching this clip through voyeur mode, when Shakira selects to skip the particular clip to the next clip, the clip will be skipped for the user as well. However, if the user wishes to skip to the next clip, it is preferred that this functionality is disenabled. However, other feedback options, such as indicating likes, dislikes, tweets, etc., may still be available. This would therefore enable a user to watch what Shakira is watching without interfering with Shakira's viewing whilst allowing the user to comment on a particular clip or other content item(s) being played back.

There may be times when user may wish not to send feedback from content player system 212 to the master node 202. For example, the user may wish to remain incognito and simply watch a seamless playback of content items without this affecting their user profile (and/or disenabling access to the playlist by third party users). When incognito mode is selected by user, the content player system 212 of the user may stop sending user feedback data based on the content items that are being played back to the user. This mode may therefore allow a user to playback content items which they do not wish for third party viewers to see or have access to and/or it may allow a user to playback content items without it affecting their user profile. This mode may be particularly advantageous where a user allows access to their profile to a third party (for example, a family member or visitor) but does not want the selections or feedback provided by the third party to affect their user profile. It will be appreciated that this mode may be used in conjunction with any other function or mode associated with the user and/or the content player system 212 of the user.

A user may be in a particular mood or may desire to watch only a particular type or genre of content. Indeed, in a ‘guided stream’ mode, a user may be allowed to filter the content items being provided in by the playlist. The additional filter to the content items may be ‘keyword’ restriction or selection, for example, ‘sci-fi’ or ‘no World of Warcraft’, or may be additional parameters selected by a user, for example, music only or over 18. The content player system 212 in this mode may send the user filter selection, feedback data, to the local node 204 and/or to the master node 202. When the playlist is being compiled, the content items being selected for the stream may be filtered using the ‘keywords’ and/or based on parameters determined by the user. It will be appreciated that this mode may be used in conjunction with any other function or mode associated with the user and/or the content player system 212 of the user. It will be appreciated that it may not be preferred that this mode of operation is always enabled and/or user feedback from use in this mode is not always provided to the master node 202, as it may inadvertently steer a user profile so that it is believe that the guided stream parameters and/or filters are preferred settings of the profile. Therefore, in preferred options when a user selects the guided stream mode, a separate user profile may be created and user feedback from this mode is updated and provided to master node 202 in respect of the separate user profile, which is preferably connected with or associated to the user's primary profile.

Additionally or alternatively, the system can place a user in the ‘guided stream’ mode when a user provides positive feedback in respect of a clip; particularly where the positive feedback was determined by specific user interactivity (for example, pressing a ‘like’ button provided on the content player and/or remote control). In this case, the system provides a filter to deliver more of the same or similar type and/or genre of content as the content item which received the positive feedback.

In the ‘guided stream’ mode, the content player system 212 may be operable to watch for a user's waning interest in the selected or specified subject or them and drop the user out of this mode, potentially returning to the random or normal mode of usage. The system 212 may be able to determine that a user has a waning interest, if, for example, the user skips, or provides other negative feedback, to a lot of clips sent from the guidance (i.e. over a predetermined threshold of number and/or within a predetermined amount of time). This functionality may be provided by the content player.

In one example, the user may select a preview or menu mode of operation in which content items associated with the user content data have been selected from one or more content sources associated with previews of content items (e.g. movie trailers) according to the user profile of the user. For example, the content source may be a web server such as, but not limited to, Netflix or IMDB. As the preview content items may be in a preferred embodiment selected according to the user profile, the seamless playback of the preview content items are effectively a menu of possible content items that the user may wish to watch. The content player system 212 and the distribution system in this embodiment may be configured to allow the user to select a preview content item that the user wishes to watch, either during preview of or after via accessing the historical data and/or the user feedback data, and retrieve and spool the entire content item associated with the previewed content item that the user has selected to watch. In this way, a user may be presented with a montage of possible trailers/preview content items in line with their user profile that they will most likely wish to watch. This relieves the user of the requirement of knowing in advance what content item they would like to watch. Even where the preview content items are not selected according to the user profile, this mode still advantageously provides a user with an enhanced decision-making platform by facilitating an efficient manner to sift through a plethora of content items to enable identification of one or more preferred content items.

A random mode may be set as the default mode of operation of the content player system 212. This mode provides means for user to discern between interesting and uninteresting content in a pool of clips through the use of random access. For example, in this mode of operation, the profile of a user will not affect the content items being selected in the playlist. Indeed this mode may be selected by a user, for example where they would like to see whether their profile has become too tailored to their likes (or dislikes), or can be selected by the system to randomize or test the applicability/correctness of a user's profile. It will be appreciated that the feedback loop can be enabled in this mode, such that feedback from content player system 212 is transmitted to the master node 202 for example to update/modify the user profile. It will be appreciated that this mode may be used in conjunction with any other function or mode associated with the user and/or the content player system 212 of the user.

This mode, the random mode, of operation may also be used where a user has not logged into the content player system 212. For example, a user who is simply demoing or testing the content player system 212, may not wish to log into the content player system to preview its functionality. Instead, the user may wish to try the system to see whether the player has a functionality which they would like to acquire. It will be appreciated that access to the content player system 212 can be provided with secure means, i.e. the user may be required to provide login details and set up passwords in order to obtain access. Additionally or alternatively, the login details can be the same as those for another website such as a social media website, for example a twitter or Facebook account. In this example, the user can login to the content player system 212 either directly or through the social media website. As mentioned, the content player system 212 may allow for some functionalities and modes of operation to be available without requiring a user to login to the system.

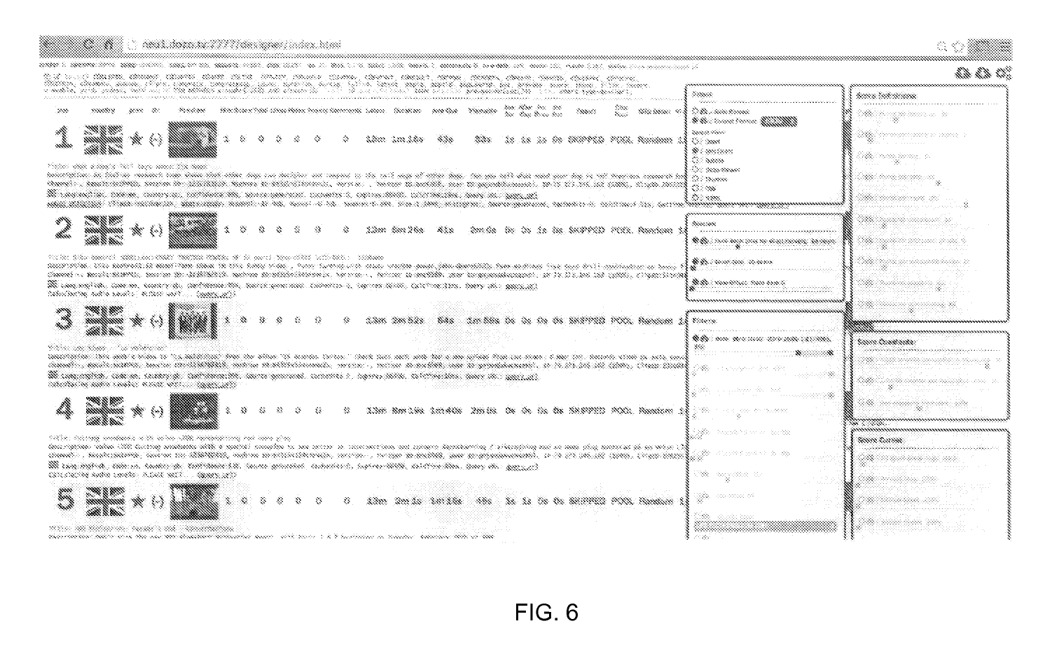

FIG. 6 is a screenshot of the recipe or mixer for use in generating the user content location data (e.g. playlist) according to the user profile. As mentioned before, the local nodes 204a-204b serving a user selects content for each user based on a user profile bank for that user. The user profile bank, in one example, may be compiled and built up over time in part from user feedback data transmitted by the content player 212a of the user. The user profile bank for a user may include one or more user profiles (e.g. recipes or sets of instructions for generating user appropriate content) for that user; each of which may be defined and based on the user's viewing preferences derived, at least in part, from user feedback data associated with playback of content from previous and current playlists viewed by the user, the user's detected mood, genre of content, the time of day the user is viewing content, content trending, user location(s), and/or whether the user is watching with family or friends, or whether the user is watching by themselves etc. A user profile from the user profile bank for a user may be automatically selected by the system 200 and/or the user may manually select a particular user profile for the system 200 to use when selecting content items from the content directory. The system 200 may select content items from a randomly generated set of content items and filter these results according to a selected user profile, in this way the user only knows that the content items will be based one of his user profiles. In this example, the system 200 or local node 204a may allow access to the user profile generator unit 238 which creates and/or updates a user profile of said user stored in the user profile bank and may also receive, from the session database master unit 234, the session database data for the user for use in updating and/or generating one or more user profiles for the user.

As depicted in FIG. 6, a graphic user interface may be provided to allow an administrator, operator or programmer, a user or group of users to generate user profile(s) and/or modify specific playlists which may be based on a user profile and/or filters which may be applied generally to one or more users. These filters may be based on user feedback data from one or more users. It will be appreciated that access to the graphic user interface can restricted such that common users are not provided with this type of system level access. Indeed, it has been considered that such access can be provided to computer programmers and/or enthusiasts to allow them to build ‘optimum’ filters; e.g. filters believed to provide more ‘likes’ and/or less ‘skips’. It will be appreciated that a variety of the parameters and settings can be selected and/or adjusted to generate and/or modify specific playlists. The specific selection of parameters and/or settings therefore can act as a playlist content item filter. The parameters and/or settings can include but are not limited to, selection of specific content items, chart information (including top viewed charts, top rejected charts, top liked and disliked charts), weighting information (including providing a point system awarded for points for turning up, points per minute of viewing, points per like, points per hate, points per mute, points for completion, points for time, points per connected device, points for tweeting, points for commenting), score constants, score curves, etc.

One advantage about providing scoring is that different weighting can be attributed to different feedback as all feedback is not the same. A ‘skip’ may indicate that a user does not like the content item being played back or that they are not in the mood for that content item. However, without further information, the content distribution system 200 may be unable to positively confirm between the two scenarios. Therefore, the weighting of a user providing a ‘like’ or a ‘dislike’ in respect to a particular content item may be rated higher than the ‘skip’ feedback. Finding the ideal weighting of such feedback information would be advantageous. Therefore, providing a graphic user interface which allows a user to generate and/or modify specific playlists based on such adapted weightings etc. is advantageous as it allows user profile and/or filter creators to create and test user profiles and/or filters in the hope of finding the optimum blend of settings.

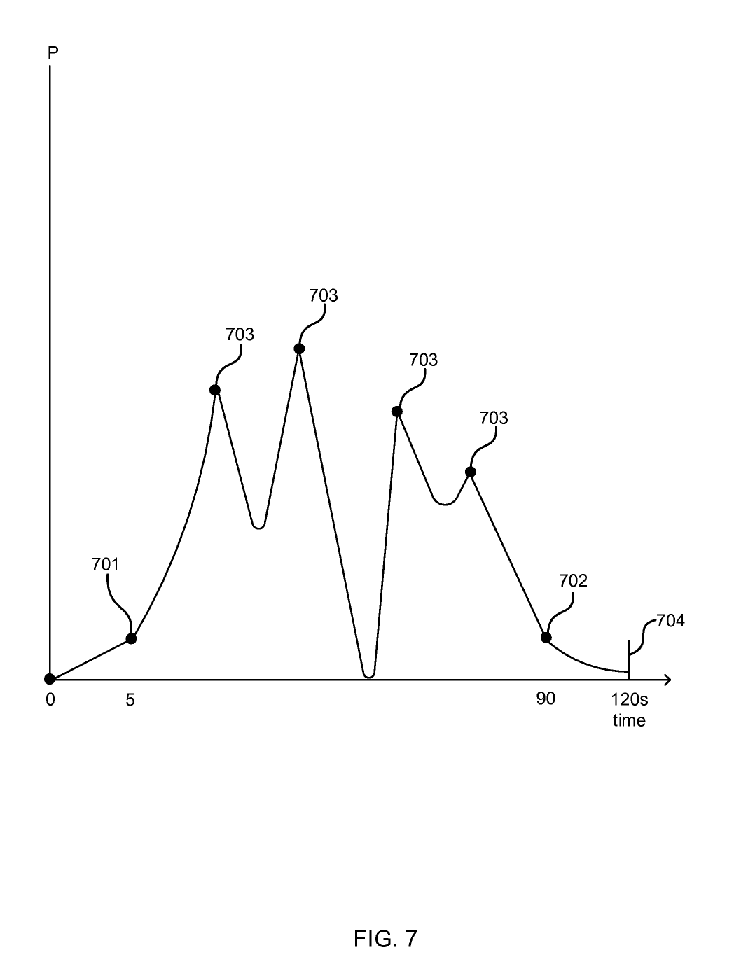

FIG. 7 is a graph showing the profile of a particular content item with time on the x-axis and a points of interest measure on the y-axis. As mentioned previously, in some instances, the content items in the playlist are played to the user from a random starting point within the content item. The random starting point for an entry may be selected from a time interval set to be between a start point and an end point within the content for that playlist entry. For example, the start point may be set to be 10 seconds from the start of the content, and the end point may be set to be 30 seconds from the end of the content. The content for each entry in the playlist may be played for a period of time after which the content for the next entry in the playlist is played. Additionally or alternatively, the content for each entry in the playlist may play for a set period of time or a random period of time, after which the content for the next entry in the playlist starts playing. It will be appreciated that the random starting point and indeed end point may be selected by other parameters; for example, based on points of interest derived from the content itself in the content item.

The profile of the content item depicted by FIG. 7 includes a number of points of interest, namely 701 to 704. The start point may be set at a particular time period from the start of the content item, in this example at 5 seconds as depicted by point 701, and the end point may be set at a particular time period from the end of the content time, which in this example has been set at 30 seconds from the end point 704 as illustrated by point 702. It will be appreciated that any timer period can be set but that it may be preferably to set a particular start and/or send time so as to effectively clip the content item to avoid content being played back that may not be of interest to the users, for example, the opening and closing credits. Other one or more points of interest, for example 703, may be selected by a number of means. For example, they may be arbitrarily selected, i.e. by a random selection of instances along the profile of the content item.

Additionally or alternatively, the instances may be chose based on estimated points of interests based on the content from the content item. The content from the content item can be assessed using a number of means. For example, it can be assessed using audio recognition, by using simple volume establishment, using voice recognition technology, using visual and/or facial recognition technology or other image analysis techniques, etc. It will be appreciated that such techniques can be used to establish the tone and/or mood of a particular scene in a clip and/or instance of an alternative content item (such as a song). Therefore, by using such techniques, the points of interests selected will ideally not be arbitrarily selected but can be specifically chosen as they are believed to correspond to the climax of a movie, the beginning of an action scene, a love scene etc. (any point which is believed would be of particular interest to viewer). Regarding step 124 on page 22, one reason or advantage for analysing video may be to ascertain volume levels (so that clips that are too loud are filtered out or adjusted) or to analyse video for amount of motion (eliminate clips that are just still images) or amount of colour.

These points may then be used as alternative start points 701 on which to commence the playback of the content item. When the content player plays the content item, user feedback (substantially as described above) may be provided and fed into the system. This allows the system to establish whether the identified points of interest are in fact points of interest as it is more likely that a viewer will skip a content item if nothing interesting is occurring in the particular scene(s) being played back. In this way, the feedback can be used as an indication of the performance of the points of interest analysis technique. This feedback can also be used to monitor and/or adjust the settings of the analysis technique itself.

It will be appreciated that although the word ‘seamless’ has been used throughout this specification, the term is not intended to limit the scope of the embodiments described herein to only systems, methods and apparatus where the play functionality is truly ‘seamless’. It will be understood that the embodiments are intended to cover functionality that is substantially seamless and/or substantially continuous. As such, the functionality covered by this phrase is intended to include functionality which is intermittent but mostly continuous.

The systems and apparatus described above may be implemented at least in part in computer software. Those skilled in the art will appreciate that the apparatus described above may be implemented using general purpose computer equipment or using bespoke equipment. The different components of the systems may be provided by software modules executing on a computer.

The hardware elements, operating systems and programming languages of such computers are conventional in nature, and it is presumed that those skilled in the art are adequately familiar therewith. In an embodiment the server may be centrally located and the clients are distributed. In other embodiments, the server functions may be implemented in a distributed fashion on a number of similar platforms, to distribute the processing load.

Here, aspects of the methods and apparatuses described herein can be executed on a computing device such as a server. Program aspects of the technology can be thought of as “products” or “articles of manufacture” typically in the form of executable code and/or associated data that is carried on or embodied in a type of machine readable medium. “Storage” type media include any or all of the memory of the computers, processors or the like, or associated modules thereof, such as various semiconductor memories, tape drives, disk drives, and the like, which may provide storage at any time for the software programming. All or portions of the software may at times be communicated through the internet or various other telecommunications networks. Such communications, for example, may enable loading of the software from one computer or processor into another computer or processor. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible non-transitory “storage” media, terms such as computer or machine “readable medium” refer to any medium that participates in providing instructions to a processor for execution.

Hence, a machine readable medium may take many forms, including but not limited to, a tangible storage carrier, a carrier wave medium or physical transaction medium. Non-volatile storage media include, for example, optical or magnetic disks, such as any of the storage devices in computer(s) or the like, such as may be used to implement the encoder, the decoder, etc. shown in the drawings. Volatile storage media include dynamic memory, such as the main memory of a computer platform. Tangible transmission media include coaxial cables; copper wire and fiber optics, including the wires that comprise the bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will appreciate that while the foregoing has described what are considered to be the best mode and, where appropriate, other modes of performing the technology, the technology should not be limited to specific apparatus configurations or method steps disclosed in this description of the preferred embodiment. It is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings. Those skilled in the art will recognize that the technology has a broad range of applications, and that the embodiments may take a wide range of modifications without departing from the inventive concept as defined in the appended claims.

In particular, it will be understood that the benefits and advantages described above may relate to one embodiment or may relate to several embodiments. The embodiments are not limited to those that solve any or all of the stated problems or those that have any or all of the stated benefits and advantages. Additionally, any reference to an item refers to one or more of those items. The term ‘comprising’ is used herein to mean including the method blocks or elements identified, but that such blocks or elements do not comprise an exclusive list and an apparatus may contain additional blocks or elements and a method may contain additional operations or elements. Furthermore, the blocks, elements and operations are themselves not impliedly closed.

Furthermore, the steps of the methods described herein may be carried out in any suitable order, or simultaneously where appropriate. The arrows between boxes in the figures show one example sequence of method steps but are not intended to exclude other sequences or the performance of multiple steps in parallel. Additionally, individual blocks may be deleted from any of the methods without departing from the spirit and scope of the subject matter described herein. Aspects of any of the examples described above may be combined with aspects of any of the other examples described to form further examples without losing the effect sought. Where elements of the figures are shown connected by arrows, it will be appreciated that these arrows show just one example flow of communications (including data and control messages) between elements. The flow between elements may be in either direction or in both directions.

Although the present technology has been described in terms of specific exemplary embodiments, it will be appreciated that various modifications, alterations and/or combinations of features disclosed herein will be apparent to those skilled in the art without departing from the scope of the technology as set forth in the following claims.

1. A method for distributing content from one or more content sources over a communications network to a plurality of users by a content distribution system, the content distribution system comprising a master node and a plurality of local nodes in communication with the master node, each local node serving a group of users from the plurality of users, the method comprising:
maintaining, at the master node, a content directory associated with a plurality of content items from the one or more content sources, the content directory comprising content location data for the plurality of content items and information associated with each of the content items;
generating, at each local node, user content location data for each user in the group of users based on selecting a plurality of content items from the content directory according to a user profile of each user, the user content location data for each user including locations of the selected content items; and
transmitting, by the local node, the user content location data for each user to a content player associated with said each user for use in retrieving the corresponding content items from the one or more content sources for seamless playback of the selected content items.

2. A method as claimed in claim 1, further comprising:
receiving, at the master node, user feedback data from the content player for each user in response to seamless playback of the selected content items;
storing, at the master node, the user feedback data associated with the user; and
updating, at the master node, a user profile of the user based on the corresponding user feedback data for the user.

3. A method as claimed in claim 2, further comprising:
receiving, by the content player, an instruction to skip playback of a content item of the user content location data;
starting playback of another content item of the user feedback data; and
sending, to the master node, a feedback message comprising user feedback data associated with the skipped content item, the user feedback data comprising at least a portion of the user content location data associated with the content item and an indication the content item was skipped;
storing, at the master node, the user feedback data associated with the user for use in updating a user profile of the user.

4. A method as claimed in claim 2, further comprising:
detecting a content item was played back without an instruction to skip playback of the content item;
sending, to the master node, a feedback message comprising user feedback data associated with the played back content item, the user feedback data comprising at least a portion of the user content location data and an indication the content item was fully played back;
storing, at the master node, the user feedback data associated with the user for use in updating a user profile of the user.

5. A method as claimed in claim 2, further comprising:
receiving, at the local node, a request for controlling the content player of the user from a device, the request including an authentication token associated with the content player; and
sending, to the device, a response authorising control of the content player by the device when the authentication token is valid.

6. A method as claimed in claim 5, further comprising:
generating, at the local node, an authentication token for the content player and associated user;
inserting the authentication token into the user content location data of the associated user;
sending, to the content player, the user content location data;
detecting, by the content player, from the user content location data the authentication token; and
displaying, by the content player, the authentication token during playback of content items associated with the user content location data.

7. A method as claimed in claim 6, wherein the authentication token is a QR code, the method further comprising:
capturing, by the device, an image of the authentication token when it is displayed by the content player; and
decoding the captured authentication token to generate a decoded authentication token for use with the local node in authenticating the device to control the content player.

8. A method as claimed in claim 6, further comprising:
receiving, at the local node, one or more control instructions from the device; and
sending, from the local node, the one or more control instructions to the content player, wherein the content player performs the one or more control instructions.

9. A method as claimed in claim 1, further comprising:
generating, for each content item in the user control location data of the user, a random starting point within a playback time slot between a start point of the content item and an end point of the content item; and
starting the playback of a content item based on the random starting point of the content item.

10. A method as claimed in claim 9, wherein the start point is based on a first time interval from the beginning of the content item, and the end point is based on a second time interval from the end of the content item.

11. A method as claimed in claim 9, further comprising:
receiving, at the content player after starting playback of a content item, an instruction to play the content item from the beginning of the content item; and
playing back the content item from the beginning of the content item.

12. A method as claimed in claim 2, further comprising:
receiving, at the content player, a control instruction for preventing user feedback data from being sent or generated by the content player; and
suspending the sending or generation of user feedback data from the content player.

13. A method as claimed in claim 1, further comprising:
receiving, at the local node, a request for a user to receive user content location data associated with another user;
sending, at the local node, the user content location data of the other user to the content player of the requesting user when the other user has authorised viewing of their user content location data.

14. A method as claimed in claim 1, further comprising:
receiving, at the local node, a request for a user to receive user content location data associated with another user currently using the system;
sending, at the local node, the user content location data of the other user to the content player of the requesting user when the other user has authorised viewing of their user content location data.

15. A method as claimed in claim 13, wherein the content player associated with the user viewing the user content location data of the other user is configured to continue playback of a content item when receiving control instructions to skip playback of the content item for the user content location data of the other user.

16. A method as claimed in claim 1, further comprising:
generating, at the local node, user content location data for a user based on a user profile of the user, the user content location data comprising a plurality of previews of content items;
receiving, by the content player during playback of a preview of a content item, a control instruction to watch the content item associated with the preview content item; and
retrieving, by the content player, the content item associated with the preview content item for playback to the user.

17. A method as claimed in claim 16, the step of retrieving further comprising:
sending, to the local node, a content location request for the content item associated with the preview content item;
receiving, from the local node, user content location data for the user comprising the location of the content item; and
accessing the content item for playback to the user.

18. A method as claimed in claim 17, accessing the content item further comprising:
sending a request to retrieve the content item from the location of the content item, the request including user permissions data associated with accessing the content item; and
retrieving the content item when the user permissions data includes permission for the user to access the content item.

19. A method as claimed in claim 1, further comprising:
generating a random selection of content items from the content directory;
selecting content items from a random selection of content items according to a user profile of the user; and
generating user content location data based on the selected content items.

20. A method as claimed in claim 1, further comprising:
selecting a plurality of content items from the content directory according to a user profile of the user; and
prior to generating the user content location data, randomly shuffling the selected content items.

21. A method as claimed in claim 1, wherein each user is associated with a user profile bank comprising one or more user profiles of the user, the method comprising:
building a user profile for the user profile bank by:
analysing stored user content location data and user feedback data associated with content items played back to the user to identify one or more preference(s) associated with the user; and
generating user profile rules or an instruction set associated with the identified preference(s), the user profile rules for use in generating user content location data for the user according to the user profile.

22. A method as claimed in claim 1, further comprising:
generating, by a content player, a queue of a plurality of content item player instantiations, each content item player instantiation for retrieving a content item associated with the user content location data from one or more content sources; and
retrieving, by the content player, a content item player instantiation from the queue for playback of the corresponding retrieved content item.

23. A method as claimed in claim 22, the step of generating a queue of a plurality of content item player instantiations further comprising:
retrieving, for each content item in the user content location data, the content item location;
instantiating a content item player for retrieval of the content item from the content item location; and
inserting the content item player instantiation in the queue of content item player instantiations when the content item has been retrieved by the content item player instantiation.

24. A method as claimed in claim 22, the step of retrieving a content item player instantiation from the queue when a minimum number of content item player instantiations are in the queue for substantially seamless playback of content items.

25. A method as claimed in claim 22, the step of retrieving a content item player instantiation from the queue comprises selecting a content item player instantiation from the queue that is ready to perform playback of a corresponding content item.

26. A method for distributing content from one or more content sources over a communications network to a plurality of users by a content delivery client, the communications network including a plurality of content delivery clients in communication with each other, each content delivery client serving a user from the plurality of users, the method comprising:
maintaining a content directory associated with a plurality of content items from the one or more content sources or one or more other content delivery clients, the content directory comprising content location data for the plurality of content items and information associated with each of the content items;
generating user content location data for the user based on selecting a plurality of content items from the content directory according to a user profile of the user, the user content location data including locations of the selected content items; and
retrieving by a content player of the user the corresponding content items from the one or more content sources and/or other client delivery clients for seamless playback of the selected content items.

27. A method as claimed in claim 26, further comprising:
receiving user feedback data from the content player in response to seamless playback of the selected content items;
storing the user feedback data associated with the user; and
updating a user profile of the user based on the corresponding user feedback data for the user.

28. A method as claimed in claim 26, further comprising:
generating a random selection of content items from the content directory;
selecting content items from a random selection of content items according to a a user profile of the user; and
generating user content location data based on the selected content items.

29. A system for distributing content from one or more content sources over a communications network to a plurality of users by a content distribution system, the content distribution system comprising a master node and a plurality of local nodes in communication with the master node, each local node serving a group of users from the plurality of users, the system further comprising:
means for maintaining, at the master node, a content directory associated with a plurality of content items from the one or more content sources, the content directory comprising content location data for the plurality of content items and information associated with each of the content items;
means for generating, at each local node, user content location data for each user in the group of users based on selecting a plurality of content items from the content directory according to a user profile of each user, the user content location data for each user including locations of the selected content items; and
means for transmitting, by the local node, the user content location data for each user to a content player associated with said each user for use in retrieving the corresponding content items from the one or more content sources for seamless playback of the selected content items.

30. A non-transitory computer-readable medium comprising instructions which, when executed by an apparatus, cause the apparatus to perform a computer process comprising the steps of claims 1.
